(19) United States
(12) Patent Application Publication
(10) Pub. No.: US 2025/0191040 A1
(43) Pub. Date: Jun. 12, 2025

(54) MATCHING SYSTEM, INVITER DEVICE, AND METHOD

(71) Applicant: Murata Manufacturing Co., Ltd., Kyoto-fu (JP)

(72) Inventors: Masaharu ITAYA, Nagaokakyo-shi (JP); Yusuke MORI, Nagaokakyo-shi (JP); Yuuto NIWA, Nagaokakyo-shi (JP); Kazuki MATSUI, Nagaokakyo-shi (JP)

(21) Appl. No.: 19/048,631

(22) Filed: Feb. 7, 2025

Related U.S. Application Data
(63) Continuation of application No. PCT/JP2023/028054, filed on Aug. 1, 2023.

(30) Foreign Application Priority Data
Aug. 9, 2022 (JP) 2022-127096
Oct. 26, 2022 (JP) 2022-171278
Jan. 24, 2023 (JP) 2023-008773

(51) Int. Cl. G06Q 30/0601; G06Q 50/00

(52) U.S. Cl. CPC G06Q 30/0609; G06Q 50/01

(57) ABSTRACT

A matching system, an inviter device, and a method to match an inviter and an applicant who applies for an invitation. A computing device that communicates with the inviter device and a first applicant device. The computing device is able to access a database, where the inviter device transmits asset information and disclosure information to the computing device, and can register the asset information and disclosure information transmitted from an inviter device into the database. The computing device can determine, asset information permitted to be disclosed to the first applicant among asset information registered in the database based on corresponding disclosure information. The computing device can provide the first applicant device with the asset information permitted to be disclosed to the first applicant.

### CROSS-REFERENCE TO RELATED APPLICATIONS

This is a continuation of International Application No. PCT/JP2023/028054 filled on Aug. 1, 2023 which claims priority from Japanese Patent Application No. 2022-127096 filed on Aug. 9, 2022, Japanese Patent Application No. 2022-171278 filed on Oct. 26, 2022, and Japanese Patent Application No. 2023-008773 filed on Jan. 24, 2023. The contents of these applications are incorporated herein by reference in their entireties.

### BACKGROUND OF THE DISCLOSURE

### Field of the Disclosure

The present disclosure relates to a matching system, an inviter device, and a method to match an inviter and an applicant, who applies for an invitation, when an owner of an asset becomes the inviter so as to invite an application to be the one whom the asset is to be transferred or by whom the asset is to be used.

### Description of the Related Art

Conventionally, a system that mediates buying and selling of an article between individuals has been known. For example, PTL 1 discloses a system including: a personal terminal of a seller; a personal terminal of a buyer; and a network server of a mediator, wherein the mediator manages respective pieces of personal information of the seller and the buyer, and selling and buying between individuals are mediated by the mediator without notifying the pieces of personal information to the seller and the buyer.

According to the system described in PTL 1, it is possible to smoothly match a person who would like to sell an unnecessary article with a person who would like to buy a desired article.
PTL 1: Japanese Patent Laid-Open No. 2002-74055

### BRIEF SUMMARY OF THE DISCLOSURE

Not only an individual but also a group such as a company have a need to dispose of or utilize a redundant asset such as an unnecessary article. The group such as a company can become an inviter who invites an application to be one to whom the asset is to be transferred or by whom the asset is to be used, thereby seeking for applicants who apply for the invitation.

However, it is important for the inviter to avoid the redundant asset from being transferred to a competitor and avoid the competitor from knowing the content of the redundant asset that the inviter desires to transfer. This is because the competitor may know secret information and business development through the content of the redundant asset that the inviter desires to transfer. Therefore, when matching an inviter and an applicant both belonging to groups such as companies, a stake between the inviter and the applicant needs to be taken into consideration.

The present disclosure has been made to solve the above-described problem, and has an object to attain selection of an appropriate applicant in consideration of a stake between an applicant and an inviter who invites an application to be one to whom the asset is to be transferred or by whom the asset is to be used.

A matching system according to a first aspect of the present disclosure is a matching system that matches an inviter and an applicant, who applies for an invitation, when an owner of an asset becomes the inviter so as to invite an application to be the one whom the asset is to be transferred or by whom the asset is to be used, the matching system including: an inviter device to be operated by the inviter; a first applicant device to be operated by a first applicant; and a computing device that communicates with the inviter device and the first applicant device, the computing device being able to access a database, wherein the inviter device transmits asset information and disclosure information to the computing device, the asset information indicating a subject of the asset, the disclosure information indicating a scope of disclosure of the asset information, the computing device registers the asset information and the disclosure information into the database, and the computing device determines, based on corresponding disclosure information, asset information permitted to be disclosed to the first applicant among pieces of asset information registered in the database, and provides the first applicant device with the asset information permitted to be disclosed to the first applicant.

An inviter device according to a second aspect of the present disclosure is an inviter device operated by an inviter when an owner of an asset becomes the inviter so as to invite an application to be the one whom the asset is to be transferred or by whom the asset is to be used, wherein the inviter device communicates with a computing device that matches the inviter and an applicant who applies for the invitation, the inviter device including: an interface that receives an operation of inputting asset information and disclosure information, the asset information indicating a subject of the asset, the disclosure information indicating a scope of disclosure of the asset information; and a processor that transmits, to the computing device, the asset information and the disclosure information received by the interface, wherein the disclosure information includes information for instructing the computing device to permit disclosure of the asset information to a first applicant and to prohibit the disclosure of the asset information to a second applicant different from the first applicant.

A method according to a third aspect of the present disclosure is a method of matching an inviter and an applicant, who applies for an invitation, when an owner of an asset becomes the inviter so as to invite an application to be the one whom the asset is to be transferred or by whom the asset is to be used, the method including: communicating with an inviter device operated by the inviter and a first applicant device operated by a first applicant; receiving asset information and disclosure information from the inviter device operated by the inviter, the asset information indicating a subject of the asset, the disclosure information indicating a scope of disclosure of the asset information; registering the asset information and the disclosure information into a database; and determining, based on corresponding disclosure information, asset information permitted to be disclosed to the first applicant among pieces of asset information registered in the database, and providing the first applicant device with the asset information permitted to be disclosed to the first applicant.

According to the present disclosure, it is possible to attain selection of an appropriate applicant in consideration of a stake between a group of an applicant and a group of an inviter who invites an application to be one to whom an asset is to be transferred or by whom the asset is to be used.

### BRIEF DESCRIPTION OF THE SEVERAL VIEWS OF THE DRAWING

FIG. 1 is a block diagram showing an overview of a matching system.

FIG. 2 is a block diagram showing configurations of a sharing server, an inviter device, and an applicant device.

FIG. 3 is a diagram showing an exemplary company database.

FIG. 4 is a diagram showing an exemplary member database.

FIG. 5 is a diagram showing an exemplary community database.

FIG. 6 is a diagram showing an exemplary invitation case database.

FIG. 7 is a diagram showing an exemplary evaluation input database.

FIG. 8 is a diagram showing an exemplary evaluation summary database.

FIG. 9 is a diagram for illustrating functions of the sharing server, the inviter device, and the applicant device.

FIG. 10 is a diagram for illustrating the functions of the sharing server, the inviter device, and the applicant device.

FIG. 11 is a diagram for illustrating the functions of the sharing server, the inviter device, and the applicant device.

FIG. 12 is a diagram for further illustrating the function of the applicant device.

FIG. 13 is a diagram for illustrating a procedure of registering an invitation case into the invitation case database.

FIG. 14 is a diagram for illustrating a procedure of searching for an invitation case in the database.

FIG. 15 is a diagram for illustrating a procedure of registering an evaluation for an applicant into the database.

FIG. 16 is a diagram for illustrating a procedure of registering an evaluation for an inviter into the database.

FIG. 17 is a diagram for illustrating a procedure of presenting, on a display, an evaluation for an applicant and a search result for a member.

FIG. 18 is a diagram for illustrating a procedure of presenting, on the display, an evaluation for an inviter and a search result for a member.

FIG. 19 is a diagram for illustrating a permitted scope of viewing of the evaluation summary database.

FIG. 20 is a diagram showing an example of setting a scope of disclosure in accordance with a disclosure level.

FIG. 21 is a diagram showing a detail of an asset content included in the invitation case database.

FIG. 22 is a diagram showing an exemplary profile database.

FIG. 23 is a diagram showing an exemplary company-specific term database.

FIG. 24 is a flowchart showing a processing procedure for an index function of the matching system.

FIG. 25 is a flowchart showing a processing procedure of a company-specific term registration unit.

FIG. 26 is a flowchart showing a processing procedure of a case registration unit.

FIG. 27 is a flowchart showing a processing procedure of presenting a meaning of a company-specific term on a screen in accordance with an operation of an applicant.

FIG. 28 is a diagram showing an exemplary invitation case database according to a modification 1.

FIG. 29 is a diagram for illustrating a procedure of registering an invitation case into the invitation case database according to modification 1.

FIG. 30 is a flowchart showing a processing procedure of a first determination process according to modification 1.

FIG. 31 is a flowchart showing a processing procedure of a second determination process according to modification 1.

FIG. 32 is a flowchart showing a processing procedure of a third determination process according to modification 1.

FIG. 33 is a diagram showing a configuration of a matching system according to a modification 2.

FIG. 34 is a diagram showing an example (modification 3) in which Kerberos authentication is applied to a matching system.

### DETAILED DESCRIPTION OF THE DISCLOSURE

Hereinafter, embodiments of the present disclosure will be described in detail with reference to figures. It should be noted that the same or corresponding portions in the figures are denoted by the same reference characters and will not be described repeatedly.

### Background as to Proposal of Matching System 1

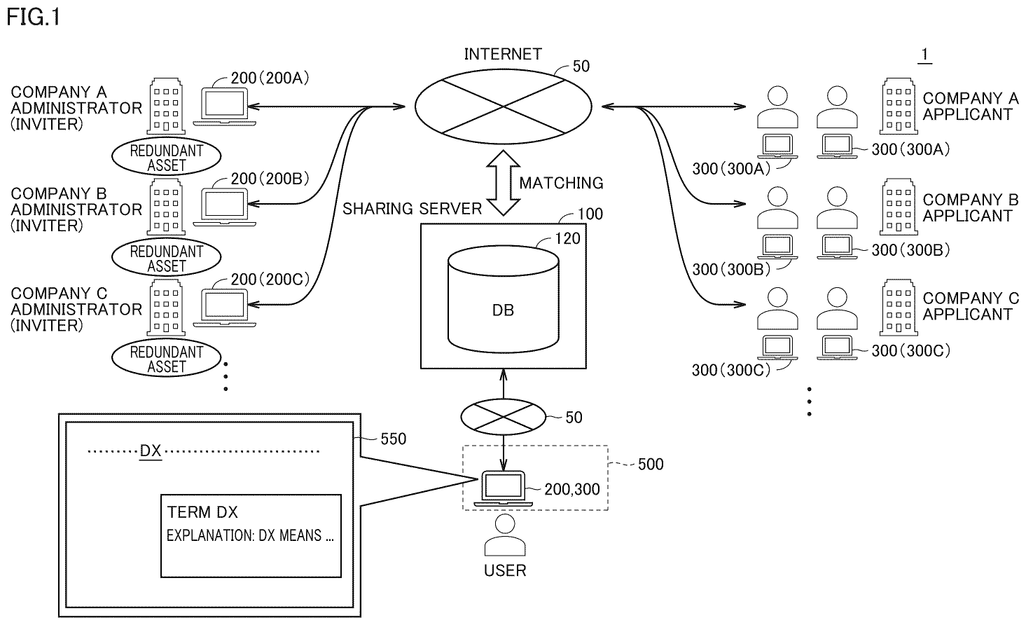

FIG. 1 is a block diagram showing an overview of a matching system 1 according to the present embodiment.

Hereinafter, in matching system 1, a redundant asset for which an invitation for application is made to be a counterpart to whom the redundant asset is to be transferred or by whom the redundant asset is to be used may be referred to as “invitation case,” one who provides or may provide such an invitation case may be referred to as “inviter,” and one who applies for or may apply for the invitation made by the inviter may be referred to as “applicant.” One who has acquired an acceptance for the application from the inviter is permitted to receive transfer of or use the redundant asset corresponding to the invitation case in accordance with the content of the invitation. The one who has acquired the acceptance for the application from the inviter in this way may be referred to as “acquirer” for the invitation case.

When a transaction for the invitation case is completed, the applicant corresponds to a “transferee,” and the inviter who has transferred the redundant asset to the “transferee” corresponds to a “transferer”; however, in the description below, the “applicant” may be stated to include the “transferee,” and the “inviter” may be stated to include the “transferer.”

First, a background as to proposal of matching system 1 in the present embodiment will be described. A system that mediates buying and selling of an article between individuals has been widely known. Each individual can use the system to dispose of an unnecessary article in exchange for compensation.

A company also has a need to dispose of a redundant asset such as an unnecessary article. The company can obtain a profit from the redundant asset by selling or lending the redundant asset, instead of amortizing or discarding the redundant asset. However, when the company searches for a counterpart for transaction of the redundant asset, it is important to pay attention to the following points that do not cause problems in the situation of buying and selling of an article between individuals.

### [Possibility of Leakage of Secret Information]

For example, when the company attempts to lend or sell the redundant asset such as a sleeping patent, a plan, or an idea, it is important to avoid transaction of the redundant asset with a competitor and avoid the content of the redundant asset to be lent or sold from being known to the competitor. This is because the competitor may know secret information and business development through the content of the redundant asset to be lent or sold. Also, when the company attempts to lend or sell a redundant asset such as a facility and an appliance, the company should avoid information of the redundant asset from being known to the competitor. This is because the competitor may hypothesize future business development in view of the fact that the facility or the like is expected to be sold.

Moreover, the company should pay sufficient attention to the identity of a counterpart of the transaction in order to avoid decreased credit quality of the company. Therefore, when matching an inviter and an applicant respectively belonging to companies, a group of the inviter as well as a stake between the company on the inviting side and the company on the applying side need to be taken into consideration.

However, in the conventional mediation system for buying and selling between individuals, the stake between the company on the inviting side and the company on the applying side is not taken into consideration. Therefore, when the mediation system for buying and selling between individuals is employed in the situation of transaction between companies, an enterprise risk and an individual risk arise. For example, secret information of a certain company may be leaked to a company having a rivalry with the foregoing company through an asset submitted by an employee of the foregoing company. Further, in the conventional mediation system for buying and selling between individuals, an administrator cannot check that the employee does not sell the company's asset to the competitor.

[Possibility that Accurate Information about Inviter and Applicant Cannot be Obtained]

Redundant assets are registered in the matching system by inviters as invitation cases for transaction. One who would like to receive transfer of a redundant asset applies for an invitation case as an applicant. The applicant will select a satisfactory case in consideration of the contents of the redundant assets, the prices of the redundant assets, and the like.

However, some inviters may frequently change the prices of redundant assets or may register poor-quality redundant assets. Applicants would like to avoid such inviters when applying for invitation cases. On the other hand, some inviters offer high-quality redundant assets at decent prices. Applicants would like to apply for cases for which applications are invited by such inviters, if possible.

Further, some applicants may have problems in payment for redundant assets or may ask for unfair discounts. Inviters would like to avoid such applicants and would like to make transactions with applicants who respond sincerely.

Therefore, it is desirable to widely share evaluations for inviters and evaluations for applicants in a crowdsourcing system.

However, a person (inviter or applicant) in charge in a certain company may input a higher magnitude of evaluation into the system than a reasonable magnitude of evaluation, in consideration of a person (inviter or applicant) in charge in the other company to be evaluated. Moreover, a person in charge in a certain company may avoid a person in charge in the other company from being evaluated to be low in consideration of a possibility that a relationship between the companies become worse. Further, a person in a position to make an evaluation may not think that there is a benefit in making an evaluation, and may input a magnitude of evaluation that is much different from a reasonable magnitude of evaluation into the system. In view of these possibilities, reliability of evaluations provided by the system may be decreased. In this case, even when the evaluations for inviters and applicants are shared in the system, a user cannot utilize the evaluations as reference data when making a transaction with an inviter or applicant.

[Possibility that Communication is Inhibited by Company-Specific Term]

In a company, a company-specific term specific to the company may be widely used. Such a company-specific term is understandable by a person from the company in which the company-specific term is widely used, but may not be understandable by a person who does not belong to the company in which the company-specific term is widely used. Further, the company-specific term is understood as a term having a specific meaning among people from the company in which the company-specific term is widely used, but may be understood as a term having a meaning different from the specific meaning among people who do not belong to the company in which the company-specific term is widely used.

Such a company-specific term may be used in a text for explaining a redundant asset. When a company to which an inviter belongs is different from a company to which an applicant belongs, the applicant may be unable to correctly understand the meaning of a company-specific term used by the inviter to explain a redundant asset. The applicant may apply for the invitation case without correctly understanding the meaning of the company-specific term used by the inviter to explain the redundant asset. This may result in a trouble between the inviter and the applicant.

Such a company-specific term may be used in a meeting between an inviter and an applicant. When a company to which the inviter belongs is different from a company to which the applicant belongs, the applicant may be unable to correctly understand the meaning of a company-specific term spoken by the inviter. Similarly, the inviter may be unable to correctly understand the meaning of a company-specific term spoken by the applicant.

When the company-specific term spoken by one of the inviter and the applicant is an unfamiliar company-specific term, the other will be able to understand the meaning of the company-specific term by asking a question to the speaker with regard to the meaning of the term. However, when the meaning of one company-specific term is differently understood between the inviter and the applicant, the meeting proceeds while the difference in recognition between them remains uncorrected. This may result in a trouble between the inviter and the applicant.

As terms similar to the company-specific terms, terms used in unique meanings may be widely used not only in companies but also in non-profit organizations. Regardless of a profit organization or a non-profit organization, one organization may be divided into a plurality of units such as departments and sections, and terms used in specific meanings may be widely used in each unit. Further, such terms may also be widely used in a community formed by gathering a plurality of organizations such as companies. Therefore, when an inviter and an applicant belong to different organizations, units, and communities, the difference in recognition of the terms may result in the above-described troubles.

In the present embodiment, not only the “company-specific terms” as used in the profit organizations such as companies and the units in the profit organizations, but also the “terms similar to the company-specific terms” as used in the non-profit organizations, communities, and units in the non-profit organizations and communities are collectively referred to as “in-house terms.” In the description below, the present embodiment will be described by illustrating the “company-specific terms” for the companies as an example of the “in-house terms.”

In the present embodiment, matching system 1 described in detail below is proposed in order to solve at least one of the above-described various problems in the conventional mediation system.

### [Overall Configuration]

An overview of a configuration of matching system 1 will be described with reference to FIG. 1. Matching system 1 includes a sharing server 100, inviter devices 200A, 200B, 200C, etc., and applicant devices 300A, 300B, 300C, etc.

Sharing server 100 provides a large number of companies with a matching service for matching transfer or use of redundant assets among the companies. In FIG. 1, companies A, B, C, etc. are shown as exemplary companies that use the matching service. Companies A, B, C, etc. are registered as company members of matching system 1. Among employees of companies A, B, C, etc., employees who use matching system 1 are also individually registered as members of matching system 1.

Each of companies A, B, C, etc. has various redundant assets. Redundant assets handled by matching system 1 are hardware-like redundant assets such as a facility and an appliance, and software-like redundant assets such as a sleeping patent, a plan, and an idea.

Each of companies A, B, C, etc. can submit various redundant assets to matching system 1. Each of companies A, B, C, etc. may submit, to matching system 1, an asset that necessarily cannot be said to be “redundant.” In the description below, a subject submitted to matching system 1 may be referred to as “asset” in a broad meaning to include the “redundant asset.”

In matching system 1, an applicant of company A can also apply as a transferee for an asset submitted by company A. For example, in matching system 1, one belonging to a department Y of company A is permitted to apply as a transferee for an asset submitted by a different department X of company A.

Matching system 1 handles not only an invitation case for transfer of an asset to an applicant but also an invitation case for permitting an applicant to use an asset while maintaining the ownership right of the asset on the inviter side. For example, each of a vacation facility, a conference room, and the like corresponds to such an invitation case. A company having a training program may submit a right to use the training program to matching system 1 as an invitation case. In this case, an invitation case for permitting an applicant to use the training program is registered in matching system 1.

When a transaction regarding this type of invitation case is established, the applicant corresponds to a “user” and the inviter who has transferred the asset to the “user” corresponds to a “use-permitter;” however, in the description below, the “applicant” may be stated to include the “user,” and the “inviter” may be stated to include the “use-permitter.”

A database 120 for the matching service is constructed in sharing server 100. Database 120 includes various databases in each of which information to provide the matching service is registered. For example, pieces of information of a member and an invitation case are registered in database 120. Sharing server 100 is managed and operated by a company other than the companies that use the matching service. Any company that uses the matching service may manage and operate sharing server 100.

Inviter device 200A is operated by an administrator of company A. Inviter device 200B is operated by an administrator of company B. Inviter device 200C is operated by an administrator of company C. Hereinafter, inviter devices 200A, 200B, 200C, etc. may be collectively referred to as “inviter device 200.”

Applicant device 300A is operated by an applicant of company A. Applicant device 300B is operated by an applicant of company B. Applicant device 300C is operated by an applicant of company C. Hereinafter, applicant devices 300A, 300B, 300C, etc. may be collectively referred to as “applicant device 300.” Although FIG. 1 illustrates two applicants for each company, the number of applicants is not limited thereto. A larger number of applicants may exist in each company, or one applicant may exist in a certain company. Sharing server 100 may accept, as an applicant, one who does not belong to a company.

Each of the administrators of companies A, B, C, etc. plays a role as an inviter. Therefore, in the description below, each of the administrators of the companies may be referred to as “inviter.” The inviter can also behave as an applicant for a case for which another inviter invites an application. In this case, inviter device 200 functions as applicant device 300. In the present disclosure, when an administrator of a company behaves as an inviter, a device used by the administrator to use the matching service is referred to as inviter device 200.

There may be one or a plurality of administrators in company A. When administrators are placed in company A, the administrators may have inviter devices 200 respectively, or one inviter device 200 may be shared by the plurality of administrators. The same applies to companies B, C, etc.

Sharing server 100 and inviter device 200 are configured to communicate with each other via Internet 50, which is an exemplary communication network. Sharing server 100 and applicant device 300 are configured to communicate with each other via Internet 50.

When receiving access from inviter device 200, sharing server 100 requests sign-in involving input of a member ID and a password. Similarly, when receiving access from applicant device 300, sharing server 100 requests sign-in involving input of a member ID and a password. Sharing server 100 specifies each one of inviters and applicants by a corresponding member ID notified at the time of sign-in.

Inviter device 200 receives various operations of the inviter. For example, inviter device 200 receives an operation of inputting an invitation case and an operation of searching for a member of the matching service.

In response to each operation on inviter device 200, inviter device 200 communicates with sharing server 100. In response to the operation of inputting an invitation case, sharing server 100 registers the invitation case into database 120, and in response to the operation of searching for a member, sharing server 100 provides information of the member to inviter device 200.

Applicant device 300 receives various operations of the applicant. For example, applicant device 300 receives an operation of searching for an invitation case and an operation of applying for an invitation case.

In response to each operation on applicant device 300, applicant device 300 communicates with sharing server 100. In response to the operation of searching for an invitation case, sharing server 100 provides an appropriate invitation case to applicant device 300, and in response to the operation of applying for an invitation case, sharing server 100 provides a notification of acceptance or rejection to applicant device 300.

An inviter belonging to a certain department of company A can use matching system 1 to select, as an acquirer for a corresponding invitation case, an applicant belonging to another department of company A. An inviter belonging to company A can use matching system 1 to select, as an acquirer for a corresponding invitation case, an applicant belonging to company B.

Each of the members who use matching system 1 accesses sharing server 100 as an inviter or an applicant. In the description below, the member of matching system 1 may be referred to as “user.” Further, in the description below, inviter device 200 and applicant device 300 operated by the members may be collectively referred to as “user device 500.”

FIG. 1 illustrates a screen 550 presented on user device 500. Various types of information are presented on screen 550. For example, a detailed explanation for an asset or the like is presented on screen 550. A user (applicant) sees screen 550 to check details of an asset presented as an invitation case.

A company-specific term may be included in the explanation for the asset or the like presented on screen 550. When a company to which the user who sees screen 550 belongs is different from a company to which a user who provides the information belongs, the user who sees screen 550 may be unable to correctly understand the company-specific term.

To address this, matching system 1 registers company-specific terms of the companies and the meanings thereof into database 120. Matching system 1 generates an index for a company-specific term from a text such as explanation for an asset, and links the index to a corresponding company-specific term registered in database 120. Thus, matching system 1 has an index function.

When a company-specific term is included in the text presented on screen 550, user device 500 presents the company-specific term in a presentation manner different from those of the other terms. Thus, the user understands that it is a company-specific term. Further, user device 500 presents the meaning intended by the company-specific term on screen 550 in response to an operation of the user (for example, an operation of clicking a portion of the company-specific term).

For example, “DX” is presented on screen 550 shown in FIG. 1 as an exemplary company-specific term. “DX” is underlined to indicate that it is a company-specific term. The user clicks “DX.” Then, a window explaining the meaning of the term “DX” is presented on screen 550. DX is an abbreviation for Digital Transformation and generally means a change through digital technology. However, some companies may use “DX” as a company-specific term that means to create some new value regardless of whether or not the digital technology is used. In such a case, the meaning corresponding to the company-specific term is explained in the window of screen 550. Thus, the user can correctly understand the meaning of “DX” intended by the counterpart.

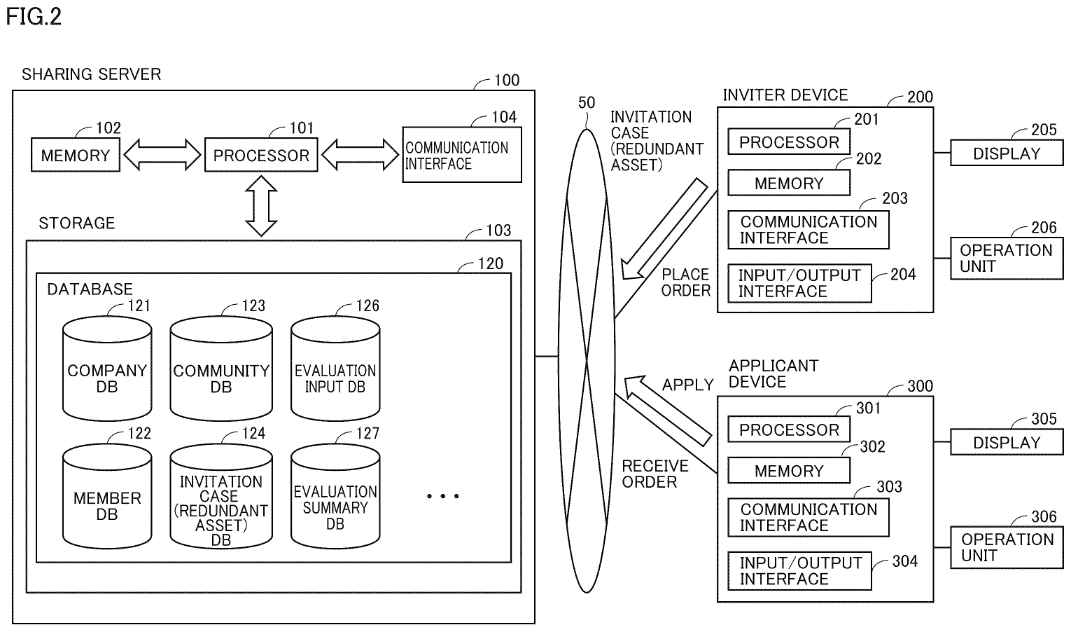

FIG. 2 is a block diagram showing configurations of sharing server 100, inviter device 200, and applicant device 300.

### [Configuration of Sharing Server 100]

Sharing server 100 includes a processor 101, a memory 102, a storage 103, and a communication interface 104.

Memory 102 includes a non-transitory computer readable medium, a RAM (random access memory), a ROM (read only memory), a flash memory, or any other suitable memory system. Memory 102 stores a program for arithmetic processing of processor 101, temporary data calculated in the arithmetic processing, and the like.

Storage 103 is constituted of a hard disk drive, a solid state drive, and the like. Storage 103 stores database 120. Database 120 includes a plurality of types of databases. The plurality of types of databases include a company database (company DB) 121, a member database (member DB) 122, a community database (community DB) 123, an invitation case database (invitation case DB) 124, an evaluation input database (evaluation input DB) 126, and an evaluation summary database (evaluation summary DB) 127. In invitation case database (invitation case DB) 124, pieces of information of (redundant) assets serving as invitation cases are registered.

A part of the plurality of types of databases may be stored in a storage provided separately from sharing server 100. For example, connection may be made to a cloud service different from sharing server 100, and a part of the plurality of types of databases shown in FIG. 2 may be stored in the cloud. In this case, sharing server 100 can access a database by communicating with the cloud via Internet 50.

Processor 101 connects to Internet 50 via communication interface 104 in accordance with a program stored in memory 102. Processor 101 connects to Internet 50 and communicates with inviter device 200 and applicant device 300. Processor 101 accesses database 120 and performs a process of extracting data, a process of registering new data into database 120, a process of updating data registered in database 120, and the like.

### [Configuration of Inviter Device 200]

Inviter device 200 includes a processor 201, a memory 202, a communication interface 203, an input/output interface 204, a display 205, and an operation unit 206. Operation unit 206 is constituted of a mouse, a keyboard, and the like.

Memory 202 includes a non-transitory computer readable medium, a RAM (random access memory), a ROM (read only memory), a flash memory, or any other suitable memory system. Memory 202 stores a program for arithmetic processing of processor 201, temporary data calculated in the arithmetic processing, and the like.

Processor 201 connects to Internet 50 via communication interface 203 in accordance with a program stored in memory 202. Processor 201 connects to Internet 50 and communicates with sharing server 100. Processor 201 communicates with sharing server 100, and performs a process of transmitting an invitation case, a process of presenting information of a member who is an applicant on display 205, a process of allowing the inviter to accept or reject the applicant as an acquirer for the invitation case, a process of transmitting, to sharing server 100, a content of an evaluation for the applicant (transferee) as input by the inviter (transferer), and the like.

Information input by an operation on operation unit 206 is notified to processor 201 via input/output interface 204.

### [Configuration of Applicant Device 300]

Applicant device 300 includes a processor 301, a memory 302, a communication interface 303, an input/output interface 304, a display 305, and an operation unit 306. Operation unit 306 is constituted of a mouse, a keyboard, and the like.

Memory 302 includes a non-transitory computer readable medium, a RAM (random access memory), a ROM (read only memory), a flash memory, or any other suitable memory system. Memory 302 stores a program for arithmetic processing of processor 301, temporary data calculated in the arithmetic processing, and the like.

Processor 301 connects to Internet 50 via communication interface 303 in accordance with a program stored in memory 302. Processor 301 connects to Internet 50 and communicates with sharing server 100. Processor 301 communicates with sharing server 100, and performs a process of applying for an invitation case, a process of presenting, on display 305, a notification of acceptance or rejection with regard to a case for which an application has been made, a process of transmitting, to sharing server 100, a content of an evaluation for an inviter (transferer) as input by an applicant (transferee), and the like.

Information input by an operation on operation unit 306 is notified to processor 301 via input/output interface 304.

### [Overview of Database 120]

Hereinafter, an overview of database 120 will be described. In company database 121, pieces of information of the companies participating in matching system 1 are registered. In member database 122, pieces of information of the members using matching system 1 are registered. Many members are employees of the companies participating in matching system 1.

Each of the members registered in member database 122 can act as an inviter or an applicant by using matching system 1. The members may include not only the employees belonging to the companies registered in company database 121, but also an individual not belonging to each of the companies.

Community database 123 stores pieces of information for specifying companies belonging to communities. Each of the communities is formed by an agreement between companies. Therefore, a plurality of communities can be formed depending on manners of agreements between companies. The number of companies belonging to one community can also be set variously. Between companies having a community relationship, a trust relationship is formed to an extent determined by a manner of an agreement when forming the community. In community database 123, information for specifying a company belonging to a community is registered on the community basis. Invitation cases are registered in invitation case database 124. Each of the invitation cases is an asset for which an application is invited to be a counterpart to whom the asset is to be transferred or by whom the asset is to be used. An employee of each company can apply, as a member of matching system 1, for an invitation case submitted from another department of his/her own company or an invitation case submitted from another company.

In evaluation input database 126, pieces of information of evaluations for applicants and pieces of information of evaluations for inviters are registered. Each of the inviters can use matching system 1 to evaluate, as an evaluator, an applicant's attitude or the like during transaction. Each of the applicants can use matching system 1 to evaluate, as an evaluator, an inviter's attitude or the like during transaction. The evaluations made by the individual evaluators are registered in evaluation input database 126.

Evaluation summaries are registered in evaluation summary database 127. In evaluation summary database 127, an evaluation summary is registered on the member basis. The evaluation summaries include an inviter evaluation summary and an applicant evaluation summary. The inviter evaluation summary indicates a magnitude of evaluation when a member behaves as an inviter. The applicant evaluation summary indicates a magnitude of evaluation when the member behaves as an applicant. The inviter evaluation summary is created based on an evaluation made for the inviter by the applicant. The applicant evaluation summary is created based on an evaluation made for the applicant by the inviter.

Each of the members can view the evaluation summaries. An inviter can select a member, who seems appropriate, as a transferee while viewing the respective applicant evaluation summaries of the members. An applicant can apply for a case presented by an inviter, who seems appropriate, while viewing the respective inviter evaluation summaries of the members.

### [Company Database 121]

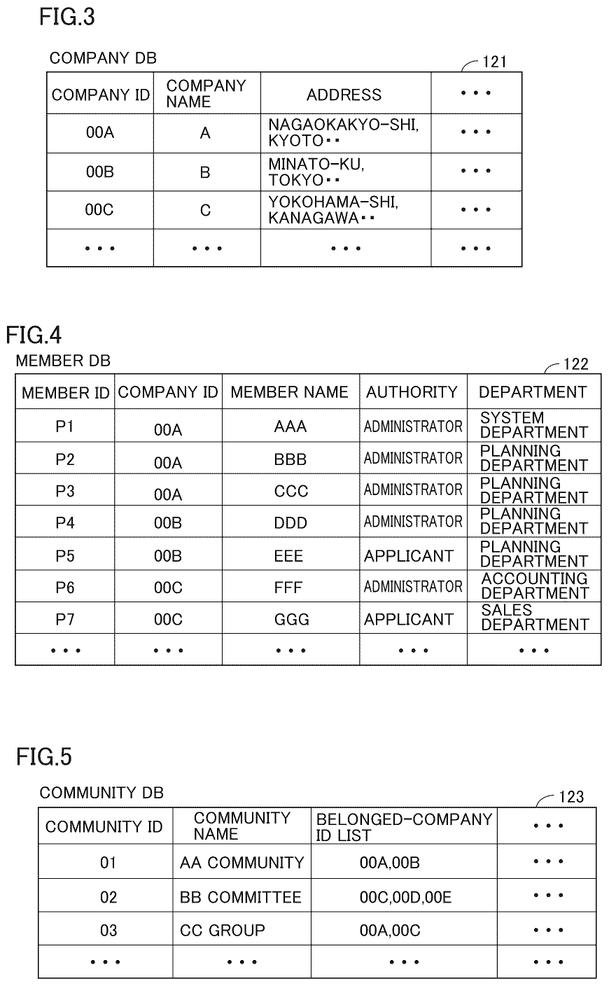

FIG. 3 is a diagram showing an exemplary company database 121. In company database 121, a “company ID,” a “company name,” and an “address” of a company for identifying the company are registered on the company basis.

### [Member Database 122]

FIG. 4 is a diagram showing an exemplary member database 122. Various types of information of each of the members are registered in member database 122. The various types of information of each of the members include a “member ID” for identifying the member, a “company ID” of a company to which the member belongs, a “member name,” an “authority” of the member, and a “department” to which the member belongs.

Types of the authority of the member include an administrator and an applicant. A member having the administrator authority is given an authority to use matching system 1 as an inviter and an applicant. A member having only the applicant authority is given an authority to use matching system 1 as an applicant, but is not given an authority to use matching system 1 as an inviter. The administrator authority is given to a department director in a company in order to manage an application from a subordinate in the department. The administrator having the administrator authority is given an authority to approve the application from the applicant who is the subordinate. Thus, the administrator functions as an approver.

### [Community Database 123]

FIG. 5 is a diagram showing an exemplary community database 123. In community database 123, pieces of information of communities formed between companies are registered. The community information includes a “community ID” for identifying each of the communities, a “community name,” and a “company ID list” of the companies belonging to the community. Each company can form various communities by making agreements with the other companies. A company belonging to a community can change a company eligible to belong to the community, by making an agreement with the other companies.

### [Invitation Case Database 124]

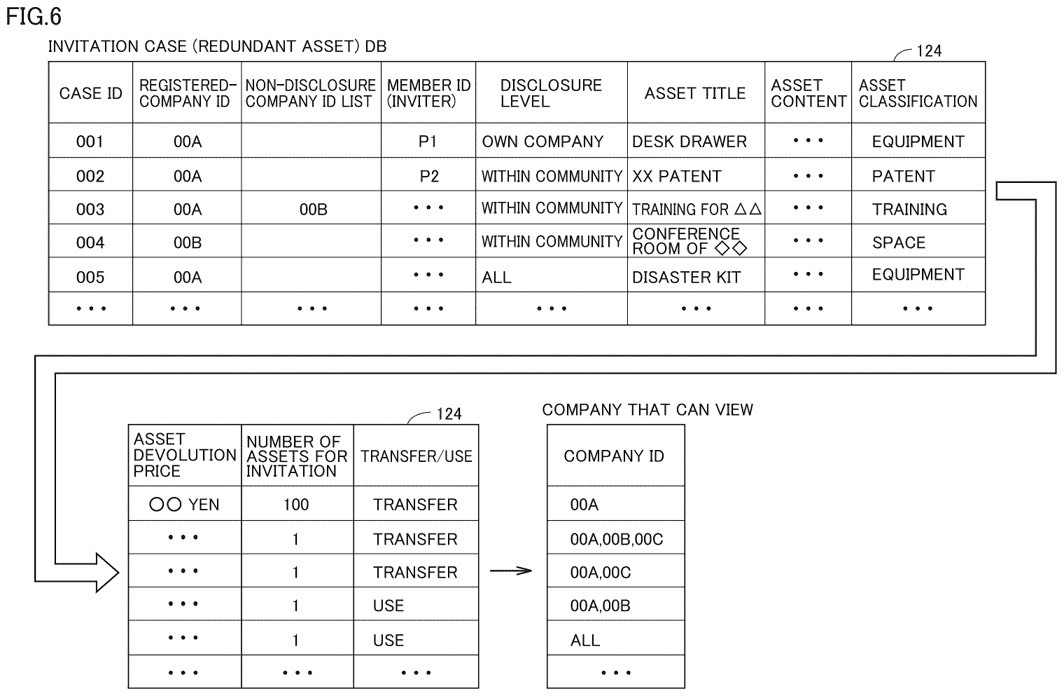

FIG. 6 is a diagram showing an exemplary invitation case database 124. In invitation case database 124, pieces of information of invitation cases are registered. The information of each of the invitation cases includes a “case ID (asset ID)” for identifying the invitation case, a “company ID” of a company to which an inviter having registered the invitation case belongs, a “non-disclosure company ID list,” a “member ID of inviter,” a “disclosure level,” an “asset title,” an “asset content,” an “asset classification,” an “asset devolution price,” the “number of assets for invitation,” and “transfer/use.”

For example, in the “non-disclosure company ID list,” the ID of a company to which the invitation case is prohibited to be disclosed is registered. In the “disclosure level,” any one of three levels, i.e., “own company,” “within community,” and “all” is set. When the disclosure level is set to “all,” the disclosure is made to those including an applicant outside the community.

On the right side of invitation case database 124 in FIG. 6, the IDs of companies that can view the invitation cases are shown. For example, in an invitation case corresponding to a case ID=001, the disclosure level is set to “own company.” In this case, only members belonging to a company (company ID=00A) having registered the invitation case can view the invitation case corresponding to the case ID=001. In this case, it is assumed that in the company identified by the company ID=00A, redundant assets of a certain department are to be transferred to or are to be used by another department.

In the description below, invitation cases corresponding to respective case IDs may be referred to as a case 001, a case 002, a case 003, etc. by using the case IDs. Similarly, communities corresponding to respective community IDs may be referred to as a community 01, a community 02, a community 03, etc. by using the community IDs, and members corresponding to respective member IDs may be referred to as a member P1, a member P2, a member P3, etc. by using the member IDs. Further, in the description below, companies corresponding to respective company IDs may be referred to as a company A, a company B, a company C, etc. by using parts of the company IDs.

In case 002, the disclosure level is set to “within community.” The inviter of case 002 is a member (member ID=P2) belonging to company A. According to community database 123 shown in FIG. 5, companies each having a community relationship with company A having registered case 002 are company B and company C. Therefore, as shown in FIG. 6, only members belonging to any of company A, company B, and company C can view case 002.

In case 003, the invitation case is registered by the same company as that in case 002 and the disclosure level is the same as that of case 002. However, in case 003, “00B” is registered in the “non-disclosure company ID list.” Therefore, as shown in FIG. 6, only the members belonging to any of company A and company C can view case 003, and the members belonging to company B are not each given an authority to view case 003.

In an invitation case for which the disclosure level is set to “all,” all the members can view the invitation case. Case 005 shown in FIG. 6 corresponds to this. If one or a plurality of company IDs are registered in the non-disclosure company ID list of case 005, the members belonging to the companies of the one or plurality of company IDs are not each given an authority to view case 005.

In the “asset title,” a title by which an overview of an asset for an invitation case is understandable is registered. For example, as an asset title corresponding to case 001, a desk drawer is registered. As understandable from asset titles shown in FIG. 6, various assets can be registered as the invitation cases, such as the desk drawer, a patent, a project plan, a conference room, and a welfare facility.

In the “asset content,” an explanation by which a content of an asset for an invitation case is understandable in detail is registered. In the “asset classification,” classifications such as equipment, patent, idea, space, facility, and the like are registered. In the “asset devolution price”, a price for transfer or use of an asset is registered.

In the “number of assets for invitation,” the number of assets to be transferred or used is registered. For example, the number of desk drawers corresponding to the asset ID=1 is 100.

In the “transfer/use,” information for specifying whether an invitation case of interest is an invitation case intended for transfer or an invitation case intended for use is registered. For example, case 001 is an invitation case intended for transfer, and the 100 desk drawers are transferred from the inviter to an acquirer for case 001 on condition that the asset devolution price is paid.

The conference room in case 004 is an invitation case intended for use, and a right to use the conference room is given from the inviter to an acquirer for case 004 on condition that the asset devolution price is paid. For example, when the conference room for which an application is invited is located in Tokyo and the company of the applicant is located in Osaka, the applicant can use the conference room when visiting Tokyo for business by acquiring case 004.

It should be noted that it is conceivable to employ various modifications with regard to the setting of the disclosure level. For example, the user may be allowed to control where to disclose the asset information by selecting a specific item. More specifically, a check box for selecting a company to which the asset information is to be disclosed may be provided on the screen for registering an invitation case. Alternatively, the user may select one of predefined options to control related information or function. For example, a list by which the user can select the scope of disclosure of the asset information from “within own company,” “within community,” and “all users” may be presented on the screen for registering an invitation case.

User device 500 may provide the user with a setting screen for variously setting the disclosure level. For example, the setting screen may present a checkbox to allow the user to select one to which the case is to be disclosed, on the business type basis such as “pharmaceutical,” “chemistry,” “electrical equipment,” “railway and bus,” or “food.” Further, by presenting company names corresponding to the business types on the setting screen, the user may be able to select one to which the disclosure is to be made, on the “business type” basis and the “company” basis.

For example, it is assumed that companies A, B, C, and D exist as companies corresponding to “pharmaceutical,” companies E, F, G, and H exist as companies corresponding to “chemistry,” and companies I, J, K, and L exist as companies corresponding to “electrical equipment.”

In this case, “company A” to “company D” are indicated to be included in the business type “pharmaceutical,” and check boxes respectively corresponding to “pharmaceutical,” “company A,” “company B,” “company C,” and “company D” are presented on the setting screen. Further, “company E” to “company H” are indicated to be included in the business type “chemistry,” and check boxes respectively corresponding to “chemistry,” “company E,” “company F,” “company G,” and “company H” are presented on the setting screen. Further, “company I” to “company L” are indicated to be included in the business type “electrical equipment,” and check boxes respectively corresponding to “electrical equipment,” “company I,” “company J,” “company K,” and “company L” are presented on the setting screen.

For example, it is assumed that the user checks the check boxes respectively corresponding to “pharmaceutical” and “chemistry” and does not check the check box corresponding to “electrical equipment.” In this case, the business type “electrical equipment” is excluded so as not to disclose the case thereto. Further, it is assumed that the check boxes corresponding to companies A to C each belonging to “pharmaceutical” and the check boxes corresponding to companies E to H each belonging to “chemistry” are checked, but the check box corresponding to company D belonging to “pharmaceutical” is not checked. In this case, companies A to C each belonging to “pharmaceutical” and companies E to H each belonging to “chemistry” are each handled as one to which the case is to be disclosed, but company D belonging to “pharmaceutical” is excluded so as not to disclose the case thereto.

### [Evaluation Input Database 126]

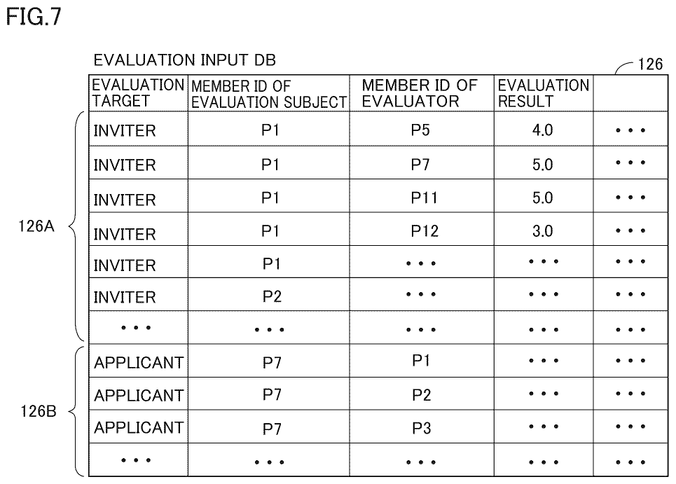

FIG. 7 is a diagram showing an exemplary evaluation input database 126. In evaluation input database 126, pieces of information of evaluations for evaluation subjects are registered. The information of each of the evaluations includes an evaluation target, a member ID of an evaluation subject, a member ID of an evaluator, and an evaluation result.

Evaluation input database 126 includes an inviter evaluation portion 126A and an applicant evaluation portion 126B. In inviter evaluation portion 126A, pieces of information of evaluations for inviters (transferers) are registered. In applicant evaluation portion 126B, pieces of information of evaluations for applicants (transferees) are registered.

In inviter evaluation portion 126A, the evaluation target (evaluation subject) corresponds to an inviter (transferer), and the evaluator corresponds to an applicant having applied for an invitation case from the evaluation target and having acquired the invitation case. In inviter evaluation portion 126A, an evaluation for an evaluation subject is registered on the evaluator basis. FIG. 7 shows an example in which each of members P1, P2 corresponding to the evaluation subjects is evaluated by all the evaluator members. In particular, FIG. 7 shows an example in which member P1 is evaluated by each of evaluator members P5, P7, P11, P12. Each of evaluation results (evaluation values) is represented by a numerical value with the maximum value of the evaluation result being 10 and the minimum value of the evaluation result being 0.

In applicant evaluation portion 126B, the evaluation target (evaluation subject) corresponds to an applicant (transferee) for an invitation case, and the evaluator corresponds to an inviter (transferer) for the case. In applicant evaluation portion 126B, an evaluation for the evaluation subject is registered on the evaluator basis. FIG. 7 shows an example in which member P7 corresponding to the evaluation subject is evaluated by members P1, P2, P3 corresponding to the evaluators. It should be noted that exemplary evaluation results in applicant evaluation portion 126B are not shown in FIG. 7; however, various evaluation results are registered therein in the same manner as in inviter evaluation portion 126A.

When an applicant (transferee) completes a transaction with an inviter (transferer), the applicant (transferee) uses applicant device 300 to evaluate, as an evaluator, the evaluation subject who is the inviter. An evaluation result by the evaluator is registered into evaluation input database 126. When a certain applicant acquires another invitation case again from an inviter from whom the applicant has acquired an invitation case, the applicant evaluates the inviter again. In this case, the average value of the previous evaluation result and the subsequent evaluation result is registered into evaluation input database 126.

When an inviter (transferer) completes a transaction with an applicant (transferee), the inviter (transferer) uses inviter device 200 to evaluate, as an evaluator, the evaluation subject who is the applicant. An evaluation result by the evaluator is registered into evaluation input database 126. When a certain inviter transfers another asset again to an applicant with whom the inviter has made a transaction for an asset, the inviter evaluates the applicant again. In this case, the average value of the previous evaluation result and the subsequent evaluation result is registered into evaluation input database 126.

Therefore, the average value of the evaluations made for the evaluation subject by the evaluator is reflected in each of the evaluation results registered in evaluation input database 126. It should be noted that instead of the average value, a weighted average value, a deviation value, or the like calculated in accordance with the number of evaluations may be employed. An evaluation result on the case ID basis may be further registered into evaluation input database 126.

### [Evaluation Summary Database 127]

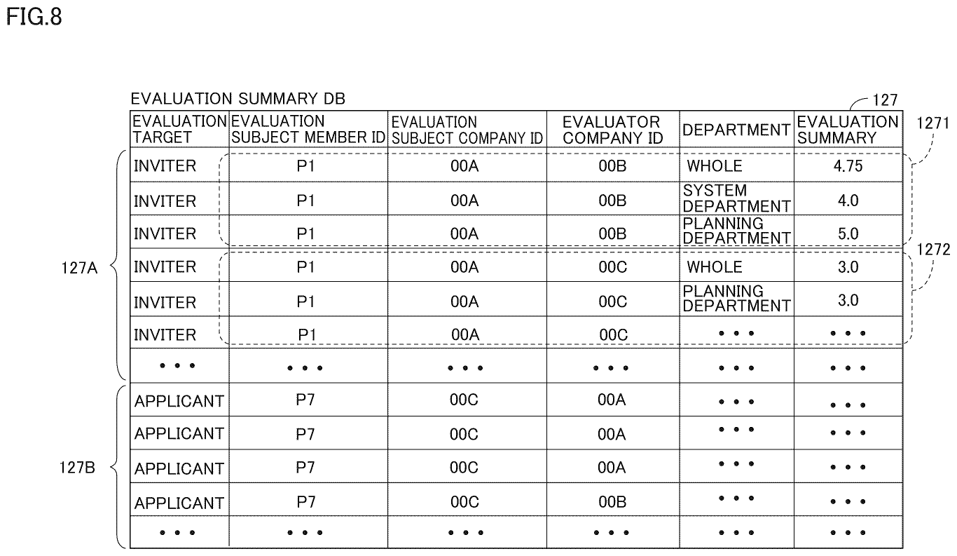

FIG. 8 is a diagram showing an exemplary evaluation summary database 127. In evaluation summary database 127, pieces of information of evaluations for evaluation subjects on the department basis are registered. The information of each of the evaluations on the organization basis includes an evaluation target, a member ID of the evaluation subject, an ID of a company to which the evaluation subject belongs, an ID of the company to which the evaluator belongs, a department to which the evaluator belongs, and an evaluation summary.

Evaluation summary database 127 includes an inviter evaluation summary portion 127A and an applicant evaluation summary portion 127B. In inviter evaluation summary portion 127A, the evaluation target (evaluation subject) corresponds to an inviter (transferer). In applicant evaluation summary portion 127B, the evaluation target (evaluation subject) corresponds to an applicant (transferee). In evaluation summary database 127, evaluation summaries for evaluation targets are registered on the department basis.

Each of the evaluation summaries is calculated based on an aggregation result of evaluation input database 126. A category for department includes: each of departments such as “system department” and “planning department” belonging to a company; and “whole,” which means the whole of the company. The evaluation summary is calculated on such a “department” basis.

For inviter evaluation summary portion 127A, FIG. 8 shows an example in which member P1 corresponds to the evaluation subject. The company ID of the evaluation subject is “00A.” Therefore, member P1 belongs to company A. In FIG. 8, a data group 1271 represents evaluations made by company B for member P1 who behaves as an inviter, and a data group 1272 represents evaluations made by company C for member P1 who behaves as an inviter.

Referring to data group 1271, it is understandable that the evaluations by company B are classified into an evaluation by the whole of the company, an evaluation by the system department in company B, and an evaluation by the planning department in company B. In the evaluation summary, the average value of the evaluations corresponding to each of the classified categories is registered.

For example, as an evaluation summary corresponding to the whole of company B, the average value of evaluation results by the members of company B who have evaluated member P1 who behaves as an inviter is registered. In FIG. 8, the value is “4.75.” As an evaluation summary corresponding to the system department, the average value of evaluation results by the members who belong to the system department among the members of company B and who have evaluated member P1 who behaves as an inviter is registered. In FIG. 8, the value is “4.0.” As an evaluation summary corresponding to the planning department, the average value of evaluation results by the members who belong to the planning department among the members of company B and who have evaluated member P1 who behaves as an inviter is registered. In FIG. 8, the value is “5.0.”

In data group 1272, the evaluations by company C are classified into an evaluation by the whole of the company and evaluations by the respective departments in company C as in data group 1271. Each of data groups 1271, 1272 is data for evaluating the inviter. Therefore, the evaluation summaries registered in data groups 1271, 1272 are inviter evaluation summaries.

Inviter evaluation summary portion 127A has been described in detail above. Next, applicant evaluation summary portion 127B will be described. For applicant evaluation summary portion 127B, FIG. 8 shows an example in which member P7 corresponds to the evaluation subject. The company ID of the evaluation subject is “00C.” Therefore, member P7 belongs to company C. In applicant evaluation summary portion 127B, evaluations for member P7 who behave as an applicant are registered on the department basis.

Applicant evaluation summary portion 127B has the same structure as that of applicant evaluation summary portion 127A except that the evaluation target is not the “inviter” but the “applicant.” Therefore, here, the above-described explanation of inviter evaluation summary portion 127A applies to the explanation of applicant evaluation summary portion 127B.

Sharing server 100 specifies the evaluation result for each member using evaluation input database 126, and specifies where the member belongs using member database 122. Sharing server 100 updates the data of evaluation summary database 127 based on the results of specifying them.

It should be noted that FIG. 8 shows only members P1, P7 as the evaluation subjects; however, each of members P2 to P6, P8, and P9 etc. is also registered in evaluation summary database 127 as an evaluation subject. Evaluation summary database 127 may include data in which a certain member is evaluated as an inviter and an applicant. For example, in evaluation summary database 127 shown in FIG. 8, the applicant evaluation summary for member P1 may be registered in addition to the inviter evaluation summary for member P1.

### [Functions of Sharing Server, Inviter Device, and Applicant Device]

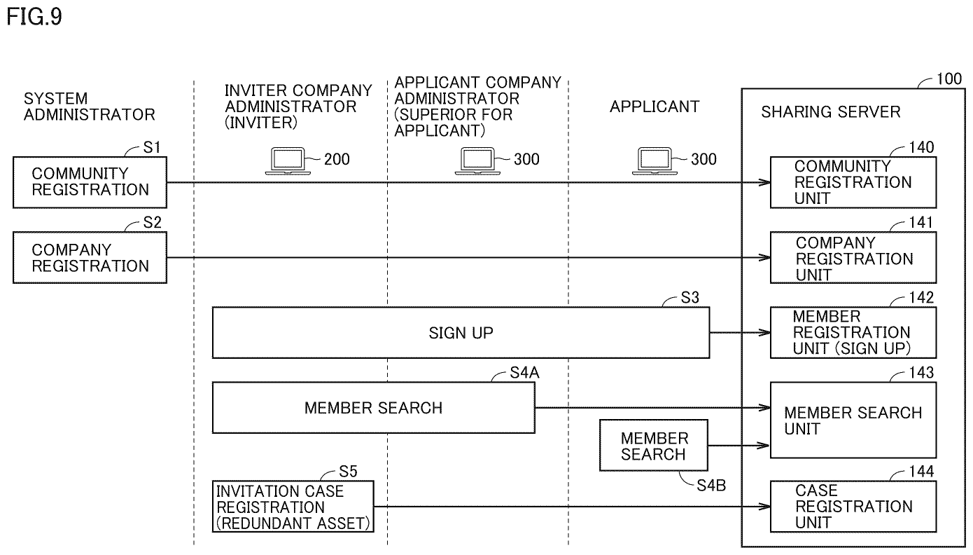

Each of FIGS. 9 to 11 is a diagram for illustrating functions of the sharing server, the inviter device, and the applicant device.

As shown in FIG. 9, sharing server 100 functionally includes a community registration unit 140, a company registration unit 141, a member registration unit 142, a member search unit 143, and a case registration unit 144. These various functions are realized by processor 101, memory 102, storage 103, and communication interface 104 included in sharing server 100.

Community registration unit 140 has a function of registering a community into community database 123. A system administrator who manages matching system 1 inputs information about the community into sharing server 100 using the operation unit such as a keyboard (not shown).

The information about the community includes a community name and information of a company belonging to the community. Community registration unit 140 registers the community into community database 123 in accordance with the input from the system administrator (step S1). Community registration unit 140 further has a function of updating information of a community registered in community database 123.

Company registration unit 141 has a function of registering a new company to participate in matching system 1. The system administrator inputs information about the company into sharing server 100 using the operation unit such as a keyboard.

The information about the company includes information such as a company name and an address. Company registration unit 141 registers the company into company database 121 in accordance with the input from the system administrator (step S2). Company registration unit 141 further has a function of updating information of a company having been already registered.

Member registration unit 142 has a function of registering (signing up) a new member to participate in matching system 1. Member registration unit 142 issues a member ID and a password in response to a request from one belonging to a company participating in matching system 1. One who would like to become a member performs a sign-up process using a personal computer or the like (step S3).

Specifically, one who would like to become a member inputs information into the personal computer or the like such as a name, a company to which he/she belongs, and a department to which he/she belongs, and transmits the input information to sharing server 100. Member registration unit 142 registers the input information into member database 122. The new member can sign in to sharing server 100 using the personal computer used for the member registration. In this case, the personal computer functions as inviter device 200 or applicant device 300.

FIG. 9 shows two applicant devices 300. One applicant device is a device assumed to be operated by an administrator of the applicant company. The other applicant device is a device assumed to be operated by a person other than the administrator in the applicant company. The administrator of the applicant company is engaged in a manager job such as a department director, and corresponds to a superior for the applicant who is a subordinate. The administrator of the applicant company plays a role as an approver who approves an application made to an invitation case by the subordinate.

Member search unit 143 has a function of searching for a member of matching system 1. In response to a request from each of inviter device 200 and applicant device 300, member search unit 143 provides a corresponding one of inviter device 200 and applicant device 300 with information of a member registered in member database 122.

When receiving a search operation from the inviter, inviter device 200 performs a member search process (step S4A). Thus, the inviter can view, for example, pieces of information of applicants. From the plurality of applicants, the inviter can select one to whom an asset for an invitation case is to be transferred in consideration of the pieces of information of the applicants. Similarly, when receiving a search operation from an administrator corresponding to a superior for a certain applicant, applicant device 300 performs a member search process (step S4A).

Further, when receiving a search operation from the applicant, applicant device 300 performs a member search process (step S4B). Thus, the applicant can view, for example, pieces of information of inviters. From a plurality of invitation cases, the applicant can select a case including an asset which the applicant would like to receive transfer in consideration of the pieces of information of the inviters.

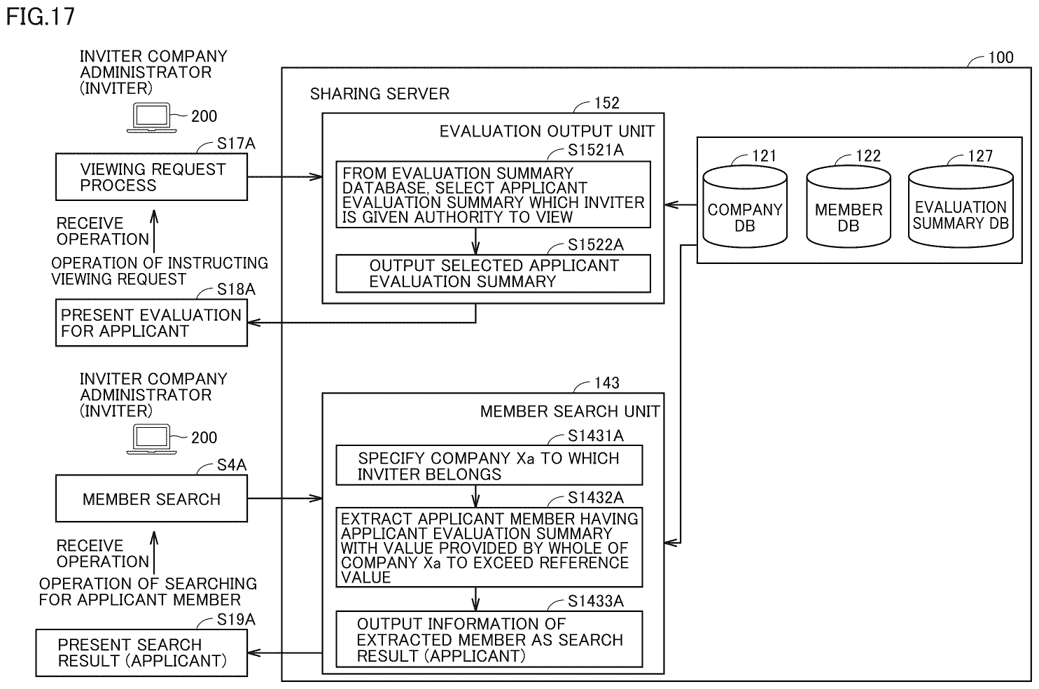

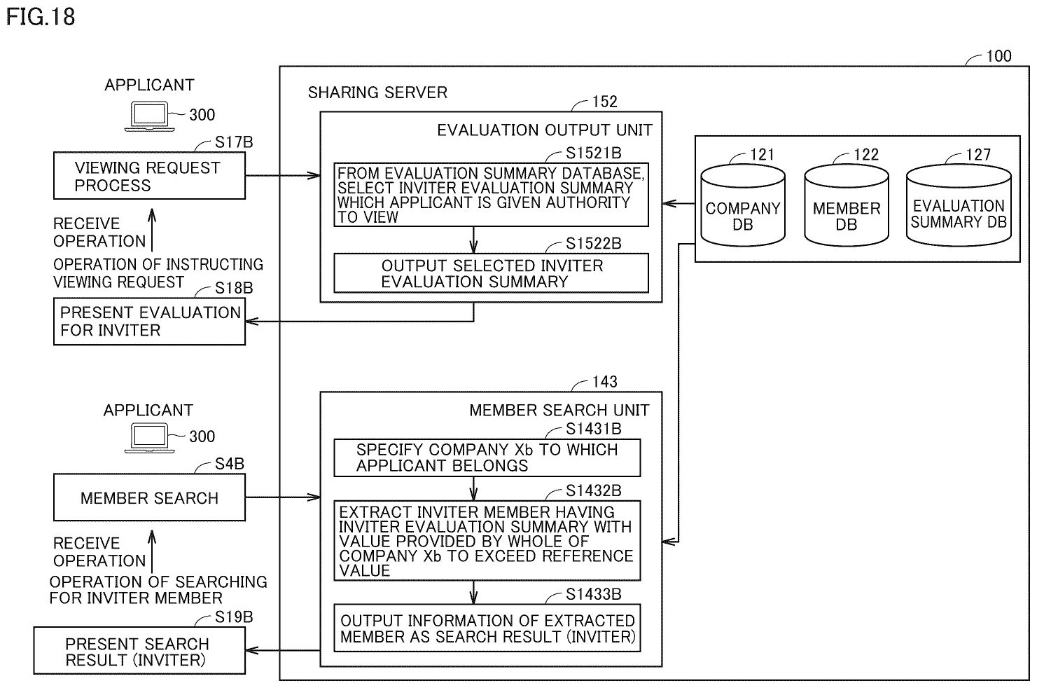

The member search process (step S4A) performed by inviter device 200 and the process of member search unit 143 will be described in detail later with reference to FIG. 17. The member search process (step S4B) performed by applicant device 300 and the process of member search unit 143 will be described in detail later with reference to FIG. 18.

Case registration unit 144 has a function of registering an invitation case into invitation case database 124. When receiving an operation of inputting an invitation case, inviter device 200 performs a process of registering the invitation case (step S5). In the process of registering the invitation case, inviter device 200 transmits information of the invitation case to sharing server 100. Case registration unit 144 registers the received information of the invitation case into invitation case database 124.

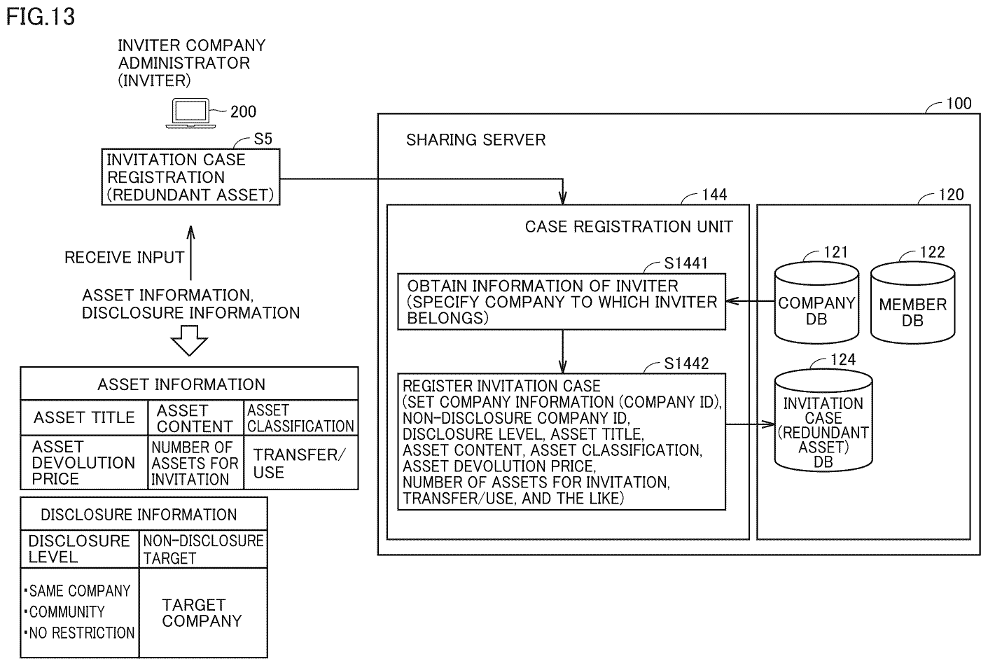

The invitation case registration process (step S5) performed by inviter device 200 and the process of case registration unit 144 will be described in detail later with reference to FIG. 13.

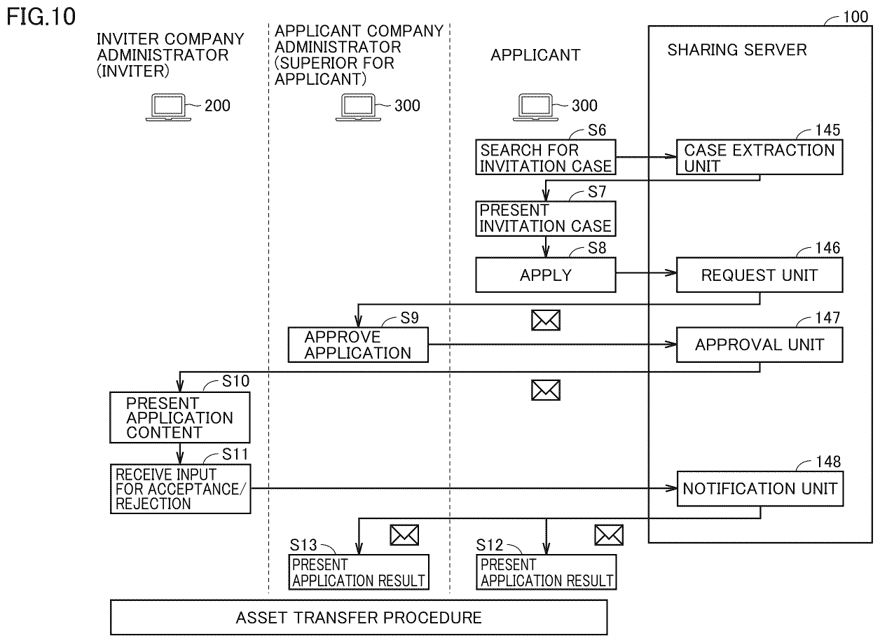

As shown in FIG. 10, sharing server 100 functionally includes a case extraction unit 145, a request unit 146, an approval unit 147, and a notification unit 148. These various functions are realized by processor 101, memory 102, storage 103, and communication interface 104 included in sharing server 100.

Case extraction unit 145 has a function of extracting an invitation case that can be viewed by an applicant. Request unit 146 has a function of requesting an administrator (superior for an applicant) to approve an application from the applicant. Approval unit 147 has a function of transmitting the content of the application for the invitation case to the inviter on condition that the approval of the application is received from the administrator (approver). Notification unit 148 has a function of receiving, from inviter device 200, information indicating whether or not the application from the applicant is accepted or rejected, and notifying, to applicant device 300 of each of the applicant and the administrator, an application result (acceptance or rejection) corresponding to the information.

Request unit 146, approval unit 147, and notification unit 148 realize, by a workflow system, the notification for requesting the administrator for approval, the notification for notifying the applicant to the inviter, and the notification for notifying the application result to the applicant.

When receiving an operation from an applicant to request a search for invitation case, applicant device 300 performs a search process for invitation case (step S6). In the search process for invitation case, applicant device 300 transmits a search request to case extraction unit 145 of sharing server 100.

When the search request is received, case extraction unit 145 extracts cases each permitted to be viewed by the applicant from the invitation cases registered in invitation case database 124, and transmits the extracted cases to applicant device 300. Case extraction unit 145 determines, based on a scope of disclosure set in each of the invitation cases, that the case is permitted to be viewed by the applicant. The scope of disclosure is defined by disclosure information.

Based on the determination result, case extraction unit 145 extracts, from the invitation cases registered in invitation case database 124, cases each permitted to be disclosed to the applicant from whom the search request has been received. Case extraction unit 145 transmits, to applicant device 300, the cases each permitted to be viewed by the applicant.

Applicant device 300 receives the invitation cases from case extraction unit 145. Applicant device 300 presents the received invitation cases on display 305 (step S7). With this, the applicant can view the invitation cases as a search result.

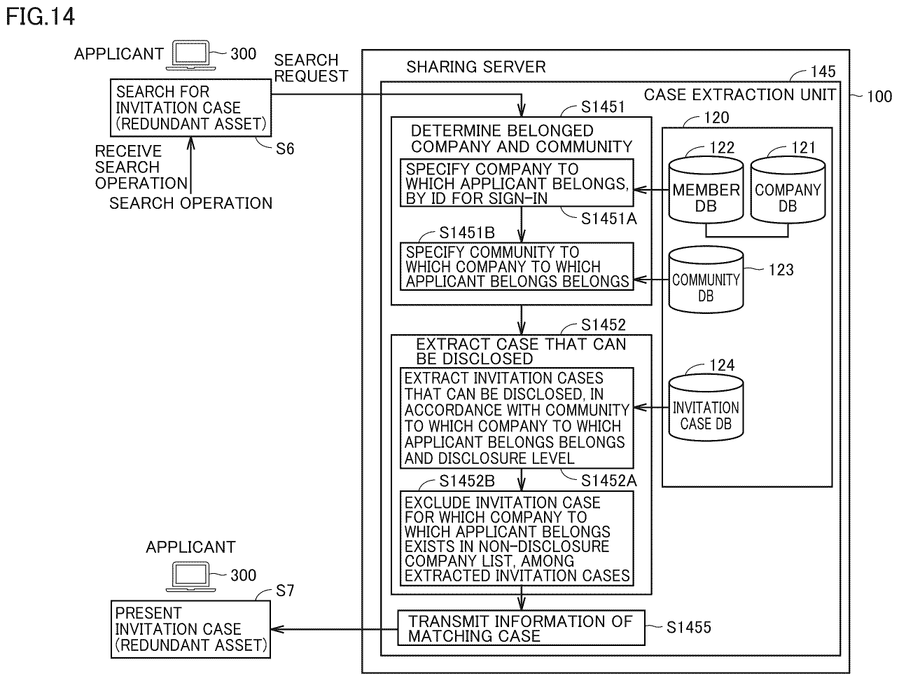

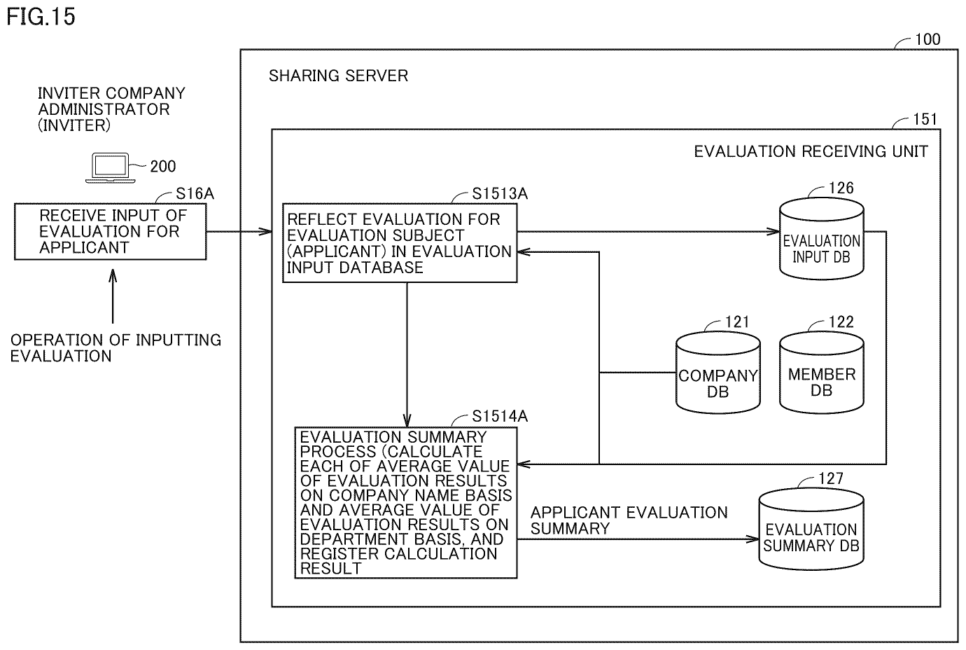

It should be noted that the invitation case search process (step S6), the process of presenting the invitation cases (step S7), and the process of case extraction unit 145 will be described in detail later with reference to FIG. 14.

The applicant performs an operation of selecting a case for which an application is to be made, from the invitation cases presented on display 305 in applicant device 300. Applicant device 300 performs an application process in response to an operation from the applicant (step S8). In the application process, applicant device 300 transmits, to request unit 146 of sharing server 100, application information indicating the case for which the application is to be made.

Request unit 146 transmits, to applicant device 300 of the administrator (superior for the applicant), the application information received from applicant device 30. For example, request unit 146 specifies the member ID of the superior, who is the administrator for the applicant, based on a relationship between the member ID of the applicant and the member ID of the superior as registered in member database 122.

Request unit 146 transmits, to applicant device 300 corresponding to the specified member ID of the superior, the application information received from the subordinate. The application information transmitted to applicant device 300 includes the “asset title,” the “asset content,” the “asset classification,” the “asset devolution price,” the “number of assets for invitation,” and the “transfer/use” registered in invitation case database 124. In applicant device 300 of the administrator, the administrator checks the content of the invitation case for which the subordinate applies.

In applicant device 300, the administrator performs an operation for approving the application. Applicant device 300 receives an approval operation and performs an application approval process (step S9). In the application approval process, applicant device 300 transmits approval information to approval unit 147 of sharing server 100. Thus, the approval information, which serves as an exemplary approval notification, is transmitted from applicant device 300 of the administrator (approver) to approval unit 147.

Approval unit 147 receives the application from the applicant on condition that the approval information is received from applicant device 300. In this way, the application from the applicant is received on condition that the approval is made by the administrator for the applicant. Therefore, the administrator can beforehand check the content of the invitation case for which the application is to be made by the subordinate.

It should be noted that FIG. 10 shows a flow when the administrator approves the application. If an operation of turning down the application is received in step S9, turndown information is transmitted from applicant device 300 of the administrator to approval unit 147. When the turndown information is received, approval unit 147 may notify applicant device 300 of the applicant that the application has been turned down.

Approval unit 147 having received the application from the applicant transmits the application information to inviter device 200. The application information includes the information of the applicant and the content of the invitation case for which the application is made. Inviter device 200 presents the content of the application information on display 205 (step S10). The inviter checks the applicant and the invitation case based on the presentation on display 205, and determines whether to accept or reject the application from the applicant.

The inviter inputs, to inviter device 200, a result of determination for acceptance or rejection. Inviter device 200 receives the input result (step S11). Inviter device 200 transmits the received result of acceptance or rejection to notification unit 148 of sharing server 100.

When the result of acceptance or rejection is received from inviter device 200, notification unit 148 transmits the application result (result of acceptance or rejection) to each of applicant device 300 of the applicant and applicant device 300 of the administrator.

Each of applicant device 300 of the applicant and applicant device 300 of the administrator presents the applicant result on display 305 (steps S12, S13). Each of the applicant and the administrator checks the application result by viewing the presentation on display 305. When the application is accepted, a procedure of transferring the asset of interest is performed between the inviter and the applicant.

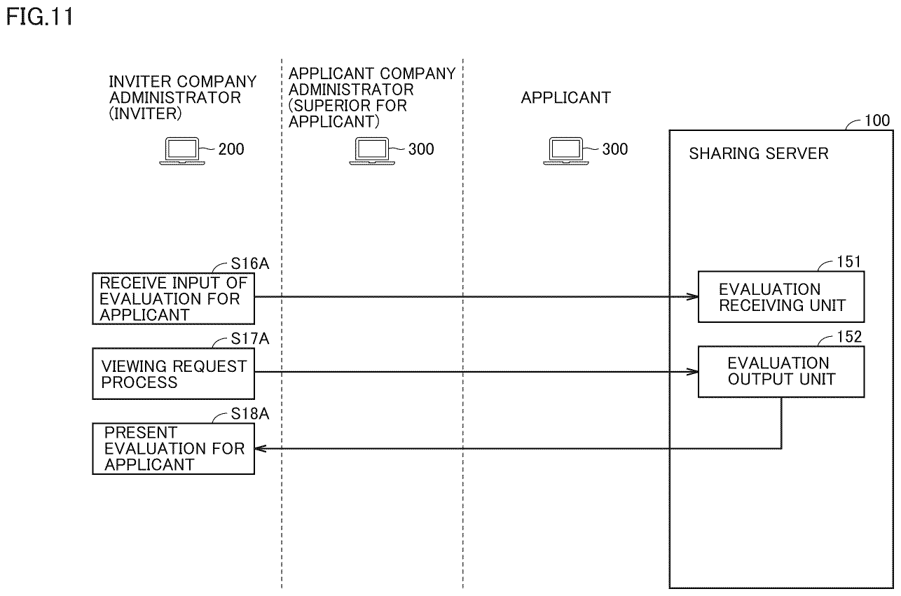

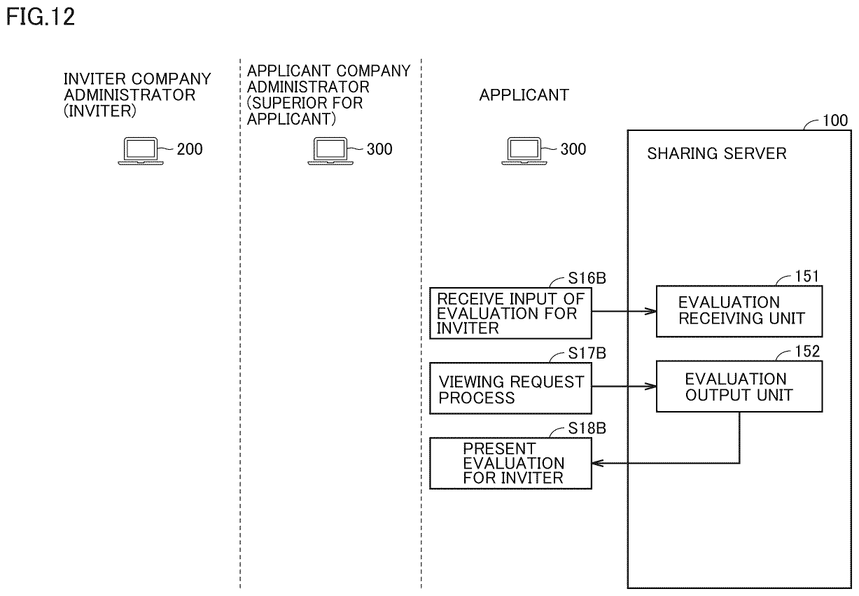

As shown in FIG. 11, sharing server 100 functionally includes an evaluation receiving unit 151 and an evaluation output unit 152. These functions are realized by processor 101, memory 102, storage 103, and communication interface 104 included in sharing server 100.

Evaluation receiving unit 151 has a function of receiving an evaluation for an applicant as input by an inviter in inviter device 200. Evaluation output unit 152 has a function of outputting information indicating the evaluation for the applicant to inviter device 200. The inviter inputs the evaluation for the applicant to inviter device 200 when the inviter completes the transaction with the applicant with regard to the invitation case. The inviter evaluates the applicant based on various points.

For example, when the inviter could communicate with the applicant without trouble and complete the transaction in a short time, the inviter gives the applicant a high magnitude of evaluation. Conversely, when the applicant frequently requested to change the asset devolution price or when a response from the applicant in communication regarding the transaction is slow, the inviter gives the applicant a low magnitude of evaluation.

Inviter device 200 receives input of the evaluation for the applicant (step S16A). Therefore, inviter device 200 functions as an evaluator device operated by the evaluator (inviter) when receiving the input evaluation.

Inviter device 200 transmits the received evaluation to evaluation receiving unit 151 of sharing server 100. Evaluation receiving unit 151 updates evaluation input database 126 and evaluation summary database 127 based on the received evaluation. Thus, the information of applicant evaluation portion 126B is updated in evaluation input database 126, and the information of applicant evaluation summary portion 127B is updated in evaluation summary database 127.

The process of step S16A performed by inviter device 200 and the process of evaluation receiving unit 151 will be described in detail later with reference to FIG. 15.

When an operation by the inviter for viewing the evaluation of the applicant is received, inviter device 200 performs a viewing request process (step S17A). In the viewing request process, inviter device 200 transmits a viewing request to evaluation output unit 152 of sharing server 100. In response to the viewing request, evaluation output unit 152 transmits, to inviter device 200, the evaluation (applicant evaluation summary) for the applicant as registered in evaluation summary database 127. Inviter device 200 presents the received evaluation for the applicant on display 205 (step S18A).

The processes of steps S17A, S18A performed by inviter device 200 and the process of evaluation output unit 152 will be described in detail later with reference to FIG. 17.

FIG. 12 is a diagram for further illustrating the function of applicant device 300. Here, input and output of an evaluation for the inviter will be described with reference to FIG. 12. Evaluation receiving unit 151 further has a function of receiving the evaluation for the inviter as input by the applicant in applicant device 300. Evaluation output unit 152 further has a function of outputting information indicating the evaluation for the inviter to applicant device 300. When the applicant completes the transaction for the invitation case with the inviter, the applicant inputs the evaluation for the inviter into applicant device 300. The applicant evaluates the inviter based on various points.

For example, when the inviter could communicate with the inviter without trouble and complete the transaction in a short time, the applicant gives the inviter a high magnitude of evaluation. Conversely, when the inviter frequently requests to change the transaction price or when the state of the asset involved in the transaction is poor, the applicant gives the inviter a low magnitude of evaluation.

Applicant device 300 receives input of the evaluation for the inviter (step S16B). Therefore, applicant device 300 functions as an evaluator device operated by the evaluator (applicant) when receiving the input evaluation.

Applicant device 300 transmits the received evaluation to evaluation receiving unit 151 of sharing server 100. Evaluation receiving unit 151 updates evaluation input database 126 and evaluation summary database 127 based on the received evaluation. Thus, the information of inviter evaluation portion 126A is updated in evaluation input database 126, and the information of inviter evaluation summary portion 127A is updated in evaluation summary database 127.

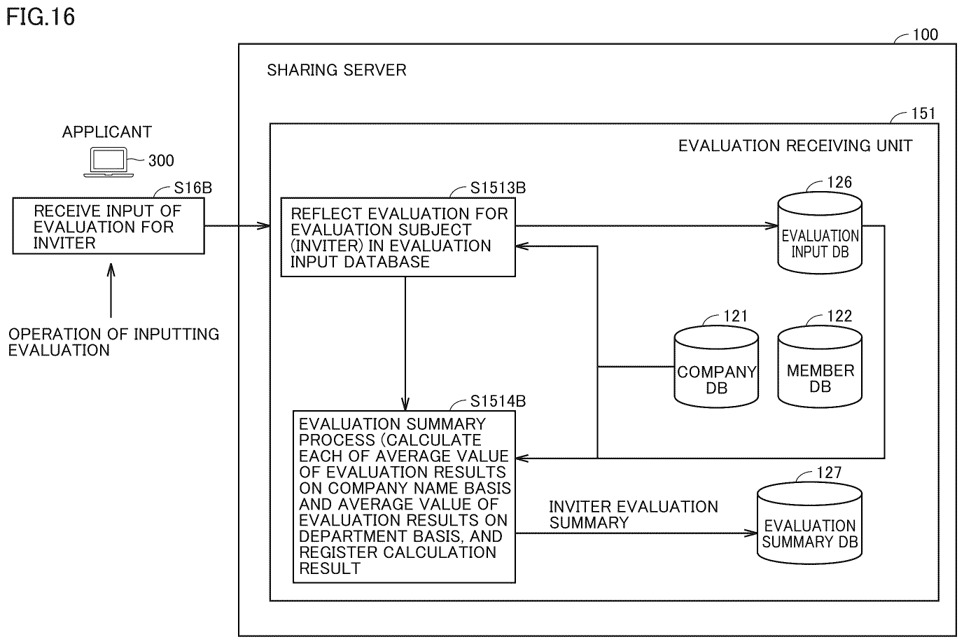

The process of step S16B performed by applicant device 300 and the process of evaluation receiving unit 151 will be described in detail later with reference to FIG. 16.

When an operation by the applicant for viewing the evaluation for the inviter is received, applicant device 300 performs a viewing request process (step S17B). In the viewing request process, applicant device 300 transmits a viewing request to evaluation output unit 152 of sharing server 100. In response to the viewing request, evaluation output unit 152 transmits, to applicant device 300, the evaluation for the inviter as registered in evaluation summary database 127 (inviter evaluation summary). Applicant device 300 presents the received evaluation for the inviter on display 305 (step S18B).

The processes of steps S17B, S18B performed by applicant device 300 and the process of evaluation output unit 152 will be described in detail later with reference to FIG. 18.

### [Details of Processes of Case Registration Unit 144 and Inviter Device 200]

FIG. 13 is a diagram for illustrating a procedure of registering an invitation case into invitation case database 124. Step S5 and the function of case registration unit 144 in FIG. 9 will be described more in detail with reference to FIG. 13.

An inviter to register an invitation case first signs in to sharing server 100 using inviter device 200. Thus, a logical communication path identified by the member ID of the inviter is established between inviter device 200 and sharing server 100. Then, the inviter inputs asset information and disclosure information of the invitation case into inviter device 200 using operation unit 206 such as a mouse and a keyboard.

The asset information includes “asset title,” “asset content,” “asset classification,” “asset devolution price,” “number of assets for invitation,” and “transfer/use.” The disclosure information includes a disclosure level. In accordance with a selection by the inviter, the disclosure information may include the ID of a company that is a “non-disclosure target.”

The information input by operation unit 206 is notified to processor 201 via input/output interface 204 of inviter device 200. Operation unit 206 and input/output interface 204 constitute an interface that receives an operation of inputting the content of the invitation case and an operation of inputting the disclosure information.

Inviter device 200 receives the input of the asset information and the disclosure information of the invitation case, and performs a process of registering the invitation case (step S5). In the process of registering the invitation case, inviter device 200 transmits the asset information and the disclosure information of the invitation case to sharing server 100.

Case registration unit 144 of sharing server 100 obtains the information of the inviter (step S1441). Specifically, case registration unit 144 specifies the company to which the inviter belongs.

When a member signs in to sharing server 100 using inviter device 200 or applicant device 300, sharing server 100 stores the member ID used for signing in. When some information is received from inviter device 200 or applicant device 300 in the communication established in accordance with this member ID, sharing server 100 identifies the member, who is the origin of transmission of the information, by the member ID used for the sign-in.

Therefore, when the asset information and the disclosure information of the invitation case are received from inviter device 200, case registration unit 144 specifies the inviter, who is operating inviter device 200, by using the member ID used for the sign-in. Case registration unit 144 identifies the member who is the inviter and the company to which the inviter belongs, by using the specified member ID, member database 122, and company database 121.

Next, case registration unit 144 performs a process of registering the invitation case into invitation case database 124 (step S1442). Specifically, case registration unit 144 generates a case ID, and then registers, into invitation case database 124, the company information (company ID), the disclosure information (the disclosure level and the ID of the company to which disclosure is not to be made), the asset information (the information of the asset title, the asset content, the asset classification, the asset devolution price, the number of assets for invitation, and the transfer/use), and the like in association with the generated case ID.

According to the present embodiment, the inviter can freely control the scope of disclosure of the invitation case to fall within the following level: “within own company,” “within community,” or “no restriction.” As a result, an invitation case unintended by the inviter can be hindered from being disclosed to a specific company such as a competitor.

According to the present embodiment, the company to which disclosure is not to be made can be set separately from the disclosure level. Therefore, the inviter can set the scope of disclosure while excluding a part of companies among the plurality of companies each having a community relationship with the company to which the inviter belongs. As a result, the information of the invitation case can be prevented from being leaked to a specific company in the community.

Instead of or in addition to the non-disclosure company ID list, a non-disclosure member ID list for registering a member ID to prohibit the invitation case from being disclosed thereto may be provided in invitation case database 124. Inviter device 200 may receive an operation of designating a member to whom the invitation case is prohibited from being disclosed, and may transmit the ID of the member to sharing server 100. Sharing server 100 may be configured not to provide the member corresponding to the member ID listed in the non-disclosure member ID list with the invitation case corresponding to the list. Thus, inviter device 200 may receive either a company or a member as a target to whom the invitation case is prohibited from being disclosed.

FIG. 14 is a diagram for illustrating a procedure of searching for an invitation case in database 120. The processes of steps S6, S7 and the function of case extraction unit 145 in FIG. 10 will be described more in detail with reference to FIG. 14.

When an operation by the applicant for requesting a search for invitation case, applicant device 300 performs a search process for invitation case (step S6). In the search process for invitation case, applicant device 300 transmits a search request to case extraction unit 145 of sharing server 100.

When the search request is received, case extraction unit 145 extracts cases each permitted to be viewed by the applicant from the invitation cases registered in invitation case database 124. To this end, case extraction unit 145 performs processes of steps S1451, S1452.

Each of steps S1451, S1452 is a process of extracting, based on the scope of disclosure set in each of the invitation cases, the cases each permitted to be viewed by the applicant. In step S1451, the company to which the applicant belongs and the community of the company to which the applicant belongs are determined. In step S1452, invitation cases that can be each disclosed are extracted.

### [Process of Extracting Cases Based on Scopes of Disclosure]

Step S1451 includes a step S1451A and a step S1451B.

In step S1451A, the company to which the applicant belongs is specified based on the member ID used for the sign-in, company database 121, and member database 122.

In step S1451B, the community of the company to which the applicant belongs is specified based on the ID of the company to which the applicant belongs and community database 123.

Step S1452 includes a step S1452A and a step S1452B.

In step S1452A, the invitation cases that can be each disclosed to the applicant are extracted from invitation case database 124 based on the community to which the company to which the applicant belongs belongs and the disclosure level.

In step S1452B, among the invitation cases extracted in step S1452A, an invitation case for which the company to which the applicant belongs exists in the non-disclosure company list is excluded. Thus, matching cases that can be each disclosed to the applicant are extracted.

### [Process of Providing Extracted Cases]

Next, case extraction unit 145 transmits information of the matching cases to applicant device 300 (step S1455). Applicant device 300 receives the matching cases. Applicant device 300 presents the received matching cases as the invitation cases on display 305 in the form of a list (step S7). The applicant is provided with the invitation cases falling within the scopes of disclosure intended by the inviters. Thus, when the applicant searches for an invitation case, only an invitation case that does not give a disadvantage to an inviter is provided to the applicant. As a result, for example, the information about the asset of the company to which the inviter belongs can be prevented from being leaked to a competitor.

### [Process of Registering Evaluation Result (Evaluation for Applicant)]

FIG. 15 is a diagram for illustrating a procedure of registering an evaluation for an applicant into database 120. Step S16A and the function of evaluation receiving unit 151 in FIG. 11 will be described more in detail with reference to FIG. 15.

When the inviter completes the transaction with the applicant, the inviter operates inviter device 200 to input an evaluation for the applicant into inviter device 200. Inviter device 200 receives the input evaluation (step S16A). Inviter device 200 transmits the received evaluation to evaluation receiving unit 151 of sharing server 100. The information transmitted from inviter device 200 to sharing server 100 includes the member ID and the evaluation value (0 to 10) of the applicant who is an evaluation subject.

When the information of the evaluation for the evaluation subject (applicant) is received from inviter device 200, evaluation receiving unit 151 reflects the evaluation for the evaluation subject in evaluation input database 126 (step S1513A).

When an evaluation result for the evaluation subject (applicant) has been already registered in evaluation input database 126, evaluation receiving unit 151 incorporates the value of the evaluation received this time so as to calculate the average value of the evaluation results for the evaluation subject. Evaluation receiving unit 151 updates the evaluation result registered in evaluation input database 126 with the calculated average value. As a result, in evaluation input database 126, the average value (evaluation result) of the evaluations for the evaluation subject (applicant) on the evaluator (inviter) basis is registered. Thus, the information of applicant evaluation portion 126B is updated in evaluation input database 126.

Next, evaluation receiving unit 151 performs an evaluation summary process (step S1514A). In the evaluation summary process, evaluation receiving unit 151 calculates each of the average value of the evaluation results for the evaluation subject (applicant) on the company basis and the average value of the evaluation results for the evaluation subject (applicant) on the department basis, and registers the calculation result into evaluation summary database 127. Thus, the information of applicant evaluation summary portion 127B is updated in evaluation summary database 127.

For example, evaluation receiving unit 151 specifies the evaluator (inviter) using the member ID used by inviter device 200 for the sign-in to perform step S16A. Evaluation receiving unit 151 specifies the ID of the company to which the evaluator belongs, the department to which the evaluator belongs, the member ID of the evaluation subject, and the ID of the company to which the evaluation subject belongs, based on the information of the evaluation received in step S1513A, company database 121, and member database 122. The “member ID” is an example of “identification information by which sharing server 100 including evaluation receiving unit 151 can identify where (company and department) one who has accessed sharing server 100 belongs.”

Evaluation receiving unit 151 accesses evaluation summary database 127 and detects a data row in which the specified IDs (the member ID of the evaluation subject, the ID of the company to which the evaluation subject belongs, and the ID of the company to which the evaluator belongs) are arranged. Evaluation receiving unit 151 updates the values of the applicant evaluation summary corresponding to the detected data row.

### [Process of Registering Evaluation Result (Evaluation for Inviter)]

FIG. 16 is a diagram for illustrating a procedure of registering an evaluation for an inviter into the database. Step S16B and the function of evaluation receiving unit 151 in FIG. 12 will be described more in detail with reference to FIG. 16.

After completing the transaction with the inviter, the applicant operates applicant device 300 to input an evaluation for the inviter into applicant device 300. Applicant device 300 receives the input evaluation (step S16B). Applicant device 300 transmits the received evaluation to evaluation receiving unit 151 of sharing server 100. The information transmitted from applicant device 300 to sharing server 100 includes the member ID and the evaluation value (0 to 10) of the inviter who is an evaluation subject.

When the information of the evaluation for the evaluation subject (inviter) is received from applicant device 300, evaluation receiving unit 151 reflects the evaluation for the evaluation subject in evaluation input database 126 (step S1513B).

When an evaluation result for the evaluation subject (inviter) has been already registered in evaluation input database 126, evaluation receiving unit 151 incorporates the value of the evaluation received this time so as to calculate the average value of the evaluation results for the evaluation subject. Evaluation receiving unit 151 updates the evaluation result registered in evaluation input database 126 with the calculated average value. As a result, in evaluation input database 126, the average value (evaluation result) of the evaluations for the evaluation subject (inviter) on the evaluator (applicant) basis is registered. Thus, the information of inviter evaluation portion 126A is updated in evaluation input database 126.

Next, evaluation receiving unit 151 performs an evaluation summary process (step S1514B). In the evaluation summary process, evaluation receiving unit 151 calculates each of the average value of the evaluation results for the evaluation subject (inviter) on the company basis and the average value of the evaluation results for the evaluation subject (inviter) on the department basis, and registers the calculation result into evaluation summary database 127. Thus, the information of inviter evaluation summary portion 127A is updated in evaluation summary database 127.

For example, evaluation receiving unit 151 specifies the evaluator (applicant) using the member ID used by applicant device 300 for the sign-in to perform step S16B. Evaluation receiving unit 151 specifies the ID of the company to which the evaluator belongs, the department to which the evaluator belongs, the member ID of the evaluation subject, and the ID of the company to which the evaluation subject belongs, based on the information of the evaluation received in step S1513B, company database 121, and member database 122. The “member ID” is an example of “identification information by which sharing server 100 including evaluation receiving unit 151 can identify where (company and department) one who has accessed sharing server 100 belongs.”

Evaluation receiving unit 151 accesses evaluation summary database 127 and detects a data row in which the specified IDs (the member ID of the evaluation subject, the ID of the company to which the evaluation subject belongs, and the ID of the company to which the evaluator belongs) are arranged. Evaluation receiving unit 151 updates the values of the inviter evaluation summary corresponding to the detected data row.

For example, in data group 1271 of FIG. 8, the member ID=P1 of the evaluation subject, the ID=00A of the company to which the evaluation subject belongs, and the ID=00B of the company to which the evaluator belongs are arranged. When a member belonging to the system department of company B evaluates member P1, the evaluation is received in step S1513B.

In this case, in step S1514B, the evaluation received in step S1513B is reflected in each of the inviter evaluation summary corresponding to the “whole” of data group 1271 and the inviter evaluation summary corresponding to the “system department.”

More specifically, evaluation receiving unit 151 regards, as the inviter evaluation summary corresponding to the “whole” in the data group 1271, the average value of the evaluations made by the whole of company B and including the evaluation received in step S1513B. Similarly, evaluation receiving unit 151 regards, as the inviter evaluation summary corresponding to the “system department” in data group 1271, the average values of the evaluations made by the system department and including the evaluation received in step S1513B.

FIG. 17 is a diagram for illustrating a procedure of presenting an evaluation for an applicant and a search result for member on display 205. Step S4A (process of inviter device 200) and the function of member search unit 143 in FIG. 10 as well as steps S17A, S18A and the function of evaluation output unit 152 in FIG. 11 will be described more in detail with reference to FIG. 17.

### [Process of Outputting Evaluation Summary of Applicant]

First, each of processes of steps S17A, S18A, S1521A, and S1522A shown in FIG. 17 will be described.

When an operation by the applicant for viewing an evaluation is received, inviter device 200 performs a viewing request process (step S17A). In the viewing request process, inviter device 200 transmits a viewing request to evaluation output unit 152 of sharing server 100. In response to the viewing request, evaluation output unit 152 selects, from evaluation summary database 127, an applicant evaluation summary which the inviter (viewing requester) is given an authority to view (step S1521A).

The inviter having made the viewing request is given an authority to view an applicant evaluation summary from the whole of the company to which the inviter belongs and an applicant evaluation summary from the department to which the inviter belongs. The inviter having made the viewing request is not given an authority to view an evaluation summary other than these. Evaluation output unit 152 determines the viewing authority based on the member ID of the inviter who transmits the viewing request, company database 121, and member database 122. The “member ID” is an example of “identification information by which sharing server 100 including evaluation receiving unit 151 can identify where (company and department) one who has accessed sharing server 100 belongs and can identify the viewing authority of the one who has accessed sharing server 100.”

Evaluation output unit 152 selects, from evaluation summary database 127, an applicant evaluation summary corresponding to the viewing authority. Evaluation output unit 152 transmits data including the selected applicant evaluation summary to inviter device 200 (step S1522A). The transmitted data includes the member ID of the applicant (evaluation subject), the information of the company to which the applicant belongs, the information of the department to which the applicant belongs, and the like in addition to the applicant evaluation summary. Depending on a viewing request, the transmitted data may include an applicant evaluation summary corresponding to each of a plurality of applicants (evaluation subjects).

Inviter device 200 having received the applicant evaluation summary presents the applicant evaluation summary on display 205 together with the information of the company to which the applicant belongs and the information of the department to which the applicant belongs (step S18A). When an applicant evaluation summary corresponding to each of a plurality of applicants (evaluation subjects) is received, inviter device 200 presents the applicant evaluation summary by presenting the plurality of applicants (evaluation subjects) in the form of a list.

Thus, when the viewing request is received in the communication established in accordance with the member ID by which each of the company and department to which the inviter belongs can be identified, sharing server 100 transmits the applicant evaluation summary, which is exemplary evaluation information, to inviter device 200 of the inviter who is the origin of transmission of the viewing request.

### [Process of Searching for Member (Applicant)]

Next, each of processes of steps S4A, S19A, and S1431A to S1433A will be described with reference to FIG. 17.

When a search operation is received from the inviter, inviter device 200 performs a member search process of searching for information about applicants (step S4A). In the member search process, inviter device 200 transmits a search request to member search unit 143 of sharing server 100. The search request includes a reference value for performing search to exclude a member having a low magnitude of evaluation as an applicant. This reference value is determined based on, for example, the value of the applicant evaluation summary.

Member search unit 143 having received the search request specifies the company to which the inviter having transmitted the search request belongs (step S1431A). Here, the company specified in step S1431A is referred to as “company Xa.”

Member search unit 143 specifies the inviter who is operating inviter device 200, by using the member ID used when inviter device 200 signs in to sharing server 100. Member search unit 143 uses company database 121 and member database 122 to specify company Xa to which the inviter belongs.

Next, member search unit 143 extracts, from evaluation summary database 127, a member having an applicant evaluation summary with a value provided by the whole of specified company Xa to exceed the reference value (step S1432A). That is, member search unit 143 extracts a search result with a member having a low magnitude of evaluation by the whole of company Xa being excluded.

Here, it should be noted that member search unit 143 determines whether or not the magnitude of evaluation is low based on the applicant evaluation summary. That is, a member α having both an authority as an applicant and an authority as an inviter may behave as an applicant and may behave as an inviter. Therefore, as an evaluation summary of such a member α, an applicant evaluation summary and an inviter evaluation summary are registered in evaluation summary database 127. Member α may have a high magnitude of evaluation as an inviter whereas member α may have a low magnitude of evaluation as an applicant. In this case, member α may be excluded from those to be extracted in step S1432A.

A function of receiving setting information for the reference value from inviter device 200 of each company may be provided in sharing server 100. Thus, in accordance with each company's own reference value, the company can exclude, from the search result, a member having a low magnitude of evaluation.

Next, member search unit 143 outputs the extracted member information as a search result to inviter device 200 that has made the search request (step S1433A). Inviter device 200 presents the received search result on display 205 in the form of a list (step S19A).

As a result, the inviter can view, on display 205, the search result from which the member having a low magnitude of evaluation made by the whole of the company to which the inviter belongs is excluded. Therefore, when selecting a transferee from the applicants, the inviter can save an effort of excluding, by eyes, a member having a low magnitude of evaluation made by the whole of the company.

It should be noted that in the present embodiment, even a member (applicant) having a low magnitude of evaluation made by a certain department of the company to which the inviter belongs is not excluded from the search result when the magnitude of evaluation made by the whole of the company is not low. However, member search unit 143 may further exclude such a member (applicant) from the search result.

FIG. 18 is a diagram for illustrating a procedure of presenting an evaluation for an inviter and a search result for member on display 305. Step S4B (process of applicant device 300) and the function of member search unit 143 in FIG. 10 as well as steps S17B, S18B and the function of evaluation output unit 152 in FIG. 12 will be described more in detail with reference to FIG. 18.

### [Process of Outputting Evaluation Summary for Inviter]

First, each of processes of steps S17B, S18B, S1521B, and S1522B shown in FIG. 18 will be described.

When an operation by the applicant for viewing an evaluation for an inviter is received, applicant device 300 performs a viewing request process (step S17B). In the viewing request process, applicant device 300 transmits a viewing request to evaluation output unit 152 of sharing server 100. In response to the viewing request, evaluation output unit 152 selects, from evaluation summary database 127, an inviter evaluation summary which the applicant (viewing requester) is given an authority to view (step S1521B).

The applicant having made the viewing request is given an authority to view an inviter evaluation summary from the whole of the company to which the applicant belongs and an inviter evaluation summary from the department to which the applicant belongs. The applicant having made the viewing request is not given an authority to view an evaluation summary other than these. Evaluation output unit 152 determines the viewing authority based on the member ID of the applicant who transmits the viewing request, company database 121, and member database 122. The “member ID” is an example of “identification information by which sharing server 100 including evaluation receiving unit 151 can identify where (company and department) one who has accessed sharing server 100 belongs and can identify the viewing authority of the one who has accessed sharing server 100.”

Evaluation output unit 152 selects, from evaluation summary database 127, an inviter evaluation summary corresponding to the viewing authority. Evaluation output unit 152 transmits data including the selected inviter evaluation summary to applicant device 300 (step S1522B). The transmitted data includes the member ID of the inviter (evaluation subject), the information of the company to which the inviter belongs, the information of the department to which the inviter belongs, and the like in addition to the inviter evaluation summary. Depending on a viewing request, the transmitted data may include an inviter evaluation summary corresponding to each of a plurality of inviters (evaluation subjects).

Applicant device 300 having received the inviter evaluation summary presents the inviter evaluation summary on display 305 together with the information of the company to which the inviter belongs and the information of the department to which the inviter belongs (step S18B). When an inviter evaluation summary corresponding to each of a plurality of inviters (evaluation subjects) is received, applicant device 300 presents the inviter evaluation summary by presenting the plurality of inviters (evaluation subjects) in the form of a list.

Thus, when the viewing request is received in the communication established in accordance with the member ID by which each of the company and department to which the applicant belongs can be identified, sharing server 100 transmits the inviter evaluation summary, which is exemplary evaluation information, to applicant device 300 of the applicant who is the origin of transmission of the viewing request.

### [Process of Searching for Member (Inviter)]

Next, each of processes of steps S4B, S19B, and S1431B to S1433B will be described with reference to FIG. 18.

When a search operation is received from the applicant, applicant device 300 performs a member search process of searching for information about inviters (step S4B). In the member search process, applicant device 300 transmits a search request to member search unit 143 of sharing server 100. The search request includes a reference value for performing search to exclude a member having a low magnitude of evaluation as an inviter. This reference value is determined based on, for example, the value of the inviter evaluation summary.

Member search unit 143 having received the search request specifies the company to which the applicant having transmitted the search request belongs (step S1431B). Here, the company specified in step S1431B is referred to as “company Xb.”

Member search unit 143 specifies the applicant who is operating applicant device 300, by using the member ID used when applicant device 300 signs in to sharing server 100. Member search unit 143 uses company database 121 and member database 122 to specify company Xb to which the applicant belongs.

Next, member search unit 143 extracts, from evaluation summary database 127, a member having an inviter evaluation summary with a value provided by the whole of specified company Xb to exceed the reference value (step S1432B). That is, member search unit 143 extracts a search result with a member having a low magnitude of evaluation by the whole of company Xb being excluded.

A function of receiving setting information for the reference value from inviter device 200 of each company may be provided in sharing server 100. Thus, in accordance with each company's own reference value, the company can exclude, from the search result, a member having a low magnitude of evaluation.

Next, member search unit 143 outputs the extracted member information as a search result to applicant device 300 having made the search request (step S1433B). Applicant device 300 presents the received search result on display 305 in the form of a list (step S19B).

As a result, the applicant can view, on display 305, the search result from which the member having a low magnitude of evaluation made by the whole of the company to which the applicant belongs is excluded. Therefore, when selecting an inviter who seems to be appropriate from the inviters, the applicant can save an effort of excluding, by eyes, a member having a low magnitude of evaluation made by the whole of the company.

It should be noted that in the present embodiment, even a member (inviter) having a low magnitude of evaluation made by a certain department of the company to which the applicant belongs is not excluded from the search result when the magnitude of evaluation made by the whole of the company is not low. However, member search unit 143 may further exclude such a member (inviter) from the search result.

### [Permitted Scope of Viewing of Evaluation Summary Database 127]

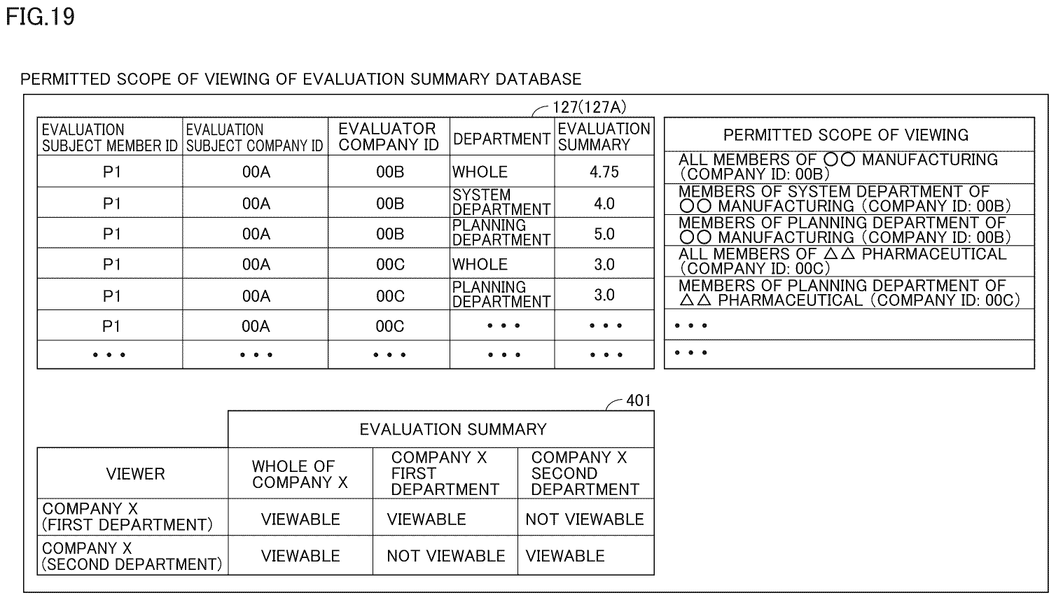

FIG. 19 is a diagram for illustrating a permitted scope of viewing of evaluation summary database 127. Here, the permitted scope of viewing will be described by exemplifying inviter evaluation summary portion 127A shown in FIG. 8 in evaluation summary database 127.

Inviter evaluation summary portion 127A shown in FIG. 19 includes evaluation summaries from company B and company C for member P1 who behaves as an “inviter.” Member P1 belongs to company A. The evaluation summaries from company B are classified into “whole,” “system department,” and “planning department.” The evaluation summaries from company C are classified into “whole,” “planning department,” and the like. Each of the members belonging to companies B and C views, as an “applicant,” the evaluation summaries for member P1.

Each of all the members belonging to company B has a viewing authority for the evaluation summary calculated from the evaluations made by the whole of company B as shown in the column “PERMITTED SCOPE OF VIEWING” in FIG. 19.

Each of the members of the system department of company B has a viewing authority for the evaluation summary calculated from the evaluations made by the system department of company B, but each of the members other than those of the system department of company B does not have the viewing authority therefor. Each of the members of the planning department of company B has a viewing authority for the evaluation summary calculated from the evaluations made by the planning department of company B, but each of the members other than those of the planning department of company B does not have the viewing authority therefor.

Each of all the members belonging to company C has a viewing authority for an evaluation summary calculated from evaluations made by the whole of company C. Each of the members of the planning department of company C has a viewing authority for an evaluation summary calculated from evaluations made by the planning department of company C, but the members other than those of the planning department of company C does not have the viewing authority therefor.

In the description above, the permitted scope of viewing has been described by exemplifying inviter evaluation summary portion 127A. In matching system 1, the permitted scope of viewing is also defined for applicant evaluation summary portion 127B (see FIG. 8) in accordance with the same design concept as that for inviter evaluation summary portion 127A.

When a member of a first department of a company X and a member of a second department of company X are viewers, authorities of the viewers for an evaluation summary from the whole of company X, an evaluation summary from the first department of company X, and an evaluation summary from the second department of company X are as shown in a table 401 of FIG. 19. Here, when an applicant corresponds to the “viewer,” an evaluation summary of an “inviter” is to be viewed. On the other hand, when an inviter corresponds to the “viewer,” an evaluation summary of an “applicant” is to be viewed.

The member belonging to the first department of company X can view the evaluation summary from the whole of company X and the evaluation summary from the first department of company X, but cannot view the evaluation summary from the second department of company X. The member belonging to the second department of company X can view the evaluation summary from the whole of company X and the evaluation summary from the second department of company X, but cannot view the evaluation summary from the first department of company X. A member belonging to a company Y other than company X cannot view the evaluation summary from the whole of company X, the evaluation summary from the first department of company X, and the evaluation summary from the second department of company X.

The evaluation summary from the whole of company X, the evaluation summary from the first department of company X, and the evaluation summary from the second department of company X are not disclosed to a member of a company other than company X. Therefore, a member who belongs to company Y and behaves as an applicant can objectively evaluate an inviter belonging to company X without a consideration of a relationship between the companies or the like on the occasion of evaluating the inviter belonging to company X. Similarly, a member who belongs to company Y and behaves as an inviter can objectively evaluate an applicant belonging to company X without a consideration of the relationship between the companies or the like on the occasion of evaluating the applicant belonging to company X.

Moreover, the evaluations (evaluations for an inviter and evaluations for an applicant) made by the members belonging to company X are shared among company X as the inviter evaluation summary and the applicant evaluation summary. Therefore, the evaluators can become conscious of such a fact that useful information is produced by accumulating evaluations one after another. With this, the evaluators are motivated to make accurate evaluations.

As a result, the accuracy of each of the inviter evaluation summary and the applicant evaluation summary is improved. Thus, the inviter evaluation summary can be usefully utilized as reference data when selecting an invitation case. Similarly, the applicant evaluation summary can be usefully utilized as reference data when selecting a transferee.

Further, according to the present embodiment, when the member search process (step S4A) is performed in inviter device 200, the search result from which a member having a low magnitude of evaluation is excluded is provided to the inviter (step S1432A). Similarly, when the member search process (step S4B) is performed in applicant device 300, the search result from which a member having a low magnitude of evaluation is excluded is provided to the inviter (step S1432B). That is, matching system 1 has a filtering function of providing a search result from which a member having a low magnitude of evaluation is excluded.

Therefore, when determining a transferee for the invitation case, the inviter can be prevented on the company basis from erroneously adopting a member having a low magnitude of evaluation. Similarly, when determining an invitation case to apply for from a large number of invitation cases, the applicant can be prevented on the company basis from erroneously selecting a case for which an application is invited by a member having a low magnitude of evaluation. It should be noted that sharing server 100 may perform filtering using an evaluation summary on the department basis.

An instruction signal for instructing which of the filtering using the evaluation summary from the whole of the company and the filtering using the evaluation summary on the department basis is to be used may be transmitted from inviter device 200 to sharing server 100. In this case, sharing server 100 is provided with a function of changing, in accordance with the instruction signal, the evaluation summary to be used for the filtering.

[Example of Setting Scope of Disclosure in Accordance with Disclosure Level]

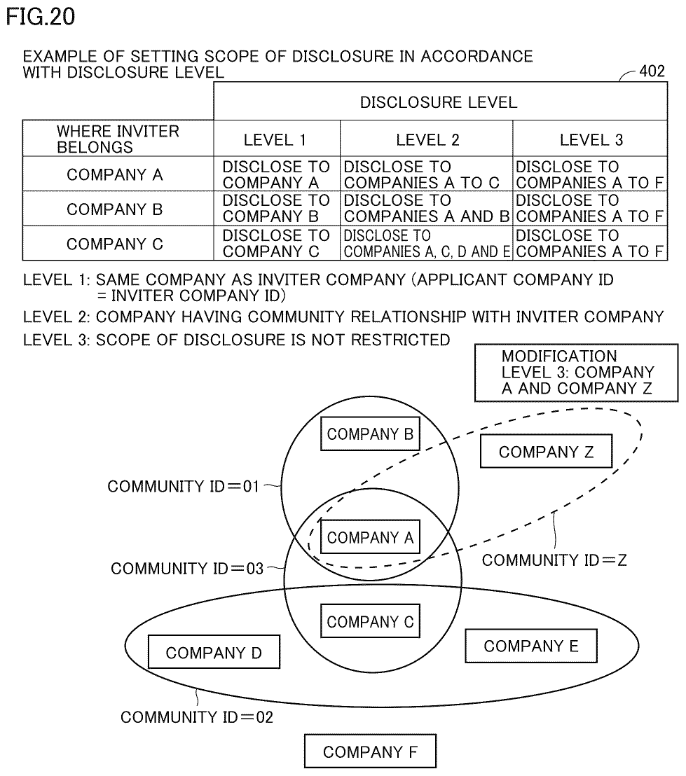

FIG. 20 is a diagram showing an example of setting the scope of disclosure in accordance with a disclosure level. Here, as shown in FIG. 20, it is assumed that companies A to E form a community relationship, and company F does not have a community relationship with any of the companies. In this case, the scopes of disclosure of invitation cases are as shown in a table 402 in accordance with companies to which inviters belong and disclosure levels set by the inviters.

The disclosure levels, i.e., “level 1” to “level 3” shown in FIG. 20 correspond to the above-described three levels, i.e., “own company,” “within community,” and “all.” Therefore, in level 1, the invitation case of the inviter is disclosed only to an applicant of the same company as the company to which the inviter belongs. In level 2, in addition to the scope of level 1, the invitation case of the inviter is disclosed to an applicant belonging to a company having the community relationship with the company to which the inviter belongs. In level 3, the invitation case of the inviter is disclosed to applicants belonging to all the companies including the company to which the inviter belongs. It should be noted that when the inviter specifies a company ID for which disclosure is not to be made, a company corresponding to the company ID is excluded from the companies to which the disclosure is to be made regardless of the disclosure level set. Among the disclosure levels of the present embodiment, “level 1” is a level corresponding to “permitting asset information (case information) to be disclosed to a first applicant and prohibiting the asset information from being disclosed to an applicant not belonging to a first group.” “Level 2” is a level corresponding to “permitting the asset information to be disclosed to an applicant belonging to any of the first group and a community group having a community relationship with the first group, and prohibiting the asset information from being disclosed to an applicant not belonging to any of the first group and the community group.” “Level 3” is a level corresponding to “permitting the asset information to be disclosed to an applicant regardless of a group to which the applicant belongs.”

Here, levels 1 to 3 have been described as examples of the plurality of types of disclosure levels. However, the plurality of types of disclosure levels are not limited thereto. For example, a community may be divided into a plurality of small communities, and whether to disclose an invitation case may be set for each small community. More specifically, community 02 shown in FIG. 5 is divided into a first small community and a second small community. It is assumed that company C belongs to the first small community, and company D and company E belong to the second small community. In this case, an inviter of company D may be allowed to select the scope of disclosure of the invitation case of company D to be the scope of the first small community or the scope of the second small community.

Sharing server 100 may receive an operation of setting a different scope of disclosure for each invitation case. For example, a specific example in which the scope of disclosure is set to be different for each invitation case will be described by exemplifying cases 001 to 003 among a large number of invitation cases.

For example, the scope of disclosure of invitation case 001 may be restricted to only companies A and C belonging to a community identified by a community ID=03. Alternatively, the scope of disclosure of invitation case 002 may be restricted to only companies C, D, and E belonging to a community identified by a community ID=02. Alternatively, the scope of disclosure of case 003 may be restricted to companies C, D, and E belonging to a community identified by the community ID=02 and companies A and C belonging to the community identified by the community ID=03.

Company A may form a community different from the community identified by community ID=01 or 02. For example, as indicated by a broken line in FIG. 20, company A may form, with a company Z, a community identified by a community ID=Z. For example, when the inviter belongs to company A, the invitation case of the inviter may be disclosed to an applicant belonging to company A and an applicant belonging to company Z. Such a disclosure level may be employed as a modification of “level 3” as shown in FIG. 20.

In this case, “level 3” corresponds to “permitting the asset information to be disclosed to an applicant belonging to each of the first group (company A) and a specific community group (community identified by the community ID=Z) that is different from the community group (companies A to C) corresponding to the second level and having the community relationship with the first group, and prohibiting the asset information from being disclosed to an applicant not belonging to any of the first group and the specific community group.”

Here, levels 1 to 3 have been described as examples of the plurality of levels, but a larger number of levels may be set as the plurality of types of disclosure levels. As an exemplary interface for allowing the inviter to set the scope of disclosure, a screen on which a check box for setting a desired level from the plurality of types of levels is presented may be presented on user device 500.

### [Details of Asset Content]

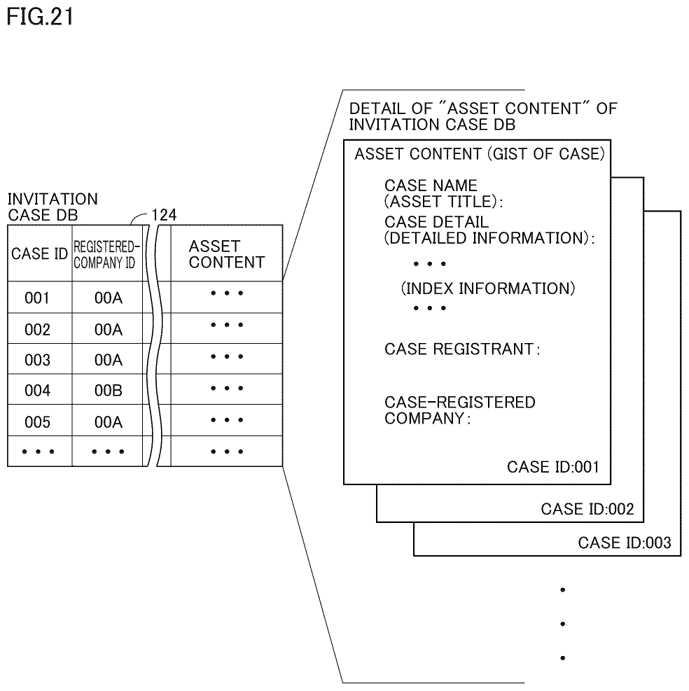

FIG. 21 is a diagram showing details of the asset content included in invitation case database 124. As shown in FIG. 21, the asset content (gist of the case) is registered in invitation case database 124 on the case ID basis.

The asset content includes the following items: a case name (asset title), a case detail (detailed information), a case registrant, and a case-registered company. The title of the asset for the invitation case is described in the case name. The case detail includes text (detailed information) describing the content of the invitation case in detail. This text may include a condition required for an applicant who is to receive transfer of the asset. The case registrant means one who has registered the case, i.e., the inviter. The case-registered company means a company to which the case registrant belongs.

The asset content is disclosed to a user (applicant) to whom the case corresponding to the asset content is permitted to be disclosed. A company-specific term may be used in the text included in the case detail. Such a company-specific term in the text is registered in invitation case database 124 as “index information” so as to be associated with a company-specific term in a below-described company-specific term database 137.

As described above with reference to FIG. 1, user device 500 presents the company-specific term in a presentation manner different from those of the other terms. Thus, the user understands that it is a company-specific term. Further, in response to an operation by the user (for example, an operation of clicking a portion of the company-specific term), user device 500 presents the meaning intended by the company-specific term on screen 550.

The applicant reviews the asset content of each case, and determines a case to apply for from a large number of cases. As required, the applicant has an interview with the inviter of the case before finally applying for the case. Moreover, the inviter may select a specific one from applicants as a provisional transferee and may then have an interview with the provisional transferee before completing the transaction.

User device 500 may provide the inviter and the applicant with an environment for a web conference for performing such interviews. When a text including a company-specific term is presented on the display during the Web conference, user device 500 may present the company-specific term in the manner shown in FIG. 1.

### [Other Databases]

Hereinafter, in addition to various databases 121 to 124, 126, 127 shown in FIG. 2, other databases employed in the present embodiment will be described.

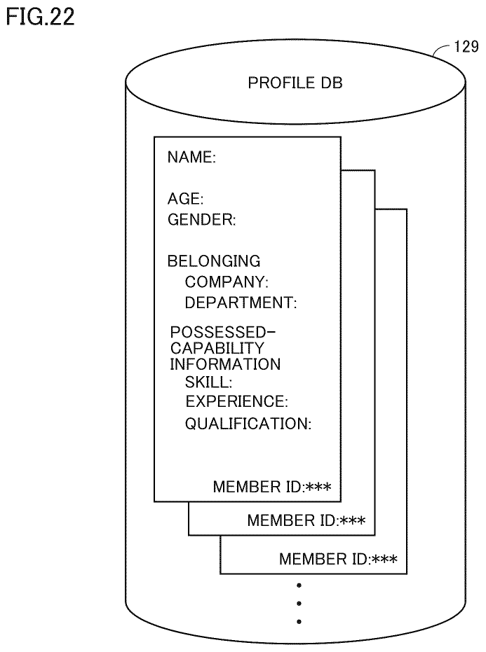

FIG. 22 is a diagram showing an exemplary profile database 129. As shown in FIG. 22, in profile database 129, profile information of a member (user) is registered on the member ID basis. A part of the profile information may overlap the information registered in member database 122. The profile information includes the name, age, and gender of the member. Further, the profile information includes belonging information by which where (company and department) the member belongs can be specified. The belonging information is exemplary group information for specifying one of the company and the department within the company.

Further, the profile information includes possessed-capability information of the member. The possessed-capability information of the member is classified based on a skill, an experience, and a qualification.

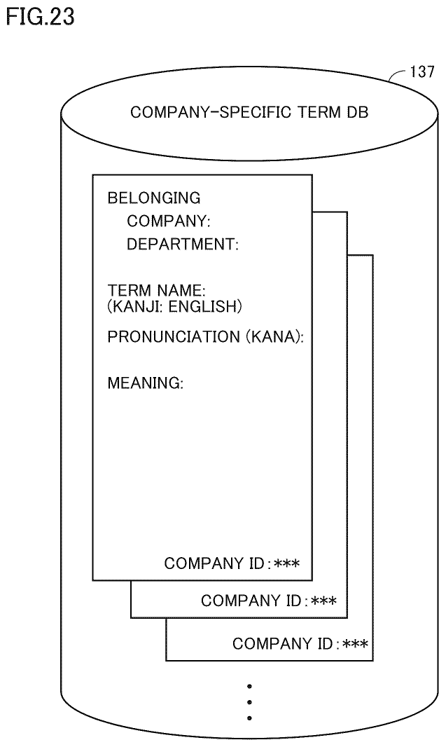

FIG. 23 is a diagram showing an exemplary company-specific term database 137. As shown in FIG. 23, company-specific term information is registered in company-specific term database 137 on the company ID basis. Sharing server 100 specifies a company-specific term on the company basis by referring to company-specific term database 137.

The company-specific term information includes belonging information by which where (company and department) the member belongs can be specified. The belonging information is exemplary group information for specifying one of the company and the department within the company. It can also be said that the belonging information is information indicating the company and the department in each of which the company-specific term to be registered is widely used.

The company-specific term information further includes “name,” “pronunciation,” and “meaning” of the term to be registered. For the company-specific term “DX,” “DX” is registered as the “name,” “di:eks” is registered as the “pronunciation,” and “to create some new value regardless of whether or not the digital technology is used” is registered as the “meaning,” for example.

Another example of the company-specific term is “application development.” “Application development” is generally understood to mean development of an application to be used in an electronic device such as a smartphone. However, in a certain department in a company handling electronic components, “application development” may mean “to cultivate a usage of a component.” In such a case, the term name “application development” and its meaning (to cultivate a usage of a component) is registered in company-specific term database 137.

### [Explanation for Processing Procedure for Index Function]

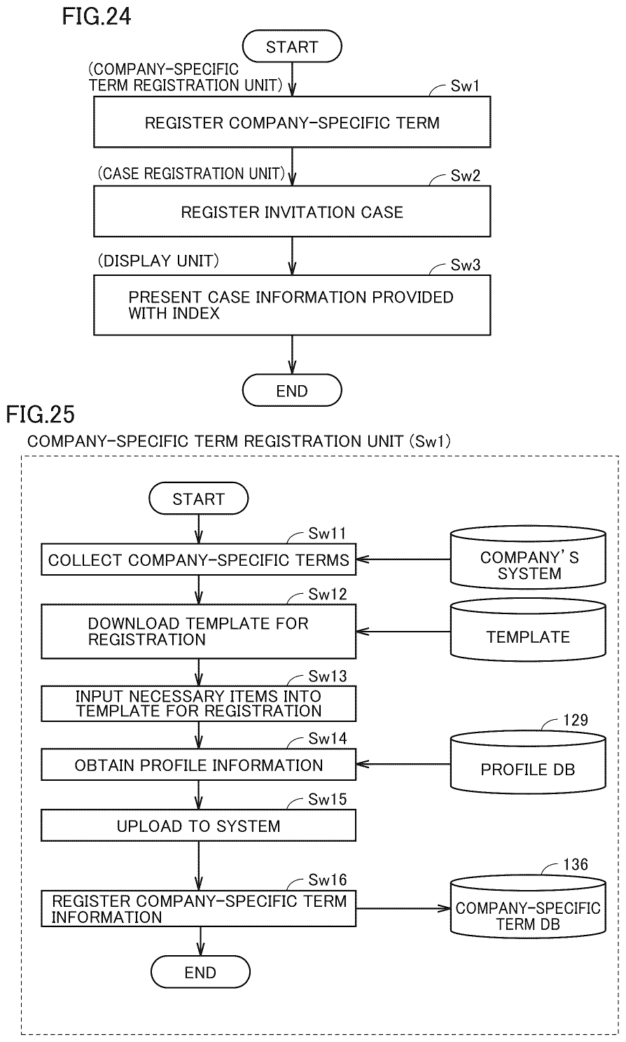

Next, various processing procedures for the index function will be described with reference to FIGS. 24 to 27. FIG. 24 is a flowchart showing a processing procedure for the index function of matching system 1.

In the flowchart shown in FIG. 24, first, sharing server 100 registers a company-specific term into company-specific term database 137 (step Sw1). In step Sw1, sharing server 100 functions as a company-specific term registration unit. Next, sharing server 100 registers an invitation case into invitation case database 124 (step Sw2). In step Sw2, sharing server 100 functions as a case registration unit. When registering the invitation case into invitation case database 124, the case registration unit indexes the company-specific term included in the invitation case information.

Next, sharing server 100 presents the case information provided with the index on screen 550 (see FIG. 1) of user device 500 (step Sw3). For example, when the company-specific term is used in a text describing the case detail, the text is presented on screen 550 with the company-specific term being underlined. Instead of underlining the company-specific term or in addition to underlining the company-specific term, the company-specific term may be presented in a color different from those of the other words on screen 550. In step Sw3, sharing server 100 functions as a display unit.

FIG. 25 is a flowchart showing a processing procedure of the company-specific term registration unit (Sw1). First, a person in charge in a company collects company-specific terms by using the company's own system or the like (step Sw11). That is, the person in charge creates a company-specific term list. Next, the person in charge downloads a template for registration from sharing server 100 (step Sw12). Next, the person in charge inputs items into the template (step Sw13). The terms include the company-specific terms, and the meanings of the company-specific terms.

Next, the person in charge in the company accesses sharing server 100 and obtains the profile information of the person in charge from profile database 129 (step Sw14). The profile information includes the company ID of the company to which the person in charge belongs. The person in charge uploads the template together with the profile information to matching system 1 (step Sw15). Sharing server 100 obtains the profile information and the template. Sharing server 100 generates company-specific term information based on the obtained profile information and template, and registers the generated company-specific term information into company-specific term database 137 (step Sw16). In this way, the company-specific terms and the meanings of the company-specific terms are registered into company-specific term database 137. The company-specific terms and the meanings of the company-specific terms are registered in company-specific term database 137 on the company basis.

The processes of steps Sw11 to Sw16 are performed for each company. In this way, the company-specific term information is registered in company-specific term database 137 on the company basis. It should be noted that sharing server 100 may register the company-specific terms collectively into company-specific term database 137 from an external file such as a CSV (Comma Separated Value) file.

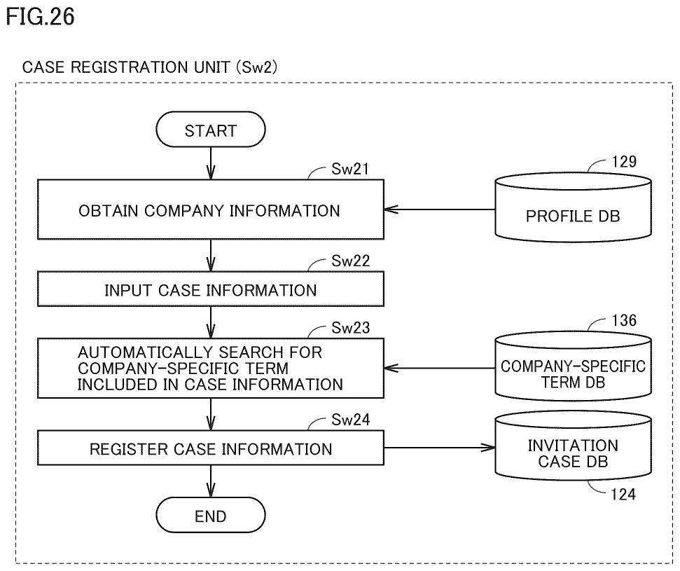

FIG. 26 is a flowchart showing a processing procedure of the case registration unit (Sw2). First, an inviter to register an invitation case into the system accesses profile database 129 so as to obtain the company information of his/her company (step Sw21). Next, the inviter inputs case information into user device 500 (step Sw22). The case information includes various types of information such as a case content to be registered in invitation case database 124. The inviter may input details of the case content using a company-specific term widely used in the company to which the inviter belongs.

Next, sharing server 100 automatically searches for the company-specific term included in the input case information (step Sw23). On this occasion, sharing server 100 indexes the company-specific term found by the search and associates it with the company-specific term information registered in company-specific term database 137. Next, sharing server 100 registers, into invitation case database 124, the case information input by the inviter (step Sw24). In this way, the case information is registered into invitation case database 124 with the company-specific term and the meaning of the company-specific term being associated with each other.

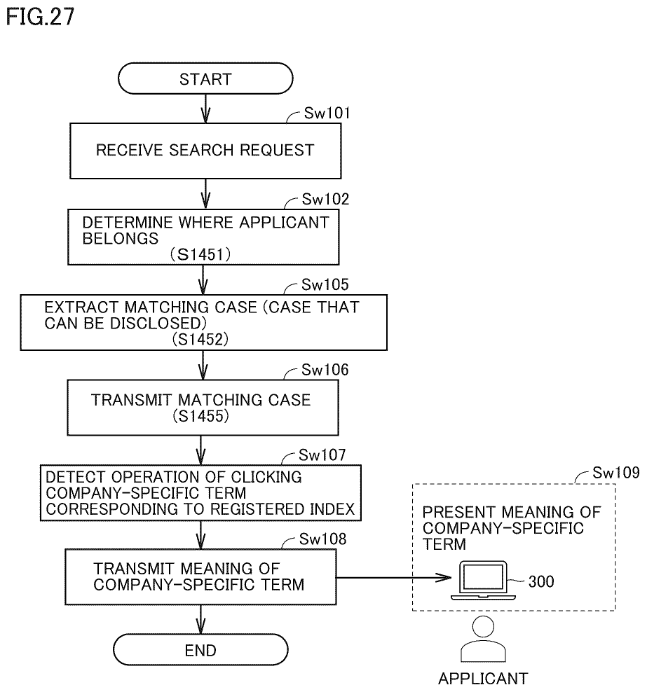

FIG. 27 is a flowchart showing a processing procedure of presenting the meaning of a company-specific term on the screen in response to an operation by an applicant. Here, the following describes a process for providing a matching case that matches the applicant in consideration of a scope of disclosure of an invitation case and for notifying the meaning of the company-specific term to the applicant as required.

First, sharing server 100 receives a search request for invitation case from an applicant (step Sw101). Next, sharing server 100 determines where the applicant belongs (step Sw102). Details of this process have been described as step S1451.

Next, sharing server 100 extracts a matching case (case that can be disclosed) (step Sw105). Details of this process have been described as step S1452. Next, sharing server 100 transmits the matching case (step Sw106). Details of this process have been described as step S1455. In this way, sharing server 100 presents the matching case on applicant device 300 by transmitting the matching case to applicant device 300.

Next, sharing server 100 detects an operation of clicking a company-specific term corresponding to the registered index (step Sw107). Next, sharing server 100 refers to company-specific term database 137 and transmits the meaning of the company-specific term to applicant device 300 (step Sw108). Next, applicant device 300 presents the meaning of the company-specific term on display 305 (step Sw109). Thus, for example, screen 550 shown in FIG. 1 is presented on display 305. In this way, sharing server 100 presents the meaning of the company-specific term to applicant device 300 by transmitting the meaning of the company-specific term to applicant device 300.

As described above, according to the present embodiment, matching system 1 functioning as a crowdsourcing platform can be provided. In order to utilize the crowdsourcing to find an appropriate one to whom a redundant asset is to be transferred, it is desirable to further broaden the scope of crowdsourcing, rather than keeping the scope to be within a particular company or a small number of companies. In this case, it is important to consider a stake between an inviter who invites an application to be a transferee of a case for the asset and an applicant who applies for the invitation. In the present embodiment, sharing server 100 communicates with applicant device 300 operated by the applicant via communication interface 104. Sharing server 100 registers, into the database, the asset information indicating the subject of the asset and the disclosure information indicating the scope of disclosure of the asset information (step S1442). Sharing server 100 determines, based on corresponding disclosure information, asset information permitted to be disclosed to the applicant among the pieces of asset information registered in database 120 (step S1452). The asset information includes detailed information about the content of the asset (case content (gist of transaction)). Sharing server 100 presents, on applicant device 300, the asset information permitted to be disclosed to the applicant and the meaning of a term (in-house term including a company-specific term) included in the detailed information (steps Sw3, Sw106, and Sw109).

Therefore, according to the present embodiment, an appropriate applicant can be selected in consideration of the stake between the inviter and the applicant. Further, according to the present embodiment, the applicant can be prevented from misunderstanding the content of the asset information due to a term used in an unfamiliar meaning or meaning different from its usual meaning.

Further, according to the present embodiment, an effort of additionally explaining the company-specific term can be saved when the user exchanges information about the case with a user outside the company. Further, sharing server 100 can automatically index the company-specific term included in the case information. Therefore, the user does not need to manually index the company-specific term. Further, sharing server 100 has a function of registering the company-specific term into company-specific term database 137. Therefore, the user does not need to manually register the company-specific term into company-specific term database 137. Further, since the user can recognize that the company-specific term is not understandable by other companies, the user can know a cultural difference from the other companies.

In the present embodiment, the “company-specific term” in the company has been described as an exemplary “in-house term” widely used in the group to which the user belongs. However, instead of or in addition to the “company-specific term,” the embodiment described above may be applied to a term similar to the company-specific term and used in a non-profit organization, a community, and a unit (department, section, or the like) therein.

In the present embodiment described above, each of a “company-based group” and a “department-based group in the same company” is an exemplary “group.” One “group” may be formed by applicants who do not belong to a company, such as freelancers. A “company group” may be formed by a plurality of companies.

The communication (S9 in FIG. 11) for transmitting the approval information from applicant device 300 of the administrator functioning as the approver to approval unit 147 is performed in the logical communication path identified by the member ID of the approver. The expression “notification unit 147 receives the approval information in such a communication path” is an example of “receiving the approval notification in the communication involving the identification information of the approver for the first applicant.”

In the present embodiment, the “applicant evaluation summary” registered in evaluation summary database 127 is an example of “evaluation information that is based on the evaluation received from inviter device 200 functioning as the evaluator device.” In the present embodiment, the “inviter evaluation summary” registered in evaluation summary database 127 is an example of the “evaluation information that is based on the evaluation received from applicant device 300 functioning as an evaluator device.”

FIG. 8 shows only exemplary data registered in evaluation summary database 127. In the present embodiment, it is also assumed that a member belonging to company A is in the position of applicant and evaluates a member who belongs to company A, B, C, etc. and who behaves as an inviter. In the present embodiment, it is also assumed that a member belonging to company B is in the position of applicant and evaluates a member who belongs to company A, B, C, etc. and who behaves as an inviter. In the present embodiment, it is also assumed that a member belonging to company A is in the position of inviter and evaluates a member who belongs to company A, B, C etc. and who behaves as an applicant. In the present embodiment, it is also assumed that a member belonging to company B is in the position of inviter and evaluates a member who belongs to company A, B, C, etc. and who behaves as an applicant.

In the present embodiment, “inviter device 200A” operated by the inviter belonging to company A functions as an evaluator device and is an example of “first inviter device (inviting-side first evaluator device) operated by one or more evaluators belonging to the first group.” In the present embodiment, “applicant device 300A” operated by the applicant belonging to company A functions as an evaluator device and is an example of “first evaluator device (applying-side first evaluator device) operated by one or more evaluators belonging to the first group.”

In the present embodiment, “inviter device 200B” operated by the inviter belonging to company B functions as an evaluator device and is an example of “second inviter device (inviter-side second evaluator device) operated by one or more evaluators belonging to a second group different from the first group.” In the present embodiment, the “applicant device 300B” operated by the applicant belonging to company B functions as an evaluator device and is an example of “second evaluator device (applying-side second evaluator device) operated by one or more evaluators belonging to a second group different from the first group.”

The system department and the planning department are illustratively described as the departments of company B in FIG. 19. In the present embodiment, “one of the system department and the planning department” is an example of the “first division group” included in the first group, and the other is an example of the “second division group” included in the first group.

As described above, sharing server 100 determines the asset information permitted to be disclosed to the applicant among the pieces of asset information of the invitation cases registered in database 120 based on the various types of information (the member ID, the company ID, the community ID, the belonging company ID list, the non-disclosure company ID list, the disclosure level, and the non-disclosure target) by each of which the relationship between the applicant and the inviter can be specified, and provides the applicant with the asset information permitted to be disclosed to the applicant. According to the present embodiment, it is possible to select an appropriate applicant in consideration of the stake between the company to which the inviter who invites an application to be one to whom the asset is to be transferred or by whom the asset is to be used belongs and the company to which the applicant belongs. Thus, the secret information of the company on the inviter side can be prevented from being leaked to a competitor company through the content of the asset for the invitation case.

The “company” and the “department within the same company” in the present embodiment are examples of the “inviter group” and the “applicant group,” and these are examples of the “group.” An applicant who does not belong to a company may form one “group.” A “company group” may be formed by a plurality of companies.

In the present embodiment, the “company forming the community relationship” is an example of the “community group.” In the present embodiment, the information of the “non-disclosure target” included in the disclosure information is an example of “information by which one to whom the asset information is prohibited from being disclosed can be specified.”

Among the disclosure levels of the present embodiment, “level 1” is a level corresponding to “permitting the asset information to be disclosed to the first applicant and prohibiting the asset information from being disclosed to the applicant not belonging to the first group.” “Level 2” is a level corresponding to “permitting the asset information to be disclosed to the applicant belonging to any of the first group and the community group having a community relationship with the first group, and prohibiting the asset information from being disclosed to the applicant not belonging to any of the first group and the community group.” “Level 3” is a level corresponding to “permitting the asset information to be disclosed to an applicant regardless of a group to which the applicant belongs.”

Each of inviter device 200 and applicant device 300 may not only include all of the processor, the memory, the communication interface, and the input/output interface shown in FIG. 2, but may be a thin client system using VDI (Virtual Desktop Infrastructure). The thin client system using VDI is a system in which a desktop environment on a server is transferred to a terminal at a remote location for the sake of use. Inviter device 200, applicant device 300, and sharing server 100 do not need to be necessarily independent devices. When the thin client system as described above is used, the functions of inviter device 200, applicant device 300, and sharing server 100 can be provided on the same aggregated server.

Database 120 is not limited to a relational database, and an object type database, a NoSQL type database, or the like may be used.

Sharing server 100 is an exemplary computing device. The computing device may be constituted of a server (such as an on-premises server or a cloud server), a serverless system, or the like. Here, the on-premises server is a server installed and managed in a facility managed by its own company. The cloud server is a server (borrowed server) provided by another business entity through a network. The serverless system is a system by which a computing/memory function can be used only when required without being aware of presence of a server. The computing device includes the server and the serverless system. The server includes the on-premises server and the cloud server.

### <Modification 1>

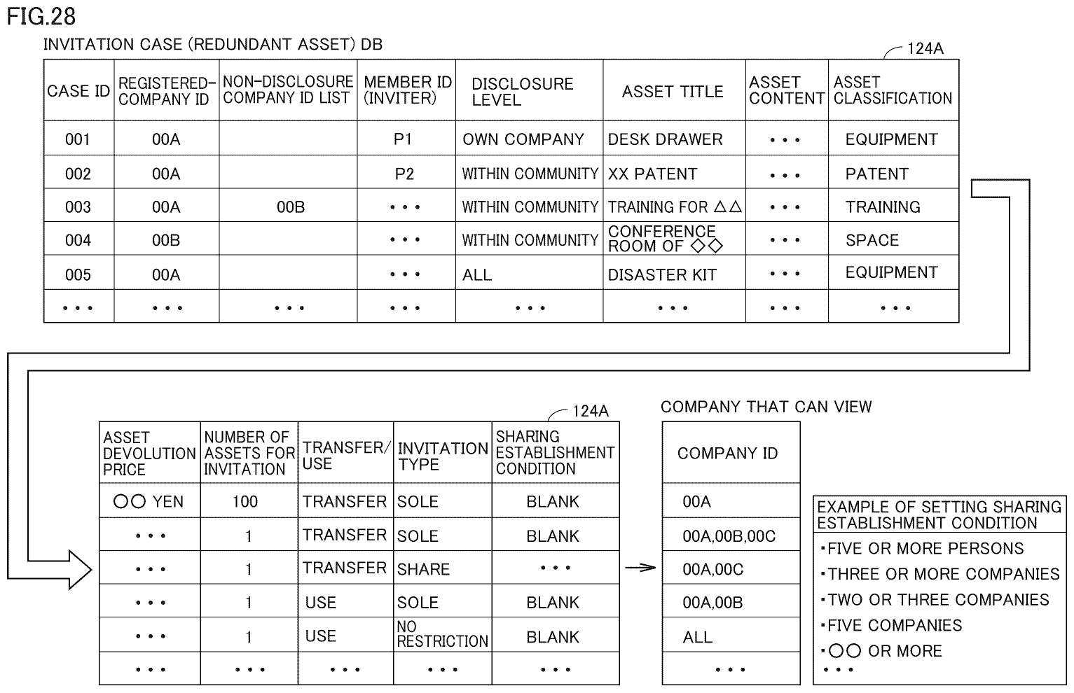

Next, a modification 1 will be described with reference to FIGS. 28 to 32. Here, a sharing function by which an asset for an invitation case can be shared by a plurality of applicants will be described.

FIG. 28 is a diagram showing an exemplary invitation case database 124A according to modification 1. In invitation case database 124A shown in FIG. 28, a function by which an “invitation type” and a “sharing establishment condition” can be registered into invitation case database 124 shown in FIG. 6 is added.

As the “invitation type,” information indicating whether the invitation type of the invitation case is “share,” “sole,” or “no restriction” is registered.

For an invitation case for which the invitation type is set to “share,” applications by a plurality of applicants to satisfy the “sharing establishment condition” are essential. For the invitation case for which the invitation type is set to “share,” the “sharing establishment condition” is registered. The inviter can set various “sharing establishment conditions.” FIG. 28 shows an example of setting the sharing establishment condition. The sharing establishment condition set by the inviter is registered in invitation case database 124A.

For example, in the case where a sharing establishment condition for training of a case 003 is set to five companies, when five companies applies for case 003, the inviter gives, to each of the companies, a right to use the training corresponding to case 003. For example, employees of the five companies each given the right to use are permitted to visit a predetermined training site and gain the training corresponding to case 003. Thus, the sharing establishment condition is constituted of the condition for the number of applicants for the share-type asset.

For an invitation case for which the invitation type is set to “sole,” “share” by a plurality of applicants is not permitted. Each of cases 001, 002, and 004 corresponds to such a case. One who would like to acquire such an invitation case for which the invitation type is set to “sole” needs to apply for the case solely. The “sharing establishment condition” is not registered for the invitation case for which the invitation type is set to “sole” (BLANK).

For an invitation case for which the invitation type is set to “no restriction,” application by a sole applicant and application by a plurality of applicants are permitted. A case 005 corresponds to such a case. Each one who applies for the invitation case for which the invitation type is set to “no restriction” determines the number of assets to apply for within the range of the number of assets for invitation. When the total number of assets to apply for by the applicants reaches the number of assets for invitation, the application is closed. The “sharing establishment condition” is not registered for the invitation case for which the invitation type is set to “no restriction” (BLANK).

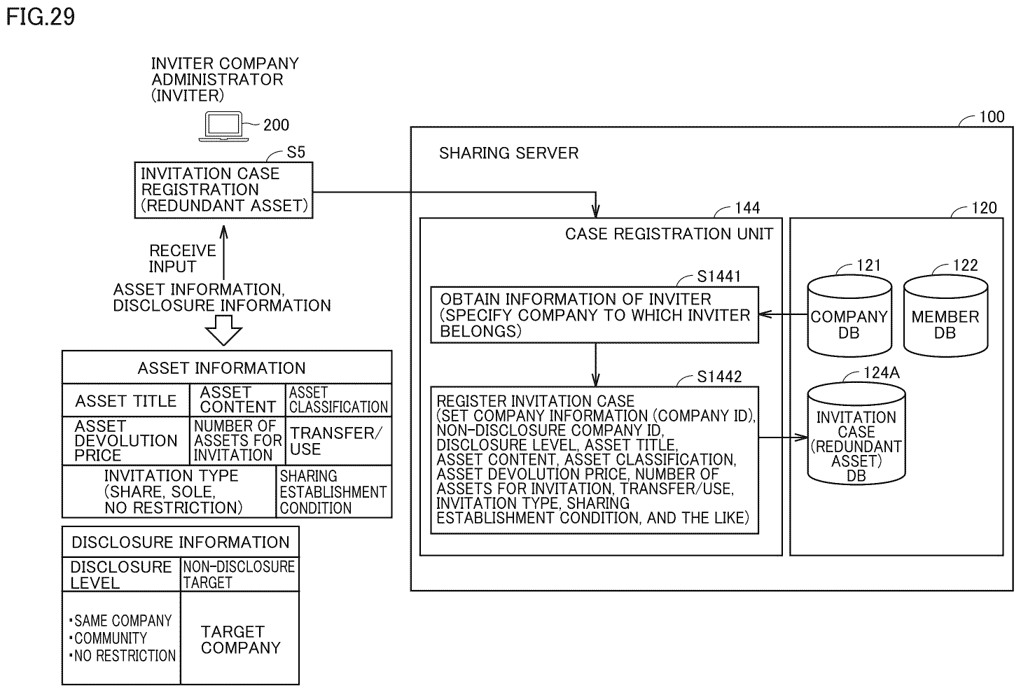

FIG. 29 is a diagram for illustrating a procedure of registering an invitation case into the invitation case database in modification 1. In FIG. 29, as compared with FIG. 13, the invitation type and the sharing establishment condition are added to the asset information input to inviter device 200.

In modification 1, when an inviter who registers an invitation case inputs asset information and disclosure information of the invitation case into inviter device 200, the invitation type and the sharing establishment condition of the invitation case can be included in the asset information. The invitation type is one of share, sole, and no restriction as described above. When the invitation type is set to share, the inviter inputs the sharing establishment condition.

Case registration unit 144 of sharing server 100 registers the invitation case into invitation case database 124A with the invitation type and the sharing establishment condition selected by the inviter being included therein (step S1442). The other contents shown in FIG. 29 are the same as those of FIG. 13 described above, and therefore will not be described repeatedly here.

The information of the “invitation type” is an example of “invitation type information by which the asset can be specified to be a share-type asset for which a plurality of applicants are each selected as one to whom the asset is to be transferred or by whom the asset is to be used.” Sharing server 100 registers the information of the “invitation type” into invitation case database 124A in association with other asset information. Sharing server 100 further registers the “sharing establishment condition” into invitation case database 124A in association with the information of the “invitation type.”

### [Processing Procedure Corresponding to Invitation Type “Share” (First Determination Process)]

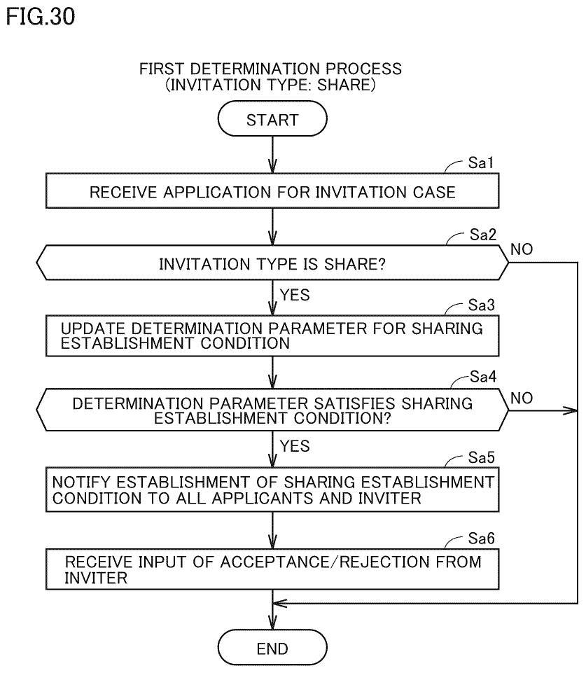

FIG. 30 is a flowchart showing a processing procedure of a first determination process according to modification 1. Referring to the flowchart shown in FIG. 30, the following describes a processing procedure for an invitation case corresponding to the invitation type “share.” A process that is based on this flowchart is performed by sharing server 100. Sharing server 100 performs the process that is based on this flowchart whenever an application for the invitation case is received.

First, sharing server 100 receives an application for the invitation case (step Sa1). Next, sharing server 100 determines whether or not the invitation type of the invitation case for which the application is made is “share” (step Sa2). When the invitation type of the invitation case for which the application is made is not “share,” sharing server 100 ends the process that is based on this flowchart.

When the invitation type of the invitation case for which the application is made is “share,” sharing server 100 updates a determination parameter for the sharing establishment condition (step Sa3). The determination parameter for the sharing establishment condition is different for each invitation case.

For example, when the sharing establishment condition is set to “five companies,” the determination parameter is the number of companies of applicants. Sharing server 100 specifies a company of an applicant whenever an application is made. For example, sharing server 100 adds 1 to the determination parameter whenever an application is made from each of different companies such as companies A, B, C, etc.

Next, sharing server 100 determines whether or not the determination parameter satisfies the sharing establishment condition (step Sa4). For example, in the case where the sharing establishment condition is set to “five company,” when the determination parameter=5, sharing server 100 determines that the determination parameter satisfies the sharing establishment condition. When the determination parameter does not satisfy the sharing establishment condition, sharing server 100 ends the process that is based on this flowchart.

When the determination parameter satisfies the sharing establishment condition, sharing server 100 notifies the establishment of the sharing establishment condition to all the applicants for the invitation case and the inviter (step Sa5). That is, when the sharing establishment condition is established, sharing server 100 fixes the applicants for the share-type invitation case. Next, sharing server 100 receives an input of acceptance/rejection from the inviter (step Sa6), and ends the process that is based on this flowchart. Thereafter, the process by notification unit 148 as described with reference to FIG. 10 is performed.

### [Processing Procedure Corresponding to Invitation Type “Sole” (Second Determination Process)]

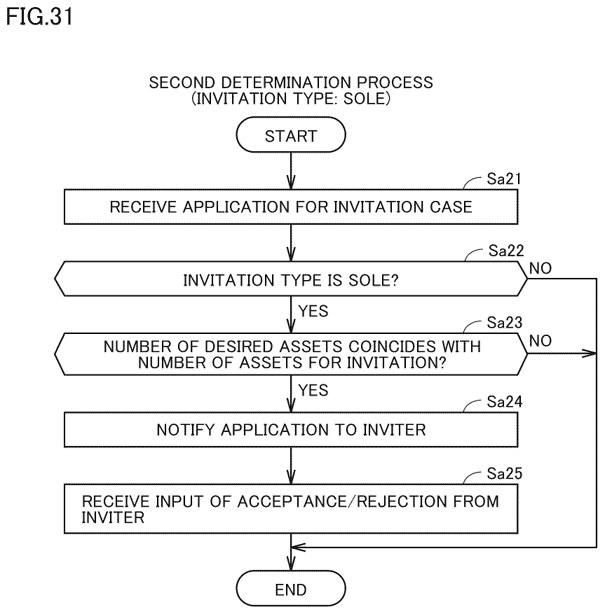

FIG. 31 is a flowchart showing a processing procedure of a second determination process according to modification 1. Referring to the flowchart shown in

FIG. 31, the following describes a processing procedure for an invitation case corresponding to the invitation type “sole.” A process that is based on this flowchart is performed by sharing server 100. Sharing server 100 performs the process that is based on this flowchart whenever an application for the invitation case is received.

First, sharing server 100 receives an application for the invitation case (step Sa21). Next, sharing server 100 determines whether or not the invitation type of the invitation case for which the application is made is “sole” (step Sa22). When the invitation type of the invitation case for which the application is made is not “sole,” sharing server 100 ends the process that is based on this flowchart.

When the invitation type of the invitation case for which the application is made is “sole,” sharing server 100 determines whether or not the number of assets desired by the applicant coincides with the number of assets for invitation (step Sa23). When the number of assets desired by the applicant does not coincide with the number of assets for invitation, the number of assets desired by the applicant is less than the number of assets for invitation by the inviter. In this case, sharing server 100 ends the process that is based on this flowchart. As a result, the application from the applicant is not accepted.

When the number of assets desired by the applicant coincides with the number of assets for invitation, sharing server 100 notifies the inviter that the application has been made (step Sa24). Next, sharing server 100 receives an input of acceptance/rejection from the inviter (step Sa25), and ends the process that is based on this flowchart. Thereafter, the process by notification unit 148 as described with reference to FIG. 10 is performed.

### [Processing Procedure Corresponding to Invitation Type “No Restriction” (Third Determination Process)]

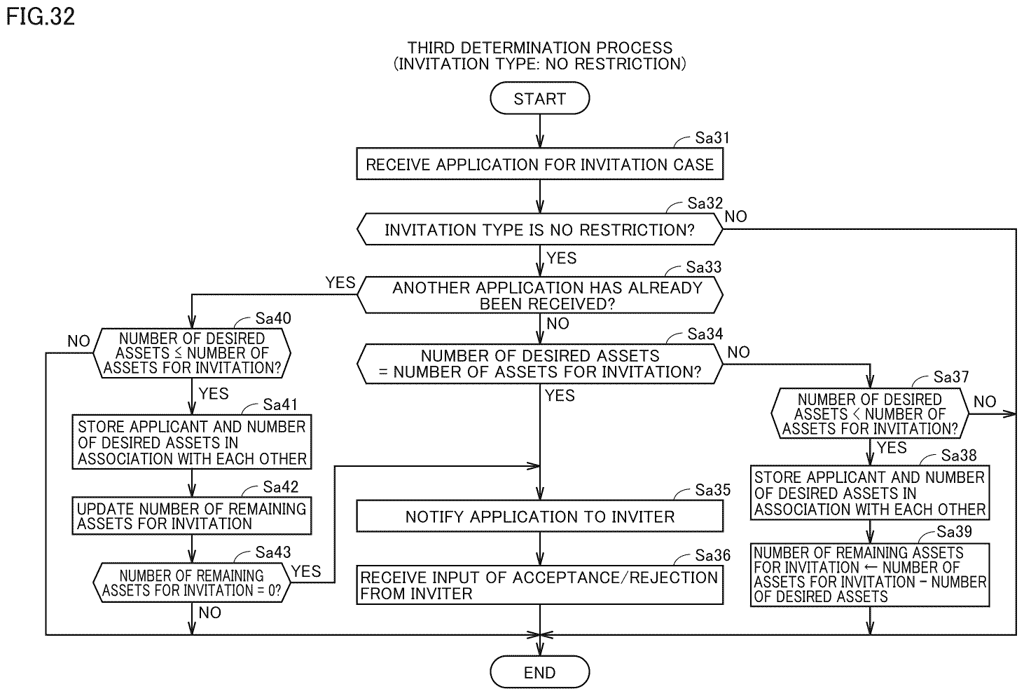

FIG. 32 is a flowchart showing a processing procedure of a third determination process according to modification 1. Referring to the flowchart shown in FIG. 32, the following describes a processing procedure for an invitation case corresponding to the invitation type “no restriction.” A process that is based on this flowchart is performed by sharing server 100. Sharing server 100 performs the process that is based on this flowchart whenever an application for the invitation case is received.

First, sharing server 100 receives an application for the invitation case (step Sa31). Next, sharing server 100 determines whether or not the invitation type of the invitation case for which the application is made is “no restriction” (step Sa32). When the invitation type of the invitation case for which the application is made is not “no restriction,” sharing server 100 ends the process that is based on this flowchart.

When the invitation type of the invitation case for which the application is made is “no restriction,” sharing server 100 determines whether or not an application from another applicant has already been received for the invitation case (step Sa33). When the application from another applicant has not been received, it means that a first application for this invitation case has been made. In this case, sharing server 100 determines whether or not the number of assets desired by the applicant coincides with the number of assets for invitation (step Sa34).

When the number of assets desired by the applicant coincides with the number of assets for invitation, there is no need to wait for another applicant to apply. In this case, sharing server 100 notifies the inviter that the application from the applicant has been made (step Sa35). Next, sharing server 100 receives an input of acceptance/rejection from the inviter (step Sa36), and ends the process that is based on this flowchart. Thereafter, the process by notification unit 148 as described with reference to FIG. 10 is performed.

When the number of assets desired by the applicant does not coincide with the number of assets for invitation, sharing server 100 confirms that the number of assets desired by the applicant is smaller than the number of assets for invitation (step Sa37). When the number of assets desired by the applicant is larger than the number of assets for invitation, sharing server 100 ends the process that is based on this flowchart without accepting the application.

When the number of assets desired by the applicant is smaller than the number of assets for invitation, sharing server 100 associates the applicant with the number of assets desired by the applicant and stores them together with the corresponding invitation case (step Sa38). Next, sharing server 100 calculates “the number of assets for invitation—the number of desired assets” and obtains the number of remaining assets for invitation (step Sa39).

Sharing server 100 stores the number of remaining assets for invitation, in association with the invitation case. Thereafter, sharing server 100 waits for a new application. Sharing server 100 determines YES in step Sa33 when a new application is made for the same invitation case. Sharing server 100 compares the number of remaining assets for invitation as stored in association with the same invitation case with the number of assets desired by the applicant in the new application. When the number of desired assets is larger than the number of remaining assets for invitation, sharing server 100 ends the process that is based on this flowchart without accepting the application.

When the number of desired assets is not larger than the number of remaining assets for invitation, sharing server 100 stores the new applicant and the number of desired assets in association with each other (step Sa41). Next, sharing server 100 updates the number of remaining assets for invitation by subtracting the new number of desired assets from the number of remaining assets for invitation (step Sa42). Sharing server 100 determines whether or not the updated number of remaining assets for invitation is 0 (step Sa43).

When the number of remaining assets for invitation after the update is not 0, the total of the numbers of assets desired by the plurality of applicants does not reach the number of assets for invitation. In this case, it is important to wait for a new applicant who desires the number of remaining assets to reach the number of assets for invitation. Therefore, in this case, sharing server 100 temporarily ends the process that is based on this flowchart, and waits for an application for the same invitation case.

When the number of remaining assets for invitation after the update is 0, it means that “the number of assets for invitation=the total number of desired assets” is established by the previous application(s) and the new application. In this case, sharing server 100 notifies each of the applications to the inviter and receives an input of acceptance/rejection from the inviter (steps Sa35 and Sa36). Thereafter, the process by notification unit 148 as described with reference to FIG. 10 is performed.

As described above, according to modification 1 regarding the sharing function, the assets for the invitation case can be shared by the plurality of applicants. By adding the sharing function to the embodiment described above, the plurality of applicants can acquire the assets for the invitation case.

Moreover, in the present embodiment, when an applicant searches for an invitation case, an invitation case that does not provide a disadvantage to the inviter is provided to the applicant (see FIG. 14). Therefore, according to matching system 1 to which modification 1 is applied, the inviter can be prevented from being provided with a disadvantage regardless of whether assets for the invitation case are shared by a plurality of applicants or are acquired by a sole applicant.

When the invitation case is directed to an educational curriculum such as a training that can be shared by a plurality of companies, it is not preferable that a competitor is included in the plurality of applicants. This is because the information of an educational field on which the company, which is the inviter, focus its effort is leaked to the competitor through the content of the educational curriculum. According to matching system 1 to which modification 1 is applied, also when such an educational curriculum is used as an invitation case, the inviter can be prevented from being provided with a disadvantage.

It should be noted that in modification 1, as the number of applicants to share the invitation case is increased, an amount of money to be paid by each applicant may be decreased. For example, when the invitation case is directed to a training, an amount of money to be paid by each applicant may be obtained by dividing the price for the invitation case set in advance by the number of applicants, with the result that the amount of money to be paid by each applicant is decreased as the number of applicants is increased.

### <Modification 2>

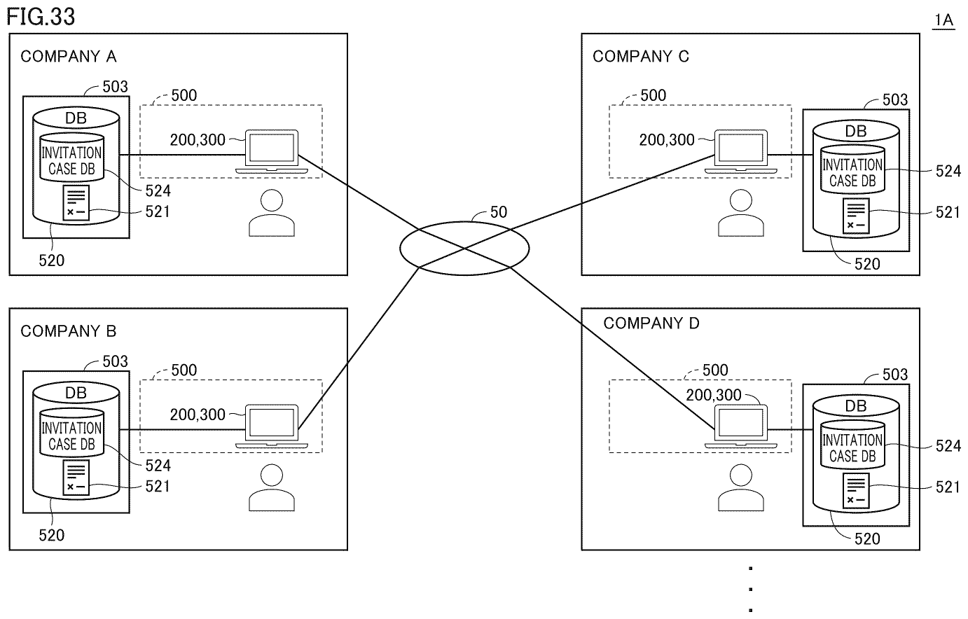

FIG. 33 is a diagram showing a configuration of a matching system 1A according to a modification 2. As shown in FIG. 33, the functions of sharing server 100 may be distributed across the systems in the companies. That is, as matching system 1, a distributed management type matching system 1A may be employed instead of centralized management type matching system 1.

The system configuration shown in FIG. 33 is the same among companies A, B, C, D, etc. In each company, user device 500, a database 520, and a storage 503 that stores the database are disposed. When a member operates user device 500 as an inviter, user device 500 functions as inviter device 200. When the member operates user device 500 as an applicant, user device 500 functions as applicant device 300.

User device 500 is constituted of, for example, a server. User device 500 is an exemplary computing device including inviter device 200 and applicant device 300. As with each of inviter device 200 and applicant device 300, user device 500 includes a processor, a memory that stores a program or the like for arithmetic processing of the processor, a communication interface, and the like.

Database 520 has the function of database 120 shown in FIG. 2, and includes an invitation case database 524 instead of invitation case database 124, and other various databases. In invitation case database 524 of company A, an invitation case prepared by an employee or the like of company A as an inviter is registered. In invitation case database 524 of company B, an invitation case prepared by an employee or the like of company B as an inviter is registered. Similarly, in invitation case database 524 of each of the other companies, an invitation case prepared by an employee of each of the companies as an inviter is registered.

A disclosure permission list 521 is registered in database 520. Disclosure permission list 521 includes a list of groups (companies, communities, or the like) to which an invitation case is permitted to be disclosed. Disclosure permission list 521 includes information corresponding to the “non-disclosure company ID list” and the “disclosure level” among the pieces of information registered in invitation case database 124 shown in FIG. 6. User device 500 registers, into database 520, disclosure permission list 521 (disclosure information) indicating the invitation case (asset information) and the scope of disclosure of the invitation case.

Based on disclosure permission list 521, user device 500 of company A determines a company or community to which the invitation case is to be disclosed and a company or community to which the invitation case is not to be disclosed. User device 500 of company A transmits the invitation case to each company or community based on the determination. For example, when user device 500 of company A determines to disclose a certain invitation case to company C and not to disclose the invitation case to companies B and D, user device 500 of company A transmits the invitation case to company C and does not transmit the invitation case to companies B and D.

User device 500 of each of companies B, C, D, etc. operates based on disclosure permission list 521 in the same manner as user device 500 of company A. Thus, user device 500 determines, based on disclosure permission list 521, the invitation case permitted to be disclosed to the applicant among the invitation cases registered in database 520, and provides applicant device 300 with the invitation case permitted to be disclosed to the applicant.

According to modification 2, a server for managing the system in a centralized manner does not need to be provided in the matching system.

### <Modification 3>

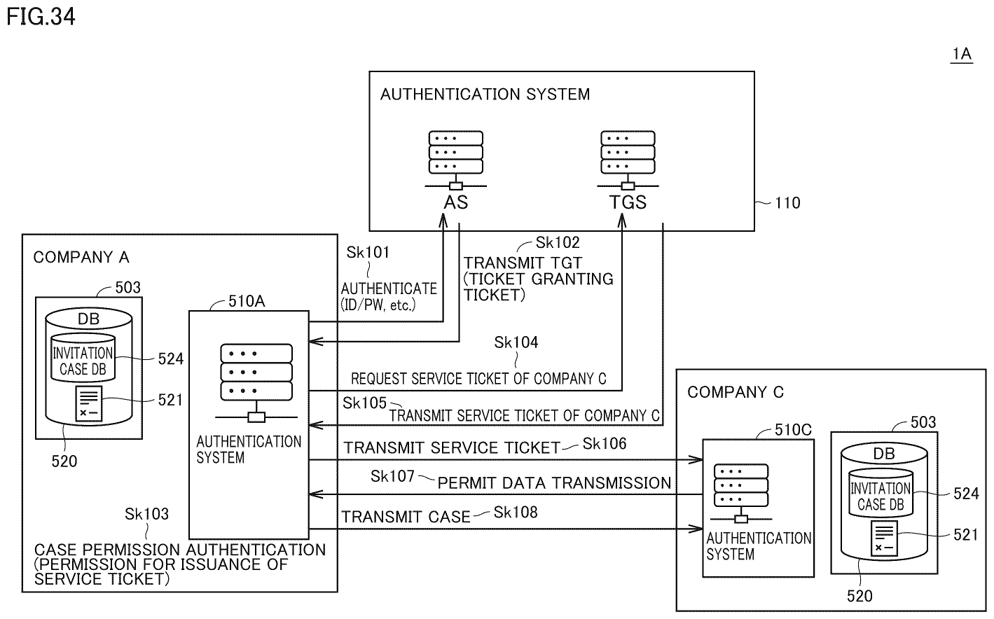

A modification 3 will be described with reference to FIG. 34. FIG. 34 is a diagram showing an example (modification 3) in which Kerberos authentication is applied to matching system 1A. As shown in FIG. 34, the Kerberos authentication may be applied to authentication between companies in matching system 1A. The Kerberos authentication is one of network authentication methods applied between a server and a client.

Here, modification 3 will be described by exemplifying companies A and C among the plurality of companies. As shown in FIG. 34, an authentication system 510A is disposed in company A, and an authentication system 510C is disposed in company C. An authentication system 110 is a KDC (key distribution center). Authentication system 110 is operated by an authentication institution, for example. Authentication system 110 is constituted of a server located in the authentication institution. Each of authentication systems 510A, 510C is constituted of, for example, user device 500 (see FIG. 33).

Authentication system 110 has a function of issuing a TGT (Ticket Granting Ticket). Authentication system 110 includes an AS (Authentication Server) and a TGS (Ticket Granting Server). The AS issues the TGT (Ticket Granting Ticket). The TGT is a ticket required to obtain a service ticket. The TGS issues a service ticket. Company A can transmit data to company C by obtaining the service ticket.

Here, it will be illustratively described that company A transmits an invitation case to company C after performing the Kerberos authentication. Therefore, here, company A is an inviter, and company C is an applicant. First, authentication system 510A requests authentication system 110 to perform an authentication procedure (step Sk101). For example, authentication system 510A transmits information for authentication, such as an ID and a password for login, to the AS of authentication system 110. Authentication system 510A may use a public authentication key technique for the authentication procedure.

The AS of authentication system 110 performs authentication based on the information received from authentication system 510A, and then transmits the TGT to authentication system 510A (step Sk102). Authentication system 510A performs permission authentication for the case and obtains an issuance permission for the service ticket (step Sk103).

Next, authentication system 510A requests a service ticket of company C to the TGS of authentication system 110 (step Sk104). On this occasion, authentication system 510A presents, to the TGS, the TGT issued by the AS. The TGS checks the TGT, and then transmits the service ticket of the company C to authentication system 510A (step Sk105).

Next, authentication system 510A transmits the service ticket to authentication system 510C of company C in order to obtain a transmission permission from company C (step Sk106). Authentication system 510C obtains the service ticket. Authentication system 510C transmits a data transmission permission to authentication system 510A (step Sk107).

Then, authentication system 510A transmits, to authentication system 510C, the case permitted to be disclosed to company C by disclosure permission list 521 among the invitation cases registered in invitation case database 524. Thus, company A can allow the applicant of company C to view the invitation case of company A. It should be noted that instead of each company storing disclosure permission list 521 of the company, disclosure permission lists 521 of all the companies may be stored in authentication system 110. In this case, authentication system 110 has a function of determining a viewing authority for each invitation case.

When the Kerberos authentication is applied to matching system 1A, company A can use the obtained TGT, thereby simplifying the authentication procedure when transmitting a case to a company other than company C. For example, when the case is desired to be transmitted to company D, authentication system 510A of company A requests a service ticket of company D to the TGS with the obtained TGT being presented. When there is no problem with the TGT, the TGS issues the service ticket of company D to authentication system 510A.

By using the Kerberos authentication as described above, a Single Sign On technique can be implemented in matching system 1A. As a result, for example, when data such as an invitation case is transmitted from company A to another company, it is not necessary to perform authentication for each company. It should be noted that here, companies A and C are shown as an example of the plurality of companies. However, the Kerberos authentication as described above may be applied as an authentication method among three or more companies.

The present embodiment described above has configurations listed below.

(a) In a matching system, an inviter device operated by an inviter transmits, to a computing device, asset information (case information) for making an invitation to be a transferee and disclosure information indicating a scope of disclosure of the asset information, the computing device registers the asset information and the disclosure information into a database, and the computing device determines, based on corresponding disclosure information, asset information permitted to be disclosed to a first applicant among pieces of asset information registered in the database, and provides a first applicant device with the asset information permitted to be disclosed to the first applicant.

(b) The matching system further includes a second applicant device to be operated by a second applicant different from the first applicant, wherein the computing device determines, based on corresponding disclosure information, asset information permitted to be disclosed to the second applicant among the pieces of asset information registered in the database, and provides the second applicant device with the asset information permitted to be disclosed to the second applicant.

(c) The matching system further includes a third applicant device to be operated by a third applicant different from the first applicant and the second applicant, wherein any of a plurality of disclosure levels is set for the disclosure information, and in accordance with each of the disclosure levels, the computing device determines whether to permit disclosure to each of the first applicant to the third applicant.

(d) In the matching system, the first applicant belongs to a first group, the second applicant belongs to a second group different from the first group, and the plurality of disclosure levels include a first level and a second level, the first level corresponds to permitting the asset information to be disclosed to the first applicant and prohibiting the asset information from being disclosed to an applicant not belonging to the first group, and the second level corresponds to permitting the asset information to be disclosed to an applicant belonging to any of the first group and a community group having a community relationship with the first group, and prohibiting the asset information from being disclosed to an applicant not belonging to any of the first group and the community group.

(e) In the matching system, the first applicant belongs to a first group, and the second applicant belongs to a second group different from the first group, the plurality of disclosure levels include a first level, a second level, and a third level, the first level corresponds to permitting the asset information to be disclosed to the first applicant and prohibiting the asset information from being disclosed to an applicant not belonging to the first group, the second level corresponds to permitting the asset information from being disclosed to an applicant belonging to any of the first group and a community group having a community relationship with the first group, and the third level corresponds to permitting the asset information to be disclosed to an applicant belonging to each of the first group and a specific community group that is different from the community group corresponding to the second level and having the community relationship with the first group, and prohibiting the asset information from being disclosed to an applicant not belonging to any of the first group and the specific community group.

(f) In the matching system, the plurality of disclosure levels include a disclosure level corresponding to permitting the asset information to be disclosed to an applicant regardless of a group to which the applicant belongs.

(g) In the matching system, attribute data by which the community group is able to be specified is registered in the database, the computing device specifies an applicant to whom the asset information is permitted to be disclosed, based on the disclosure information and the attribute data.

(h) In the matching system, the inviter device receives an operation of inputting a target group to which the asset information is prohibited from being disclosed, and transmits, to the computing device, information by which the received target group is able to be specified, and the computing device prohibits the asset information from being disclosed to an applicant belonging to the target group even when the disclosure level is a level at which the asset information is permitted to be disclosed to the target group.

(i) In the matching system, the first applicant belongs to a first company, and the second applicant belongs to a second company different from the first company.

(j) An evaluator device to be operated by one or more evaluators belonging to a first group includes: an interface that receives an operation of inputting an evaluation for an applicant; a receiving unit that receives a viewing request; a display; and a processor that transmits the evaluation received by the interface and the viewing request received by the receiving unit to a computing device that is able to access a database, wherein the processor causes the display to present the evaluation made by each of the one or more evaluators belonging to the first group when the viewing request is made.

(k) A method of evaluating an applicant includes: communicating with a first evaluator device operated by one or more evaluators belonging to a first group; receiving, from the first evaluator device, an evaluation for the applicant; registering, into a database, first evaluation information that is based on the evaluation received from the first evaluator device; and when a viewing request is received in a first communication established in accordance with identification information by which one is able to be identified to belong to the first group, transmitting the first evaluation information to an origin of transmission of the viewing request in the first communication.

(l) An evaluator device to be operated by one or more evaluators belonging to a first group includes: an interface that receives an operation of inputting an evaluation for an inviter; a receiving unit that receives a viewing request; a display; and a processor that transmits the evaluation received by the interface and the viewing request received by the receiving unit to a computing device that is able to access a database, wherein the processor causes the display to present the evaluation made by each of the one or more evaluators belonging to the first group when the viewing request is made.

(m) A method of evaluating an inviter includes: communicating with a first evaluator device operated by one or more evaluators belonging to a first group; receiving, from the first evaluator device, an evaluation for the inviter; registering, into a database, first evaluation information that is based on the evaluation received from the first evaluator device; and when a viewing request is received in a first communication established in accordance with identification information by which one is able to be identified to belong to the first group, transmitting the first evaluation information to an origin of transmission of the viewing request in the first communication.

(n) A computing device included in a matching system that matches an inviter and an applicant includes: a communication interface that communicates with a first applicant device operated by a first applicant; and a processor that accesses a database, wherein the processor registers, into the database, asset information indicating a subject of an asset and disclosure information indicating a scope of disclosure of the asset information, the processor determines, based on corresponding disclosure information, asset information permitted to be disclosed to the first applicant among pieces of asset information registered in the database, the asset information includes detailed information about a content of the asset, and the processor causes the first applicant device to present the asset information permitted to be disclosed to the first applicant and a meaning of a term included in the detailed information.

(o) A method of matching an inviter and an applicant includes: communicating with a first applicant device operated by a first applicant; registering, into a database, asset information indicating a subject of an asset and disclosure information indicating a scope of disclosure of the asset information; and determining, based on corresponding disclosure information, asset information permitted to be disclosed to the first applicant among pieces of asset information registered in the database, wherein the asset information includes detailed information about a content of the asset, the method further comprising causing the first applicant device to present the asset information permitted to be disclosed to the first applicant and a meaning of a term included in the detailed information.

### [Implementations]

Implementations of the present disclosure are listed below.

(Item 1) A matching system according to item 1 is a matching system that matches an inviter and an applicant, who applies for an invitation, when an owner of an asset becomes the inviter so as to invite an application to be the one whom the asset is to be transferred or by whom the asset is to be used, the matching system comprising: an inviter device to be operated by the inviter; a first applicant device to be operated by a first applicant; and a computing device that communicates with the inviter device and the first applicant device, the computing device being able to access a database, wherein the inviter device transmits asset information and disclosure information to the computing device, the asset information indicating a subject of the asset, the disclosure information indicating a scope of disclosure of the asset information, the computing device registers the asset information and the disclosure information into the database, and the computing device determines, based on corresponding disclosure information, asset information permitted to be disclosed to the first applicant among pieces of asset information registered in the database, and provides the first applicant device with the asset information permitted to be disclosed to the first applicant.

(Item 2) A matching system according to item 2 is such that the matching system according to item 1 further comprises a second applicant device to be operated by a second applicant different from the first applicant, wherein the computing device determines, based on corresponding disclosure information, asset information permitted to be disclosed to the second applicant among the pieces of asset information registered in the database, and provides the second applicant device with the asset information permitted to be disclosed to the second applicant.

(Item 3) A matching system according to item 3 is such that the matching system according to item 2 further comprises a third applicant device to be operated by a third applicant different from the first applicant and the second applicant, wherein any of a plurality of disclosure levels is set for the disclosure information, and in accordance with each of the disclosure levels, the computing device determines whether to permit disclosure to each of the first applicant to the third applicant.

(Item 4) A matching system according to item 4 is such that in the matching system according to item 3, the first applicant belongs to a first group and the second applicant belongs to a second group different from the first group, the plurality of disclosure levels include a first level and a second level, the first level corresponds to permitting the asset information to be disclosed to the first applicant and prohibiting the asset information from being disclosed to an applicant not belonging to the first group, and the second level corresponds to permitting the asset information from being disclosed to an applicant belonging to any of the first group and a community group having a community relationship with the first group, and prohibiting the asset information from being disclosed to an applicant not belonging to any of the first group and the community group.

(Item 5) A matching system according to item 5 is such that in the matching system according to item 3, the first applicant belongs to a first group and the second applicant belongs to a second group different from the first group, the plurality of disclosure levels include a first level, a second level, and a third level, the first level corresponds to permitting the asset information to be disclosed to the first applicant and prohibiting the asset information from being disclosed to an applicant not belonging to the first group, the second level corresponds to permitting the asset information to be disclosed to an applicant belonging to any of the first group and a community group having a community relationship with the first group, and the third level corresponds to permitting the asset information to be disclosed to an applicant belonging to each of the first group and a community that is different from the community group corresponding to the second level and having the community relationship with the first group, and prohibiting the asset information from being disclosed to an applicant not belonging to any of the first group and the community group.

(Item 6) A matching system according to item 6 is such that in the matching system according to item 4, the plurality of disclosure levels include a disclosure level corresponding to permitting the asset information to be disclosed to an applicant regardless of a group to which the applicant belongs.

(Item 7) A matching system according to item 7 is such that in the matching system according to item 5 or 6, attribute data by which the community group is able to be specified is registered in the database, and the computing device specifies an applicant to whom the asset information is permitted to be disclosed, based on the disclosure information and the attribute data.

(Item 8) A matching system according to item 8 is such that in the matching system according to any one of items 3 to 7, the inviter device receives an operation of inputting a target group to which the asset information is prohibited from being disclosed, and transmits, to the computing device, information by which the received target group is able to be specified, and the computing device prohibits the asset information from being disclosed to an applicant belonging to the target group even when the disclosure level is a level at which the asset information is permitted to be disclosed to the target group.

(Item 9) A matching system according to item 9 is such that in the matching system according to any one of items 2 to 8, the first applicant belongs to a first company, and the second applicant belongs to a second company different from the first company.

(Item 10) A matching system according to item 10 is such that in the matching system according to any one of items 1 to 9, the inviter device transmits, to the computing device, invitation type information by which the asset is able to be specified to be a share-type asset that is to be transferred to or to be used by one or more selected applicants, and the computing device registers the invitation type information into the database in association with the asset information.

(Item 11) A matching system according to item 11 is such that in the matching system according to item 10, the computing device registers a sharing establishment condition into the database in association with the invitation type information, the sharing establishment condition is a condition about the number of applicants for the share-type asset, and when the sharing establishment condition is established, the computing device fixes the applicants for the share-type asset.

(Item 12) A matching system according to item 12 is such that in the matching system according to item 1, the inviter device includes a first inviter device to be operated by one or more inviters belonging to a first group, the first inviter device receives an input of an evaluation for the first applicant and transmits the received evaluation to the computing device, the computing device registers, into the database on an applicant basis, first evaluation information that is based on the evaluation received from the first inviter device, and when the computing device receives a viewing request in a first communication established in accordance with identification information by which one is able to be identified to belong to the first group, the computing device transmits the first evaluation information to an origin of transmission of the viewing request in the first communication.

(Item 13) A matching system according to item 13 is such that in the matching system according to item 12, the inviter device further includes a second inviter device to be operated by one or more inviters belonging to a second group different from the first group, the second inviter device receives an input of an evaluation for the first applicant and transmits the received evaluation to the computing device, the computing device registers, into the database on the applicant basis, second evaluation information that is based on the evaluation received from the second inviter device, and when the computing device receives a viewing request in a second communication established in accordance with identification information by which one is able to be identified to belong to the second group, the computing device transmits the second evaluation information to an origin of transmission of the viewing request in the second communication.

(Item 14) A matching system according to item 14 is such that in the matching system according to item 13, the first group is constituted of a first company, and the second group is constituted of a second company different from the first company.

(Item 15) A matching system according to item 15 is such that in the matching system according to item 13, the first group is constituted of a first department of a first company, and the second group is constituted of a second department of the first company.

(Item 16) A matching system according to item 16 is such that in the matching system according to any one of items 12 to 15, when the computing device receives evaluations for a predetermined applicant from a plurality of inviters belonging to the first group, the computing device calculates an average value of the evaluations made for the predetermined applicant by the plurality of inviters, and the computing device transmits the average value as the first evaluation information for the predetermined applicant to the origin of transmission of the viewing request in the first communication.

(Item 17) A matching system according to item 17 is such that in the matching system according to item 16, the first group includes one or more inviters belonging to a first division group and one or more inviters belonging to a second division group different from the first division group, based on evaluations for a predetermined order receiver from a plurality of inviters belonging to the first division group, the computing device calculates a first average value that is an average value of the evaluations for the predetermined applicant, based on evaluations for the predetermined order receiver from a plurality of inviters belonging to the second division group, the computing device calculates a second average value that is an average value of the evaluations for the predetermined applicant, based on the evaluations for the predetermined order receiver from the plurality of inviters belonging to the first group, the computing device calculates a third average value that is an average value of the evaluations for the predetermined applicant, when the computing device receives a viewing request in a third communication established in accordance with identification information by which one is able to be identified to belong to the first division group, the computing device transmits each of the first average value and the third average value as the first evaluation information for the predetermined applicant to an origin of transmission of the viewing request in the third communication, and when the computing device receives a viewing request in a fourth communication established in accordance with identification information by which one is able to be identified to belong to the second division group, the computing device transmits each of the second average value and the third average value as the first evaluation information for the predetermined applicant to an origin of transmission of the viewing request in the fourth communication.

(Item 18) A matching system according to item 18 is such that in the matching system according to any one of items 12 to 17, a list of applicants is registered in the database,
when the first inviter device receives an operation of searching in the list, the first inviter device transmits a search request to the computing device, and
when the computing device receives the search request, the computing device transmits, to the origin of transmission of the viewing request in the first communication, a search result in which an applicant who has an evaluation specified by the first evaluation information to have a magnitude not satisfying a criterion is excluded from the list.

(Item 19) A matching system according to item 19 is such that in the matching system according to item 1, the first applicant belongs to a first group, the first applicant device receives an input of an evaluation for the inviter and transmits the received evaluation to the computing device, the computing device registers, into the database on an inviter basis, first evaluation information that is based on the evaluation received from the first applicant device, and when the computing device receives a viewing request in a first communication established in accordance with identification information by which one is able to be identified to belong to the first group, the computing device transmits the first evaluation information to an origin of transmission of the viewing request in the first communication.

(Item 20) A matching system according to item 20 is such that the matching system according to item 19 further comprises a second applicant device to be operated by one or more second applicants belonging to a second group different from the first group, the second applicant device receives an input of an evaluation for an inviter and transmits the received evaluation to the computing device, the computing device registers, into the database on the inviter basis, second evaluation information that is based on the evaluation received from the second applicant device, and when the computing device receives a viewing request in a second communication established in accordance with identification information by which one is able to be identified to belong to the second group, the computing device transmits the second evaluation information to an origin of transmission of the viewing request in the second communication.

(Item 21) A matching system according to item 21 is such that in the matching system according to item 20, the first group is constituted of a first company, and the second group is constituted of a second company different from the first company.

(Item 22) A matching system according to item 22 is such that in the matching system according to item 20, the first group is constituted of a first department of a first company, and the second group is constituted of a second department of the first company.

(Item 23) A matching system according to item 23 is such that in the matching system according to any one of items 19 to 22, when the computing device receives evaluations for a predetermined inviter from a plurality of first applicants belonging to the first group, the computing device calculates an average value of the evaluations made for the predetermined inviter by the plurality of first applicants, and the computing device transmits the average value as the first evaluation information for the predetermined inviter to the origin of transmission of the viewing request in the first communication.

(Item 24) A matching system according to item 24 is such that in the matching system according to any one of items 19 to 21, the first group includes one or more first applicants belonging to a first division group and one or more first applicants belonging to a second division group different from the first division group, based on evaluations for a predetermined inviter from a plurality of first applicants belonging to the first division group, the computing device calculates a first average value that is an average value of the evaluations for the predetermined inviter, based on evaluations for the predetermined inviter from a plurality of first applicants belonging to the second division group, the computing device calculates a second average value that is an average value of the evaluations for the predetermined inviter, based on evaluations for the predetermined inviter from a plurality of first applicants belonging to the first group, the computing device calculates a third average value that is an average value of the evaluations for the predetermined inviter, when the computing device receives a viewing request in a third communication established in accordance with identification information by which one is able to be identified to belong to the first division group, the computing device transmits each of the first average value and the third average value as the first evaluation information for the predetermined inviter to an origin of transmission of the viewing request in the third communication, and when the computing device receives a viewing request in a fourth communication established in accordance with identification information by which one is able to be identified to belong to the second division group, the computing device transmits each of the second average value and the third average value as the first evaluation information for the predetermined inviter to an origin of transmission of the viewing request in the fourth communication.

(Item 25) A matching system according to item 25 is such that in the matching system according to any one of items 19 to 24, a list of inviters is registered in the database, when the first applicant device receives an operation of searching in the list, the first applicant device transmits a search request to the computing device, when the computing device receives the search request, the computing device transmits, to the origin of transmission of the viewing request in the first communication, a search result in which an inviter who has an evaluation specified by the first evaluation information to have a magnitude not satisfying a criterion is excluded from the list.

(Item 26) A matching system according to item 26 is such that in the matching system according to item 1, the asset information includes detailed information about a content of the asset, and the computing device causes the first applicant device to present the asset information permitted to be disclosed to the first applicant and a meaning of a term included in the detailed information.

(Item 27) A matching system according to item 27 is such that in the matching system according to item 26, the term included in the detailed information is an in-house term widely used in a group to which the inviter belongs.

(Item 28) A matching system according to item 28 is such that in the matching system according to item 27, the computing device registers, into the database, the in-house term and the meaning of the in-house term.

(Item 29) A matching system according to item 29 is such that in the matching system according to item 28, the computing device registers the in-house term into the database based on the group to which the inviter belongs.

(Item 30) A matching system according to item 30 is such that in the matching system according to item 28 or 29, when an operation of the first applicant for the in-house term is detected in the first applicant device, the computing device transmits, to the first applicant device, information by which the meaning of the in-house term registered in the database is able to be specified.

(Item 31) A matching system according to item 31 is such that in the matching system according to any one of items 27 to 30, the computing device searches for the in-house term included in the detailed information, and registers the asset information into the database with the detected in-house term and the meaning of the in-house term being associated with each other.

(Item 32) An inviter device according to item 32 is an inviter device operated by an inviter when an owner of an asset becomes the inviter so as to invite an application to be the one whom the asset is to be transferred or by whom the asset is to be used, wherein the inviter device communicates with a computing device that matches the inviter and an applicant who applies for the invitation, the inviter device comprising: an interface that receives an operation of inputting asset information and disclosure information, the asset information indicating a subject of the asset, the disclosure information indicating a scope of disclosure of the asset information; and a processor that transmits, to the computing device, the asset information and the disclosure information received by the interface, wherein the disclosure information includes information for instructing the computing device to permit the asset information to be disclosed to a first applicant and to prohibit the asset information from being disclosed to a second applicant different from the first applicant.

(Item 33) A method according to item 33 is a method of matching an inviter and an applicant, who applies for an invitation, when an owner of an asset becomes the inviter so as to invite an application to be the one whom the asset is to be transferred or by whom the asset is to be used, the method comprising: communicating with an inviter device operated by the inviter and a first applicant device operated by a first applicant; receiving asset information and disclosure information from the inviter device operated by the inviter, the asset information indicating a subject of the asset, the disclosure information indicating a scope of disclosure of the asset information; registering the asset information and the disclosure information into a database; and determining, based on corresponding disclosure information, asset information permitted to be disclosed to the first applicant among pieces of asset information registered in the database, and providing the first applicant device with the asset information permitted to be disclosed to the first applicant.

The embodiments disclosed herein are illustrative and non-restrictive in any respect. The scope of the present disclosure is defined by the terms of the claims, rather than the embodiments described above, and is intended to include any modifications within the scope and meaning equivalent to the terms of the claims.

### REFERENCE SIGNS LIST

1 matching system; 50 internet; 100 sharing server; 101 processor; 102 memory; 103 storage; 104 communication interface; 120 database (DB); 121 company database (company DB); 122 member database (member DB); 123 community database (community DB); 124, 124A invitation case database (invitation case DB); 126 evaluation input database (evaluation input DB); 126A inviter evaluation portion; 126B applicant evaluation portion; 127 evaluation summary database (evaluation summary DB); 127A inviter evaluation summary portion; 127B applicant evaluation summary portion; 129 profile database (profile DB); 137 company-specific term database (company-specific term DB); 140 community registration unit; 141 company registration unit; 142 member registration unit; 143 member search unit; 144 case registration unit; 145 case extraction unit; 146 request unit; 147 approval unit; 148 notification unit; 151 evaluation receiving unit; 152 evaluation output unit; 200, 200A, 200B, 200C inviter device; 201 processor; 202 memory; 203 communication interface; 204 input/output interface; 205 display; 206 operation unit; 300, 300A, 300B, 300C applicant device; 301 processor; 302 memory; 303 communication interface; 304 input/output interface; 305 display; 306 operation unit; 402 table; 500 user device; 1271, 1272 data group.

1. A matching system configured to match an inviter and an applicant who applies for an invitation when an owner of an asset becomes the inviter so as to invite an application to be one to whom the asset is to be transferred or by whom the asset is to be used, the matching system comprising:
an inviter device operated by the inviter;
a first applicant device operated by a first applicant; and
a computing device configured to communicate with the inviter device and the first applicant device, the computing device configured to access a database,
wherein the first applicant belongs to a first group and the inviter belongs to an inviter group different from the first group,
wherein the inviter device is configured to transmit asset information and disclosure information to the computing device, the asset information indicating a subject of the asset, the disclosure information indicating a scope of disclosure of the asset information,
wherein the computing device is configured to register the asset information and the disclosure information into the database, and
wherein the computing device is configured to determine asset information permitted to be disclosed to the first group among asset information registered in the database based on corresponding disclosure information, and provide the first applicant device with the asset information permitted to be disclosed to the first group.

2. The matching system according to claim 1, further comprising a second applicant device operated by a second applicant different from the first applicant,
wherein the second applicant belongs to a second group different from the first group, and
wherein the computing device is configured to determine asset information permitted to be disclosed to the second group among the asset information registered in the database based on corresponding disclosure information, and provide the second applicant device with the asset information permitted to be disclosed to the second group.

3. The matching system according to claim 2,
wherein a plurality of disclosure levels are set for the disclosure information, the plurality of disclosure levels comprising a first level and a second level,
wherein the first level corresponds to permitting the asset information to be disclosed to the first applicant and prohibiting the asset information from being disclosed to an applicant not belonging to the first group, and
wherein the second level corresponds to permitting the asset information to be disclosed to an applicant belonging to any of the first group and a community group having a community relationship with the first group, and prohibiting the asset information from being disclosed to an applicant not belonging to any of the first group and the community group.

4. The matching system according to claim 2,
wherein the plurality of disclosure levels comprise a first level, a second level, and a third level,
wherein the first level corresponds to permitting the asset information to be disclosed to the first applicant and prohibiting the asset information from being disclosed to an applicant not belonging to the first group,
wherein the second level corresponds to permitting the asset information to be disclosed to an applicant belonging to any of the first group and a community group having a community relationship with the first group, and
wherein the third level corresponds to permitting the asset information to be disclosed to an applicant belonging to each of the first group and a community that is different from the community group corresponding to the second level and having the community relationship with the first group, and prohibiting the asset information from being disclosed to an applicant not belonging to any of the first group and the community group.

5. The matching system according to claim 3, wherein the plurality of disclosure levels comprise a disclosure level corresponding to permitting the asset information to be disclosed to an applicant regardless of a group to which the applicant belongs.

6. The matching system according to claim 4,
wherein attribute data by which the community group is able to be specified is registered in the database, and
wherein the computing device is configured to specify an applicant to whom the asset information is permitted to be disclosed based on the disclosure information and the attribute data.

7. The matching system according to claim 2,
wherein a plurality of disclosure levels are set for the disclosure information,
wherein the inviter device is configured to receive an operation of inputting a target group to which the asset information is prohibited from being disclosed, and transmit information by which the received target group is able to be specified to the computing device, and
wherein the computing device is configured to prohibit the asset information from being disclosed to an applicant belonging to the target group even when the disclosure level is a level at which the asset information is permitted to be disclosed to the target group.

8. The matching system according to claim 1,
wherein the inviter device is configured to transmit invitation type information by which the asset is able to be specified to be a share-type asset that is to be transferred to or to be used by one or more selected applicants to the computing device, and
wherein the computing device is configured to register the invitation type information into the database in association with the asset information.

9. The matching system according to claim 8,
wherein the computing device is configured to register a sharing establishment condition into the database in association with the invitation type information,
wherein the sharing establishment condition is a condition about the number of applicants for the share-type asset, and
wherein when the sharing establishment condition is established, the computing device fixes the applicants for the share-type asset.

10. The matching system according to claim 1,
wherein the inviter device comprises a first inviter device operated by one or more inviters belonging to a first group,
wherein the first inviter device is configured to receive an input of an evaluation for the first applicant and transmit the received evaluation to the computing device,
wherein the computing device is configured to register first evaluation information based on the evaluation received from the first inviter device into the database on an applicant basis,
wherein when the computing device receives a viewing request in a first communication established in accordance with identification information by which one is able to be identified to belong to the first group, the computing device is configured to transmit the first evaluation information to an origin of transmission of the viewing request in the first communication,
wherein the inviter device comprises a second inviter device configured to be operated by one or more inviters belonging to a second group different from the first group,
wherein the second inviter device is configured to receive an input of an evaluation for the first applicant and transmit the received evaluation to the computing device,
wherein the computing device is configured to register, into the database on the applicant basis, second evaluation information that is based on the evaluation received from the second inviter device, and
wherein when the computing device receives a viewing request in a second communication established in accordance with identification information by which one is able to be identified to belong to the second group, the computing device is configured to transmit the second evaluation information to an origin of transmission of the viewing request in the second communication.

11. The matching system according to claim 10,
wherein when the computing device receives evaluations for a predetermined applicant from a plurality of inviters belonging to the first group, the computing device is configured to calculate an average value of the evaluations made for the predetermined applicant by the plurality of inviters, and
wherein the computing device is configured to transmit the average value as the first evaluation information for the predetermined applicant to the origin of transmission of the viewing request in the first communication.

12. The matching system according to claim 11,
wherein the first group includes one or more inviters belonging to a first division group and one or more inviters belonging to a second division group different from the first division group,
wherein based on evaluations for a predetermined order receiver from a plurality of inviters belonging to the first division group, the computing device is configured to calculate a first average value that is an average value of the evaluations for the predetermined applicant,
wherein based on evaluations for the predetermined order receiver from a plurality of inviters belonging to the second division group, the computing device is configured to calculate a second average value that is an average value of the evaluations for the predetermined applicant,
wherein based on the evaluations for the predetermined order receiver from the plurality of inviters belonging to the first group, the computing device is configured to calculate a third average value that is an average value of the evaluations for the predetermined applicant,
wherein when the computing device receives a viewing request in a third communication established in accordance with identification information by which one is able to be identified to belong to the first division group, the computing device is configured to transmit each of the first average value and the third average value as the first evaluation information for the predetermined applicant to an origin of transmission of the viewing request in the third communication,
wherein when the computing device receives a viewing request in a fourth communication established in accordance with identification information by which one is able to be identified to belong to the second division group, the computing device is configured to transmit each of the second average value and the third average value as the first evaluation information for the predetermined applicant to an origin of transmission of the viewing request in the fourth communication,
wherein a list of applicants is registered in the database,
wherein when the first inviter device receives an operation of searching in the list, the first inviter device is configured to transmit a search request to the computing device, and
wherein when the computing device receives the search request, the computing device is configured to transmit, to the origin of transmission of the viewing request in the first communication, a search result in which an applicant who has an evaluation specified by the first evaluation information to have a magnitude not satisfying a criterion is excluded from the list.

13. The matching system according to claim 1,
wherein the first applicant belongs to a first group,
wherein the first applicant device is configured to receive an input of an evaluation for the inviter and transmit the received evaluation to the computing device,
wherein the computing device is configured to register first evaluation information that is based on the evaluation received from the first applicant device into the database on an inviter basis, and
wherein when the computing device receives a viewing request in a first communication established in accordance with identification information by which one is able to be identified to belong to the first group, the computing device is configured to transmit the first evaluation information to an origin of transmission of the viewing request in the first communication.

14. The matching system according to claim 13, further comprising:
a second applicant device operated by one or more second applicants belonging to a second group different from the first group, the second applicant device configured to receive an input of an evaluation for the inviter and transmits the received evaluation to the computing device, and the computing device configured to register second evaluation information that is based on the evaluation received from the second applicant device into the database on the inviter basis,
wherein when the computing device receives a viewing request in a second communication established in accordance with identification information by which one is able to be identified to belong to the second group, the computing device is configured to transmit the second evaluation information to an origin of transmission of the viewing request in the second communication.

15. The matching system according to claim 13,
wherein when the computing device receives evaluations for a predetermined inviter from a plurality of first applicants belonging to the first group, the computing device is configured to calculate an average value of the evaluations made for the predetermined inviter by the plurality of first applicants, and
wherein the computing device is configured to transmit the average value as the first evaluation information for the predetermined inviter to the origin of transmission of the viewing request in the first communication.

16. The matching system according to claim 13,
wherein the first group includes one or more first applicants belonging to a first division group and one or more first applicants belonging to a second division group different from the first division group,
wherein based on evaluations for a predetermined inviter from a plurality of first applicants belonging to the first division group, the computing device is configured to calculate a first average value that is an average value of the evaluations for the predetermined inviter,
wherein based on evaluations for the predetermined inviter from a plurality of first applicants belonging to the second division group, the computing device is configured to calculate a second average value that is an average value of the evaluations for the predetermined inviter,
wherein based on evaluations for the predetermined inviter from the plurality of first applicants belonging to the first group, the computing device is configured to calculate a third average value that is an average value of the evaluations for the predetermined inviter,
wherein when the computing device receives a viewing request in a third communication established in accordance with identification information by which one is able to be identified to belong to the first division group, the computing device is configured to transmit each of the first average value and the third average value as the first evaluation information for the predetermined inviter to an origin of transmission of the viewing request in the third communication,
wherein when the computing device receives a viewing request in a fourth communication established in accordance with identification information by which one is able to be identified to belong to the second division group, the computing device is configured to transmit each of the second average value and the third average value as the first evaluation information for the predetermined inviter to an origin of transmission of the viewing request in the fourth communication,
wherein a list of inviters is registered in the database,
wherein when the first applicant device receives an operation of searching in the list, the first applicant device transmits a search request to the computing device, and
wherein when the computing device receives the search request, the computing device is configured to transmit, to the origin of transmission of the viewing request in the first communication, a search result in which an inviter who has an evaluation specified by the first evaluation information to have a magnitude not satisfying a criterion is excluded from the list.

17. The matching system according to claim 1,
wherein the asset information comprises detailed information about a content of the asset, and
wherein the computing device is configured to cause the first applicant device to present the asset information permitted to be disclosed to the first applicant and a meaning of a term included in the detailed information.

18. The matching system according to claim 17,
wherein the term included in the detailed information is an in-house term widely used in a group to which the inviter belongs,
wherein the computing device is configured to register, into the database, the in-house term and the meaning of the in-house term,
wherein the computing device is configured to register the in-house term into the database based on the group to which the inviter belongs, and
wherein when an operation of the first applicant for the in-house term is detected in the first applicant device, the computing device is configured to transmit, to the first applicant device, information by which the meaning of the in-house term registered in the database is able to be specified.

19. An inviter device operated by an inviter when an owner of an asset becomes the inviter so as to invite an application to be one to whom the asset is to be transferred or by whom the asset is to be used, the inviter device comprising:
an interface configured to receive an operation of inputting asset information and disclosure information, the asset information configured to indicate a subject of the asset, the disclosure information configured to indicate a scope of disclosure of the asset information; and
a processor configured to transmit, to a computing device, the asset information and the disclosure information received by the interface,
wherein the inviter device communicates with the computing device that matches the inviter and an applicant, and
wherein the disclosure information comprises information for instructing the computing device to permit the asset information to be disclosed to a group to which a first applicant belongs and to prohibit the asset information from being disclosed to a group to which a second applicant belongs and which is different from the group to which the first applicant belongs.

20. A method of matching an inviter and an applicant who applies for an invitation when an owner of an asset becomes the inviter so as to invite an application to be one to whom the asset is to be transferred or by whom the asset is to be used, the method comprising
communicating with an inviter device operated by the inviter and a first applicant device operated by a first applicant;
receiving asset information and disclosure information from the inviter device operated by the inviter, the asset information indicating a subject of the asset, the disclosure information indicating a scope of disclosure of the asset information;
registering the asset information and the disclosure information into a database; and
determining, based on corresponding disclosure information, asset information permitted to be disclosed to the group to which the first applicant belongs among pieces of asset information registered in the database, and providing the first applicant device with the asset information permitted to be disclosed to the group to which the first applicant belongs.
